(19) United States
(12) Patent Application Publication
(10) Pub. No.: US 2019/0068967 A1
(43) Pub. Date: Feb. 28, 2019

(54) PREDICTED-IMAGE GENERATION DEVICE, VIDEO DECODING DEVICE, AND VIDEO CODING DEVICE

(71) Applicant: SHARP KABUSHIKI KAISHA, Sakai City, Osaka (JP)

(72) Inventors: TOMOHIRO IKAI, Sakai City (JP); TAKESHI TSUKUBA, Sakai City (JP)

(21) Appl. No.: 16/074,841

(22) PCT Filed: Jan. 11, 2017
(86) PCT No.: PCT/JP2017/000640

§ 371 Date: Aug. 2, 2018

(30) Foreign Application Priority Data
Feb. 3, 2016 (JP) 2016-019353

(51) Int. Cl. H04N 19/117; H04N 19/159; H04N 19/593; H04N 19/513

(52) U.S. Cl. CPC H04N 19/117; H04N 19/513; H04N 19/593; H04N 19/159

(57) ABSTRACT

A predicted-image 145 correction unit derives a predicted pixel value constituting a predicted image by applying, to an unfiltered predicted pixel value in a target pixel within a prediction block, and also to at least one unfiltered reference pixel value, a boundary filter that applies a weighted addition used for a filter mode corresponding to a non-directional prediction mode.

### TECHNICAL FIELD

An embodiment of the disclosure relates to a predicted-image generation device configured to generate a predicted image of a partial area of an image by using an image of a surrounding area, an image decoding device configured to decode coded data by utilizing a predicted image, and an image coding device configured to generate coded data by coding an image utilizing the predicted image, with the main objective of image coding and image decoding.

### BACKGROUND ART

In order to efficiently transmit or record a video, a video coding device configured to generate coded data by coding the video, and a video decoding device configured to generate a decoded image by decoding the coded data are used.

A specific video coding method is, for example, a method (NPL 2 and 3) adopted in HEVC (High-Efficiency Video Coding).

According to HEVC, by coding a prediction residual (also called a “differential image” or a “residual image”) obtained by subtracting, from an input image (a source image), a predicted image, the predicted image having been generated based on a local decoded image obtained by coding and decoding an input image, the input image can be expressed by coded data having a lesser amount as compared to a case in which the input image is directly coded.

The methods of generating the predicted image include inter-picture prediction (inter prediction) and intra-picture prediction (intra prediction). According to the intra prediction of HEVC, an area adjacent to a target area is configured as a reference area, and the predicted image is generated based on a value of a decoded pixel (reference pixel) on the reference area. The reference pixel may be directly utilized as an unfiltered reference pixel, or a value obtained by applying a low pass filter between adjacent reference pixels may be utilized as a filtered reference pixel.

Furthermore, as another method of intra prediction, NPL 1 discloses a method of correcting a predicted pixel value obtained by intra prediction using a filtered reference pixel based on the unfiltered reference pixel value on the reference area.

### CITATION LIST

### Non Patent Literature

NPL 1: “Position dependent intra prediction combination”, ITU-T STUDY GROUP 16 COM16-C1046-E, (published October, 2015)

NPL 2: JCTVC-R1013 (HEVC version 2, RExt and SHVC and MV-HEVC)

NPL 3: JCTVC-V0031 (Draft of HEVC version 3, 3D-HEVC and SSC), Joint Collaborative Team on Video Coding (JCT-VC) of ITU-T SG 16 WP 3 and ISO/IEC JTC 1/SC 29/WG 11, 22nd Meeting: Geneva, CH, 15-21 Oct. 2015.

NPL 4: J. Chen, Y. Chen, M. Karczewicz, X. Li, H. Liu, L. Zhang, X. Zhao, “Coding tools investigation for next generation video coding”, ITU-T SG16 Doc. COM16-C806, February 2015.

### SUMMARY OF THE INVENTION

### Technical Problem

However, according to the technology described in NPL 1, as described below, there is room for further improvement in an accuracy of a predicted image near a boundary of a prediction block.

There is correlation between a predicted pixel obtained by inter prediction and intra-block copy prediction (IBC prediction), and a pixel value on a reference area near the boundary of the prediction block. However, a first problem according to the technology described in NPL 1 is that filtering is performed by using the pixel value on the reference area only in a case that the predicted image value of the predicted image near the boundary of the prediction block obtained by intra prediction is corrected.

Furthermore, during generation of the predicted image, referencing the reference pixel in the top right direction, and not in the top left direction, may improve the accuracy of the predicted image. However, a second problem according to the technology described in NPL 1 is that the reference pixel in the top left direction is always referenced.

Furthermore, a third problem is that a size of a table referenced in a case that a strength of the filter is decided depending on an intra-prediction mode is large.

In addition, in a case that the strength of the filter applied to the reference pixel (reference pixel filter) is low, it is better to reduce the strength of the filter for correcting (boundary filter) by using the pixel value on the reference area near the boundary of the prediction block. Also, generally, in a case that a divisor during quantization (quantization step) becomes small, a prediction error is reduced, and thus, it is possible to reduce the strength of the filter for correcting by using the pixel value on the reference area near the boundary of the prediction block. However, a fourth problem according to the technology described in NPL 1 is that while the strength of the filter applied to the reference pixel can be changed, the strength of the filter for correcting by using the pixel value on the reference area near the boundary of the prediction block cannot be changed.

It is known that if a filter is applied in a case that an edge exists near the boundary of the prediction block, there is a possibility that an artifact, such as a line, occurs in the predicted image. However, a fifth problem according to the technology described in NPL 1 is that even in the case that the edge exists near the boundary of the prediction block, a similar filtering is performed.

Furthermore, a sixth problem according to the technology described in NPL 1 is that while filtering is performed for luminance by using a pixel value on the reference area near the boundary of the prediction block, filtering is not performed for chrominance.

An embodiment of the disclosure aims at resolving at least any one of the above-described first to sixth problems, and an object thereof is to provide a predicted-image generation device, a video decoding device, and a video coding device capable of generating a high-accuracy predicted image by appropriately correcting a predicted pixel value of the predicted image near the boundary of the prediction block in various prediction modes.

### Solution to Problem

In order to resolve the above-described first or sixth problem, a predicted-image generation device according to an embodiment of the disclosure includes a filtered reference pixel setting unit configured to derive a filtered reference pixel value on a reference area R configured for a prediction block, a prediction unit configured to derive a provisional predicted pixel value of the prediction block by a prediction method corresponding to a prediction mode included in a first prediction mode group, or by a prediction method corresponding to a prediction mode included in a second prediction mode group, a predicted-image correction unit configured to generate a predicted image from the provisional predicted pixel value by performing a predicted-image correction process based on an unfiltered reference pixel value on the reference area R, and a filter mode in accordance with a prediction mode referenced by the prediction unit so that the predicted-image correction unit is configured to, in accordance with the prediction mode referenced by the prediction unit, either derive a predicted pixel value constituting the predicted image by applying, to the provisional predicted pixel value and to at least one unfiltered reference pixel value, a weighted addition using a weighting factor corresponding to the filter mode, or derive a predicted pixel value constituting the predicted image by applying, to the provisional predicted pixel value and to at least one unfiltered reference pixel value, a weighted addition that is used for a filter mode corresponding to a non-directional prediction mode.

Furthermore, in order to resolve the above-described first problem, a predicted-image generation device according to one aspect of the disclosure includes a reference area setting unit configured to configure a reference area for a prediction block, a prediction unit configured to calculate a provisional predicted pixel value of the prediction block by a prediction method corresponding to a prediction mode, a predicted-image correction unit configured to generate a predicted image from the provisional predicted pixel value by performing a predicted-image correction process based on an unfiltered reference pixel value on the reference area, and any one of multiple filter modes so that the predicted-image correction unit is configured to derive a predicted pixel value constituting the predicted image by applying, to the provisional predicted pixel value and to at least one unfiltered reference pixel value, a weighted addition using a weighting factor corresponding to a filter mode having a directionality that corresponds to a directionality of a motion vector indicating the reference image.

Furthermore, in order to resolve the above-described fourth problem, a predicted-image generation device according to one aspect of the disclosure includes a filtered reference pixel setting unit configured to derive a filtered reference pixel value by applying a first filter to a pixel on a reference area configured for a prediction block, a first filter switching unit configured to switch a strength or an ON/OFF state of the first filter, an intra prediction unit configured to derive a provisional predicted pixel value of the prediction block by referring to the filtered reference pixel value or a pixel on the reference area by a prediction method corresponding to a prediction mode, a predicted-image correction unit configured to generate a predicted image from the provisional predicted pixel value by performing a predicted-image correction process based on an unfiltered reference pixel value on the reference area and the prediction mode, and configured to derive a predicted pixel value constituting the predicted image by applying, to the provisional predicted pixel value in a target pixel within the prediction block and to at least one unfiltered reference pixel value, a second filter using a weighted addition based on a weighting factor, and a second filter switching unit configured to switch a strength or an ON/OFF status of the second filter in accordance with the strength or the ON/OFF state of the first filter.

Moreover, in order to resolve the above-described fifth problem, a predicted-image generation device according to one aspect of the disclosure includes a filtered reference pixel setting unit configured to derive a provisional predicted pixel value by applying a first filter to a pixel on a reference area configured for a prediction block, an intra prediction unit configured to derive a filtered predicted pixel value of the prediction block by referring to the filtered reference pixel value by a prediction method corresponding to a prediction mode, a predicted-image correction unit configured to generate a predicted image from the provisional predicted pixel value by performing a predicted-image correction process based on an unfiltered reference pixel value on the reference area and the prediction mode, and configured to derive a predicted pixel value constituting the predicted image by applying, to the provisional predicted pixel value in a target pixel within the prediction block and to at least one unfiltered reference pixel value, a second filter using a weighted addition based on a weighting factor, and a filter switching unit configured to switch a strength or an ON/OFF state of the second filter depending on whether an edge adjacent to the prediction block is present.

Furthermore, in order to resolve the above-described fourth problem, a predicted-image generation device according to one aspect of the disclosure includes a filtered reference pixel setting unit configured to derive a provisional predicted pixel value by applying a first filter to a pixel on a reference area configured for a prediction block, an intra prediction unit configured to derive a provisional predicted pixel value of the prediction block by a prediction method corresponding to a prediction mode, a predicted-image correction unit configured to generate a predicted image from the provisional predicted pixel value by performing a predicted-image correction process based on an unfiltered reference pixel value on the reference area and the prediction mode, and also configured to derive a predicted pixel value constituting the predicted image by applying, to a filtered predicted pixel value in a target pixel within the prediction block and to at least one unfiltered reference pixel value, a second filter using a weighted addition based on a weighting factor, and a filter switching unit configured to switch a strength or an ON/OFF state of the second filter in accordance with a quantization step.

Moreover, in order to resolve the above-described fourth and fifth problems, a predicted-image generation device according to one aspect of the disclosure includes a filtered reference pixel setting unit configured to derive a filtered reference pixel value by applying a first filter to a pixel on a reference area configured for a prediction block, an intra prediction unit configured to derive a provisional predicted pixel value of the prediction block by a prediction method corresponding to a prediction mode, a predicted-image correction unit configured to generate a predicted image from the provisional predicted pixel value by performing a predicted-image correction process based on an unfiltered reference pixel value on the reference area and the prediction mode, and configured to derive a predicted pixel value constituting the predicted image by applying, to the provisional predicted pixel value in a target pixel within the prediction block and to at least one unfiltered reference pixel value, a second filter using a weighted addition based on a weighting factor, and a weighting factor change unit configured to change the weighting factor by a shift operation.

Furthermore, in order to resolve the above-described second problem, a predicted-image generation device according to one aspect of the disclosure includes a filtered reference pixel setting unit configured to derive a filtered reference pixel value on a reference area configured for a prediction block, an intra prediction unit configured to derive a provisional predicted pixel value of the prediction block by a prediction method corresponding to a prediction mode, a predicted-image correction unit configured to generate a predicted image from the provisional predicted pixel value by performing a predicted-image correction process based on a pixel value of an unfiltered reference pixel on the reference area and the prediction mode, so that the predicted-image correction unit is configured to derive a predicted pixel value constituting the predicted image by applying, to the provisional predicted pixel value in a target pixel within the prediction block and to the pixel value of at least one unfiltered reference pixel, a weighted addition using a weighting factor, and configured not to include a pixel positioned at a top left of the prediction block in the at least one unfiltered reference pixel, and to include a pixel positioned at a top right of the prediction block, or a pixel positioned at a bottom left of the prediction block in the at least one unfiltered reference pixel.

Furthermore, in order to resolve the above-described third problem, a predicted-image generation device according to one aspect of the disclosure includes a filtered reference pixel setting unit configured to derive a filtered reference pixel value on a reference area configured for a prediction block, an intra prediction unit configured to derive a provisional predicted pixel value of the prediction block by a prediction method corresponding to a prediction mode, and a predicted-image correction unit configured to generate a predicted image from the provisional predicted pixel value by performing a predicted-image correction process based on an unfiltered reference pixel value on the reference area, and a filter mode corresponding to the prediction mode, so that the predicted-image correction unit is configured to derive a predicted pixel value constituting the predicted image by applying, to the provisional predicted pixel value in a target pixel within the prediction block and to at least one unfiltered reference pixel value, a weighted addition using a weighting factor corresponding to the filter mode, and the prediction image correction unit is configured to, based on one or more table indexes derived from a filter mode, refer to one or more tables that correspond to the table indexes and determines a weighting factor, and the number of the tables is less than the number of the filter modes.

### Advantageous Effects of Invention

According to an embodiment of the disclosure, a highly accurate predicted image can be generated by appropriately correcting a predicted pixel value of a predicted image near a boundary of a prediction block in various prediction modes.

### BRIEF DESCRIPTION OF DRAWINGS

FIG. 1 is a functional block diagram illustrating a schematic configuration of a video decoding device.

FIGS. 2A to 2D are diagrams illustrating a data configuration of coded data generated by a video coding device according to an embodiment of the disclosure and decoded by the video decoding device, and 2A to 2D are diagrams illustrating a picture layer, a slice layer, a CTU layer, and a CU layer, respectively.

FIG. 3 is a diagram illustrating a prediction direction corresponding to an identifier of an intra prediction mode with regard to 33 types of intra prediction modes belonging to a directional prediction.

FIG. 4 is a functional block diagram illustrating a schematic configuration of a predicted-image generation unit according to an embodiment of the disclosure.

FIGS. 5A to 5C are diagrams for describing a derivation of a predicted pixel value p[x, y] at a position (x, y) within a prediction block in a predicted-image correction unit. FIG. 5A illustrates an example of a derivation equation of the predicted pixel value p[x, y], FIG. 5B illustrates an example of a derivation equation of a weighting factor b[x, y], and FIG. 5C illustrates an example of a derivation equation of a distance-weighted k[ ].

FIG. 6 is a flowchart illustrating an outline of a predicted-image generation process in a CU unit in the predicted-image generation unit.

FIG. 7A(a) and FIG. 7A(b) are diagrams illustrating a positional relationship between a predicted pixel on a prediction block in an intra prediction and a reference pixel on a reference area R configured for a prediction block, FIG. 7A(a) illustrates a case of an unfiltered reference pixel value, and FIG. 7A(b) illustrates a case of a filtered reference pixel value.

FIG. 7B(a) illustrates a derivation equation of a predicted pixel value p[x, y] according to the related art, and FIG. 7B(b) illustrates a derivation equation of a weighting factor b[x, y] according to the related art.

FIG. 7C is a flowchart illustrating an example of an operation of a predicted-image correction unit.

FIG. 8A is an example of a derivation equation of a distance-weighted k[ ] where a reference distance is set as 0 in a case that a predetermined value is exceeded.

FIGS. 8B(a) to (c) are diagrams expressing a relationship between the reference distance and a weighting factor k[ ] in a case that a first normalization adjustment term smax varies. FIGS. 8B(a) to (c) illustrate the relationship between the reference distance and the weighting factor k[ ] in a case that the value of a variable d expressing a block size is 1, 2, and 3, respectively.

FIGS. 8C(a) to (c) are diagrams for describing another example of derivation of a predicted pixel value p[x, y] at a position (x, y) within a prediction block. FIG. 8C(a) illustrates an example of a derivation equation of the predicted pixel value p[x, y], FIG. 8C(b) illustrates an example of a derivation equation of a weighting factor b[x, y], and FIG. 8C(c) illustrates an example of a derivation equation of a distance shift value s[ ].

FIGS. 8D(a) to (d) are diagrams illustrating an example of a calculation formula for deriving a distance-weighted k[x] by a left shift operation. FIG. 8D(a) and FIG. 8D(b) illustrate a derivation equation of the distance-weighted k[x] used in a case that d=2, and FIG. 8D(c) and FIG. 8D(d) illustrate a derivation equation of the distance-weighted k[x] used in a case that d=1.

FIGS. 8E(a) to (d) are diagrams illustrating an example of a modification of the calculation formula for deriving the distance-weighted k[x] by the left shift operation.

FIGS. 8F(a) to (d) are diagrams illustrating an example of a distance weighting reference table for deriving the distance-weighted k[ ]. FIG. 8F(a) to (d) maintain a result of the calculation formula of distance weighting of FIG. 8E(a) to (d).

FIG. 9 is a diagram illustrating an example of classification of a prediction direction corresponding to an identifier of an intra prediction mode into five filter modes with regard to 33 types of intra prediction modes belonging to a directional prediction.

FIG. 10 is a diagram illustrating an example of switching a filter mode of a boundary filter in accordance with a direction of a motion vector in an inter prediction.

FIGS. 11A to 11C are diagrams illustrating a positional relationship between a predicted pixel on a prediction block in an intra prediction, and a reference pixel on a reference area R configured for a prediction block, FIG. 11A, FIG. 11B, and FIG. 11C are diagrams illustrating an example of deriving a predicted pixel on a prediction block from a reference pixel value on a reference region R configured at top left, top right, and bottom left, respectively.

FIG. 12 is a diagram illustrating an example of classification of the prediction direction corresponding to the identifier of the intra prediction mode into three filter modes, namely top left, top right, and bottom left with regard to 33 types of intra prediction modes belonging to a directional prediction.

FIG. 13 is a functional block diagram illustrating a configuration of a video coding device according to an embodiment of the disclosure.

FIGS. 14A and 14B are diagrams illustrating a configuration of a transmission device on which the video coding device is mounted, and a reception device on which the video decoding device is mounted. FIG. 14A illustrates the transmission device on which the video coding device is mounted, and FIG. 14B illustrates the reception device on which the video decoding device is mounted.

FIGS. 15A and 15B are diagrams illustrating a configuration of a recording device on which the video coding device is mounted, and a playback device on which the video decoding device is mounted. FIG. 15A illustrates the recording device on which the video coding device is mounted, and FIG. 15B illustrates the playback device on which the video decoding device is mounted.

FIGS. 16A to 16C are diagrams illustrating an example of a table in which vectors of a reference strength coefficient C {c1v, c2v, c1h, c2h} are arranged for each filter mode fmode.

FIG. 17A is a flowchart illustrating an example of a flow of a process for deriving a filter strength coefficient fparam of a reference pixel filter in accordance with the reference pixel filter, and FIG. 17B is a flowchart illustrating an example of a flow of a process for switching a strength of a reference strength coefficient in accordance with the reference pixel filter.

### DESCRIPTION OF EMBODIMENTS

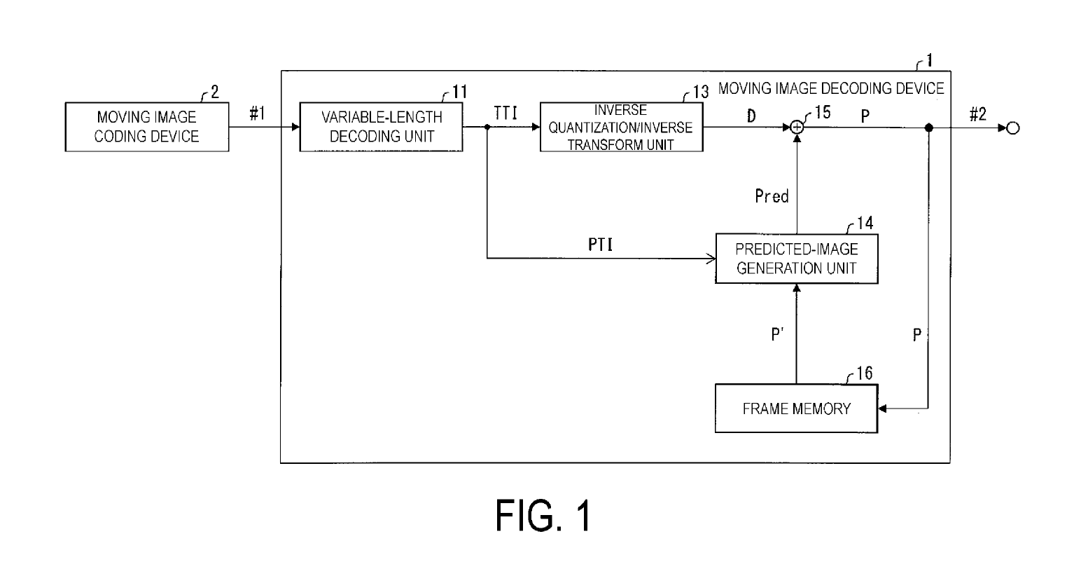

An embodiment of the disclosure will be described below with reference to FIG. 1 to FIG. 15B. First, an overview of a video decoding device (image decoding device) 1 and a video coding device (image coding device) 2 will be described, with reference to FIG. 1. FIG. 1 is a functional block diagram illustrating a schematic configuration of the video decoding device 1.

The video decoding device 1 and the video coding device 2 illustrated in FIG. 1 are equipped with a technology adopted in the H.264/MPEG-4.AVC standard, a technology adopted in the HEVC (High-Efficiency Video Coding) standard, and an improved technology thereof.

According to a specific video coding method, the video coding device 2 performs entropy coding of a value of a syntax for which transmission from an encoder to a decoder is defined, and generates the coded data #1.

The coded data #1 in which the video coding device 2 has coded a video is input in the video decoding device 1. The video decoding device 1 decodes the input coded data #1 and outputs a video #2 to the outside. Before describing the video decoding device 1 in detail, a configuration of the coded data #1 will be described below.

### Configuration of the Coded Data

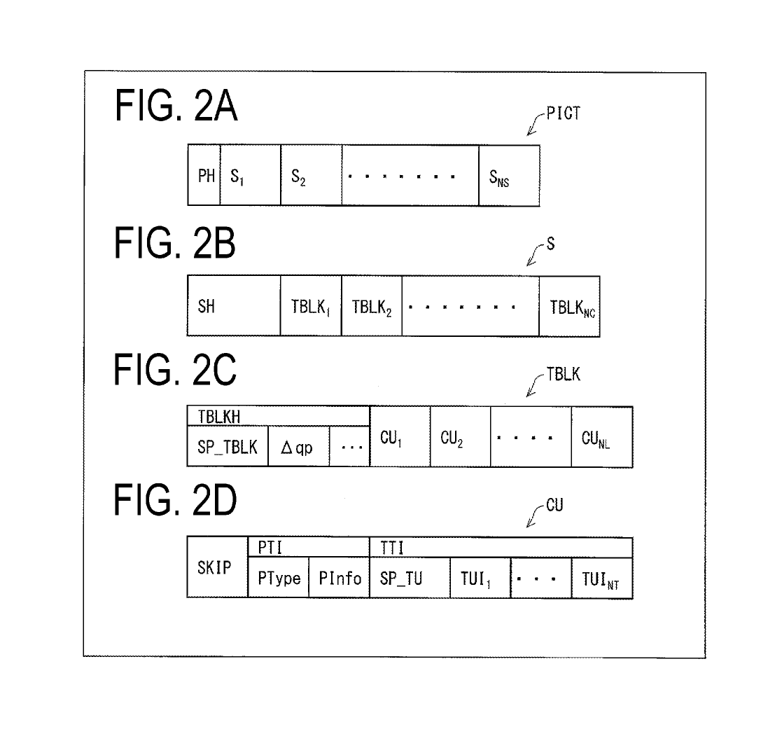

A configuration example of the coded data #1 generated by the video coding device 2 and decoded by the video decoding device 1 will be described by using FIGS. 2A to 2D. Exemplarily, the coded data #1 includes a sequence, and partially coded data corresponding to multiple pictures constituting the sequence.

A hierarchical structure below a picture layer in the coded data #1 is illustrated in FIGS. 2A to 2D. FIGS. 2A to 2D are diagrams illustrating a picture layer that defines a picture PICT, a slice layer that defines a slice S, a tree block layer that defines a tree block TBLK, and a CU layer that defines a coding unit (CU) included in the tree block TBLK, respectively.

### Picture Layer

In the picture layer, aggregation of data referenced by the video decoding device 1 for decoding the picture PICT to be processed (hereinafter, also called a target picture) is defined. As illustrated in FIG. 2A, the picture PICT includes a picture header PH and slices S1 to SNS (NS being the total number of slices included in the picture PICT).

It is noted that hereinafter, in a case that there is no need of differentiating each of the slices S1 to SNS, the description may be provided by omitting the code subscript. Furthermore, the same applies to other data included in the coded data #1 described below to which a subscript is added.

The picture header PH includes a coding parameter group referenced by the video decoding unit 1 for deciding a decoding method of the target picture. For example, a reference value within the picture in a quantization step of a prediction residual (hereinafter, also called a “value QP of the quantization step”) is an example of the coding parameter included in the picture header PH.

It is noted that the picture header PH is also called a picture parameter set (PPS).

### Slice Layer

In the slice layer, aggregation of data referenced by the video decoding device 1 for decoding the slice S to be processed (also called a target slice) is defined. As illustrated in FIG. 2B, the slice S includes a slice header SH and tree blocks TBLK1 to TBLKNC (NC being the total number of tree blocks included in the slice S).

In the slice header SH, the coding parameter group referenced by the video decoding unit 1 for deciding the decoding method of the target slice is included. Slice type designation information (slice_type) for designating a slice type is an example of a coding parameter included in the slice header SH.

The slice types that can be designated by the slice type designation information include (1) an I slice that uses only the intra prediction during coding, (2) a P slice that uses an unidirectional prediction or the intra prediction during coding, and (3) a B slice that uses the unidirectional prediction, a bi-directional prediction, or the intra prediction during coding.

### Tree Block Layer

In the tree block layer, aggregation of data referenced by the video decoding device 1 for decoding the tree block TBLK to be processed (hereinafter, also called the target tree block) is defined.

The tree block TBLK includes a tree block header TBLKH and coding unit information CU1 to CUNL (NL being the total number of pieces of coding unit information included in the tree block TBLK). Here, first, a relationship between the tree block TBLK and the coding unit information CU will be described as below.

The tree block TBLK is split into units for specifying intra prediction or inter prediction, as well as the block size for each process of conversion. The splitting into each unit is expressed by a recursive splitting of the tree block TBLK into a quadtree. The tree structure obtained by this recursive splitting into a quadtree is hereinafter called a coding tree.

Hereinafter, a unit corresponding to a leaf being the end node of the coding tree will be referenced as a coding node. Furthermore, the coding node is a basic unit of the coding process, and thus, the coding node is also called a coding unit (CU) hereinafter.

That is, the coding unit information (hereinafter, called CU information) CU1 to CUNL is information corresponding to each coding node (coding unit) obtained by recursively splitting the tree block TBLK into the quadtree.

Furthermore, a root of the coding tree is associated with the tree block TBLK. In other words, the tree block TBLK is associated with the highest node of a tree structure obtained by splitting into the quadtree that recursively includes multiple coding nodes.

It is noted that the size of each coding node is, both vertically and horizontally, half the size of a coding node to which the coding node directly belongs (that is, the unit of the node that is one order above the coding node).

Furthermore, the size that each coding node can have depends on the size of the tree block and size designation information of the coding node included in a sequence parameter set SPS of the coded data #1. Since the tree block is the root of a coding node, the maximum size of the coding node is the size of the tree block. Since the maximum size of the tree block matches the maximum size of the coding node (CU), a tree block may also be referred to as an LCU (Largest CU) and CTU (Coding Tree Unit). In the general configuration, the size designation information of a coding node in which the maximum coding node size is 64×64 pixels and the minimum coding node size is 8×8 pixels is used. In this case, the size of the coding node and the coding unit CU is any one of 64×64 pixels, 32×32 pixels, 16×16 pixels, or 8×8 pixels.

### Tree Block Header

In the tree block header TBLKH, the coding parameter referenced by the video decoding unit 1 for deciding the decoding method of the target tree block is included. Specifically, as illustrated in FIG. 2C, tree block splitting information SP_TBLK designating a splitting pattern for each CU of the target tree block, and a quantization parameter differential Aqp (qp_delta) designating the size of the quantization step are included.

The tree block splitting information SP_TBLK is information expressing the coding tree for splitting the tree block, and is, specifically, information designating the shape and size of each CU included in the target tree block, as well as the position of each CU within the target tree block.

It is noted that the tree block splitting information SP_TBLK may not explicitly include the shape and size of the CU. For example, the tree block splitting information SP_TBLK may be an aggregation of flags indicating whether or not to split the entire target tree block or a partial area of the tree block into four. In this case, by jointly using the shape and size of the tree block, the shape and size of each CU can be specified.

### CU Layer

In the CU layer, aggregation of the data referenced by the video decoding device 1 for decoding the CU to be processed (hereinafter, also called a target CU) is defined.

Here, before describing the specific content of the data included in CU information CU, the tree structure of the data included in a CU will be described. The coding node is the root node of a prediction tree (PT) and a transform tree (TT). The prediction tree and the transform tree will be described below.

In the prediction tree, a coding node is split into one or multiple prediction blocks, and the position and size of each prediction block are defined. In other words, a prediction block is one or multiple non-overlapping areas constituting a coding node. Furthermore, a prediction tree includes one or multiple prediction blocks obtained by the above-described splitting.

A prediction process is performed for each of these prediction blocks. Hereinafter, a prediction block that is a unit of prediction will also be called a prediction unit (PU).

Generally speaking, there are two types of splitting in a prediction tree, namely splitting in a case of an intra prediction (intra-picture prediction) and splitting in a case of an inter prediction (inter-picture prediction).

In the case of an intra prediction, the splitting methods include 2N×2N (same size as a coding node) and N×N.

Furthermore, in the case of an inter prediction, the splitting methods include 2N×2N (same size as a coding node), 2N×N, N×2N, and N×N.

Furthermore, in the transform tree, a coding node is split into one or multiple transform blocks, and the position and size of each transform block is defined. In other words, a transform block is one or multiple non-overlapping areas constituting a coding node. Furthermore, a transform tree includes one or multiple transform blocks obtained by the above-described splitting.

A transform process is performed for each of these transform blocks. Hereinafter, a transform block that is a unit of transform will be called a transform unit (TU).

### Data Structure of CU Information

Next, the specific content of the data included in the CU information CU will be described with reference to FIG. 2D. As illustrated in FIG. 2D, the CU information CU includes, specifically, a skip flag SKIP, PT information PTI, and TT information TTI.

The ship flag SKIP is a flag indicating whether or not a skip mode is applied to the CU. In a case that a value of the skip flag SKIP indicates that the skip mode is applied to the target CU, the PT information PTI and the TT information TTI in the CU information CU are skipped. It is noted that the skip flag SKIP is skipped in the I slice.

The PT information PTI is information about a PT included in the CU. In other words, the PT information PTI is an aggregation of information about each of the prediction blocks included in the PT, and is referenced by the video decoding device 1 during the generation of a predicted image Pred. As illustrated in FIG. 2D, the PT information PTI includes prediction type information PType and prediction information PInfo.

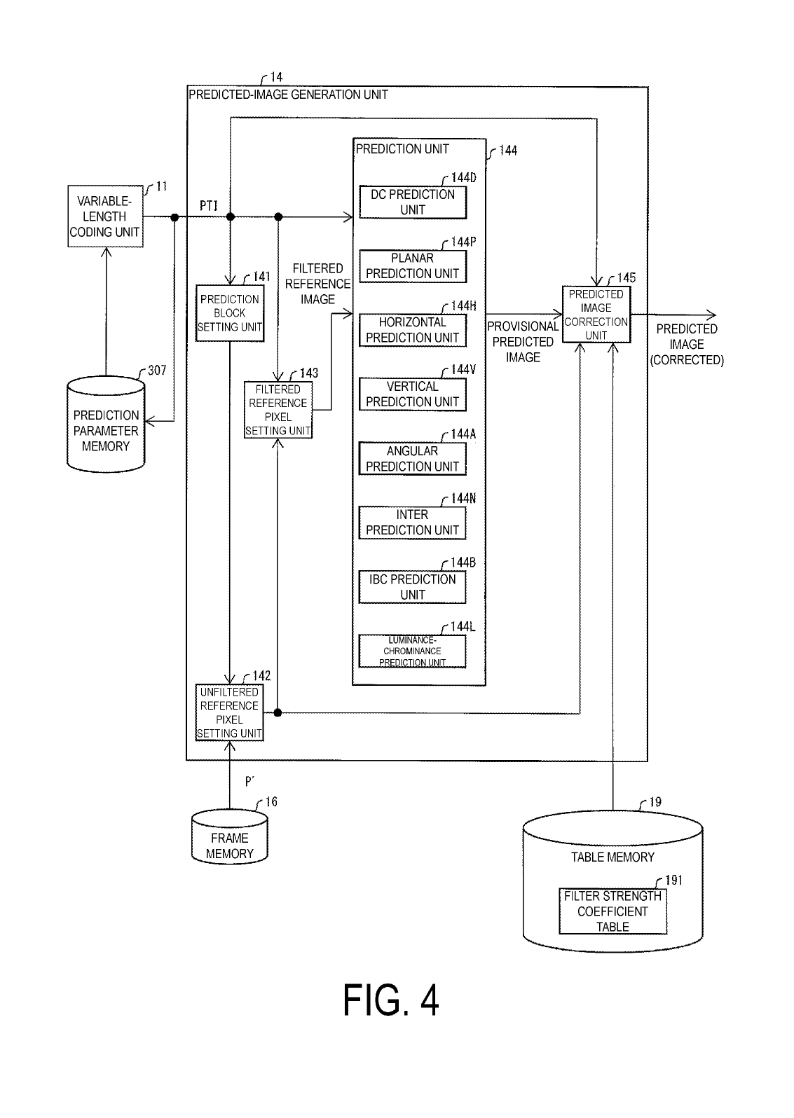

The prediction type information PType is information that designates whether to use intra prediction or to use inter prediction as the predicted-image generation method for the target PU. As for a prediction unit 144 illustrated in FIG. 4, a specific prediction unit is selected in accordance with the prediction mode designated by the prediction type information PType (a first prediction mode group and a second prediction mode group), and the predicted image Pred is generated. It is noted that the “first prediction mode group” and the “second prediction mode group” will be described later.

The prediction information PInfo is constituted by the intra prediction information or the inter prediction information in accordance with the prediction method (prediction mode) designated by the prediction type information PType. Hereinafter, the prediction block will be named in accordance with the prediction type applied to the prediction block (that is, the prediction mode designated by the prediction type information PType). For example, a prediction block to which intra prediction is applied is also called an intra prediction block, a prediction block to which inter prediction is applied is also called an inter prediction block, and a prediction block to which intra block copy (IBC) prediction is applied is also called an IBC block.

Further, the prediction information PInfo includes information that designates the shape, size, and position of the prediction block. As described above, the predicted image Pred is generated with the prediction block as unit. The details of the prediction information PInfo will be described later.

The TT information TTI is information about a TT included in the CU. In other words, the TT information TTI is an aggregation of information about a single or each of multiple TUs included in the TT, and is referenced by the video decoding device 1 during decoding of the residual data. It is noted that hereinafter, the TU may also be called a transform block.

As illustrated in FIG. 2D, the TT information TTI includes TT splitting information SP_TU that designates a splitting pattern to each transform block of the target CU, and TU information TUI1 to TUINT (NT being the total number of transform blocks included in the target CU).

The TT splitting information SP_TU is, specifically, information for deciding the shape and size of each TU included in the target CU, as well as the position of each TU within the target CU. For example, the TT splitting information SP_TU can be realized by information indicating whether or not to split the target node (split_transform_unit_flag), and information indicating the depth of splitting (trafoDepth).

Furthermore, for example, in a case that the size of the CU is 64×64, each TU obtained by splitting can take a size from 32×32 pixels to 4×4 pixels.

The TU information TUI1 to TUINT is individual information about a single or each of the multiple TUs included in the TT. For example, the TU information TUI includes a quantization prediction residual.

Each quantization prediction residual is coded data generated by implementing the processes 1 to 3 described below by the video coding device 2 in the target block that is the block to be processed.

Process 1: DCT transform (DiscreteCosine Transform) of the prediction residual obtained by subtracting the predicted image Pred from the coding target image

Process 2: Quantization of the transform coefficient obtained in process 1

Process 3: Variable-length coding of the transform coefficient quantized in process 2.

### Prediction Information PInfo

As described above, there are two types of prediction information PInfo, namely the inter prediction information and the intra prediction information.

The inter prediction information includes the coding parameter that the video decoding device 1 references during the generation of an inter predicted image by inter prediction. More specifically, the inter prediction information includes the inter prediction block splitting information that designates the splitting pattern for each inter prediction block of the target CU, and the inter prediction parameter for each inter prediction block.

The inter prediction parameter includes a reference image index, an estimation motion vector index, and a motion vector residual.

On the other hand, the intra prediction information includes the coding parameter that the video decoding device 1 references during the generation of an intra predicted image by intra prediction. More specifically, the intra prediction information includes intra prediction block splitting information that designates the splitting pattern for each intra prediction block of the target CU, and an intra prediction parameter for each intra prediction block. The intra prediction parameter is a parameter for controlling the predicted-image generation by intra prediction in each intra prediction block and includes a parameter for restoring the intra prediction mode IntraPredMode.

The parameter for restoring the intra prediction mode includes an mpm_flag that is a flag related to an MPM (Most Probable Mode, same hereinafter), an mpm_idx that is an index for selecting the MPM, and an rem_idx that is an index for designating a prediction mode other than the MPM. Here, the MPM is an estimation prediction mode that has a high possibility of being selected in the target partition.

Furthermore, hereinafter, in a case that simply “prediction mode” is expressed, this implies an intra prediction mode that is applicable to luminance. An intra prediction mode applied to chrominance is expressed as a “chrominance prediction mode”, and is thus differentiated from the luminance prediction mode.

### Video Decoding Device

Hereinafter, a configuration of the video decoding device 1 according to the present embodiment will be described with reference to FIGS. 1 to 12.

### Overview of the Video Decoding Device

The video decoding device 1 is configured to generate a predicted image Pred for each prediction block, and to generate a decoded image #2 by adding the generated predicted image Pred and the prediction residual decoded from the coded data #1, and also to output the generated decoded image #2 to the outside.

Here, the predicted image is generated with reference to a prediction parameter obtained by decoding the coded data #1. The prediction parameter is a parameter that is referenced for generating a predicted image.

Furthermore, hereinafter, the picture (frame), slice, tree block, CU, block, and prediction block for which the decoding process is to be performed will respectively be called a target picture, target slice, target tree block, target CU, target block, and target prediction block (prediction block).

It is noted that the size of the tree block is, for example, 64×64 pixels, the size of the CU is, for example, 64×64 pixels, 32×32 pixels, 16×16 pixels, and 8×8 pixels, and the size of the prediction block is, for example, 64×64 pixels, 32×32 pixels, 16×16 pixels, 8×8 pixels, 4×4 pixels, and the like. However, these sizes are simply examples, and the size of the tree block, the CU, and the prediction block may be other than the sizes described above.

### Configuration of Video Decoding Device

Again, a schematic configuration of the video decoding device 1 will be described with reference to FIG. 1. As illustrated in FIG. 1, the video decoding device 1 includes a variable-length decoding unit 11, an inverse quantization/inverse transform unit 13, a predicted-image generation unit 14, an adder 15, and a frame memory 16.

### Variable-Length Decoding Unit

The variable-length decoding unit 11 is configured to decode various types of parameters included in the coded data #1 input from the video decoding device 1. In the description provided below, the variable-length decoding unit 11 is configured to appropriately decode a parameter coded by an entropy coding method such as CABAC and CAVLC, or the like.

First, the variable-length decoding unit 11 separates the coded data #1 of one frame into various types of information included in the hierarchical structure illustrated in FIGS. 2A to 2D by performing reverse multiplexing. For example, the variable-length decoding unit 11 sequentially separates the coded data #1 into a slice and a tree block by referencing the information included in various types of headers.

In addition, the variable-length decoding unit 11 splits the target tree block into CU(s) by referencing the tree block splitting information SP TBLK included in the tree block header TBLKH. Furthermore, the variable-length decoding unit 11 is configured to decode the TT information TTI related to the transform tree obtained for the target CU, and the PT information PTI related to the prediction tree obtained for the target CU.

It is noted that as described above, the TU information TUI corresponding to the TU included in the transform tree is included in the TT information TTI. Furthermore, as described above, the PU information PUI corresponding to the prediction block included in the target prediction tree is included in the PT information PTI.

The variable-length decoding unit 11 supplies the TT information TTI obtained for the target CU to the inverse quantization/inverse transform unit 13. Furthermore, the variable-length decoding unit 11 supplies the PT information PTI obtained for the target CU to the predicted-image generation unit 14.

### Inverse Quantization/Inverse Transform Unit

The inverse quantization/inverse transform unit 13 is configured to perform an inverse quantization/inverse transform process based on the TT information TTI for each block included in the target CU. Specifically, the inverse quantization/inverse transform unit 13 is configured to restore a prediction residual D of each pixel, for each target TU, by performing inverse quantization and inverse orthogonal transform of the quantization prediction residual included in the TU information TUI corresponding to the target TU. It is noted that here, an orthogonal transform implies the orthogonal transform from a pixel area to a frequency area. Therefore, an inverse orthogonal transform is a transform from a frequency area to a pixel area. Furthermore, examples of inverse orthogonal transform include an inverse DCT transform (Inverse Discrete Cosine Transform) and an inverse DST transform (Inverse Discrete Sine Transform), and the like. The inverse quantization/inverse transform unit 13 supplies the restored prediction residual D to the adder 15.

### Predicted-Image Generation Unit

The predicted-image generation unit 14 is configured to generate a predicted image Pred based on the PT information PTI for each prediction block included in the target CU. Specifically, the predicted-image generation unit 14 is configured to generate the predicted image Pred, for each target prediction block, by performing a prediction such as the intra prediction or the inter prediction according to the prediction parameter included in the PU information PUI corresponding to the target prediction block. At this time, a local decoded image P′ that is a decoded image accumulated in the frame memory 16 is referenced based on the content of the prediction parameter. The predicted-image generation unit 14 supplies the generated predicted image Pred to the adder 15. It is noted that the configuration of the predicted-image generation unit 14 will be described in detail later.

It is noted that the inter prediction may include the “Intra block copy (IBC) prediction” that is described later, or the configuration may be such that the “IBC prediction” is not included in the inter prediction, and the “IBC prediction” is handled as a prediction scheme different from the inter prediction and intra prediction.

Furthermore, the configuration may be such that the “Luminance-Chrominance prediction (Luma-Chroma Prediction)” described later is further included in at least either one of the inter prediction and the intra prediction, or the configuration may be such that the “Luminance-Chrominance prediction” is not included in either the inter prediction or the intra prediction, and is handled as a prediction method different from the inter prediction and intra prediction.

### Adder

The adder 15 is configured to generate a decoded image P for the target CU by adding the predicted image Pred supplied by the predicted-image generation unit 14, and the prediction residual D supplied by the inverse quantization/inverse transform unit 13.

### Frame Memory

In the frame memory 16, the decoded images P are sequentially recorded. In the frame memory 16, when a target tree block is decoded, the decoded images that correspond to all tree blocks decoded earlier than the target tree block (for example, all preceding tree blocks in the raster scan order) are recorded.

Furthermore, when a target CU is decoded, the decoded images that correspond to all CU(s) decoded earlier than the target CU are recorded.

It is noted that in the video decoding device 1, when the decoded image generation process performed in the tree block unit has ended for all tree blocks within an image, the decoded image #2 that corresponds to the coded data #1 of one frame input to the video decoding device 1 is output to the outside.

### Definition of the Prediction Mode

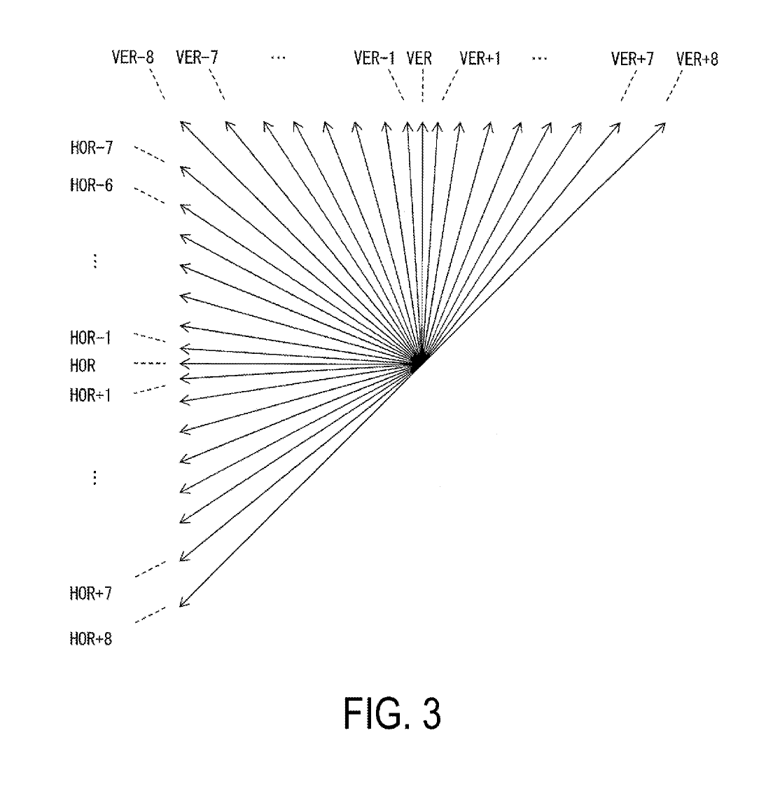

As described earlier, the predicted-image generation unit 14 is configured to generate a predicted image based on the PT information PTI, and output the generated predicted image. In a case that the target CU is an intra CU, the PU information PTI that is input to the predicted-image generation unit 14 includes an intra prediction mode (IntraPredMode). In a case that the target CU is an inter CU, the PU information PTI that is input to the predicted-image generation unit 14 includes a merge flag merge_flag, a merge index merge_idx, and a motion vector differential mvdLX. Below, a definition of the prediction mode (PredMode) will be described with reference to FIG. 3.

### Overview

In the prediction mode used in the video decoding device 1 (the first prediction mode group and the second prediction mode group), a Planar prediction (Intra_Planar), a vertical prediction (Intra_Vertical), a horizontal prediction (Intra_Horizontal), a DC prediction (Intra_DC), an angular prediction (Intra_Angular), the inter prediction (Inter), the IBC prediction (Ibc), and the luminance-chrominance prediction (Luma-chroma), etc. are included. The prediction mode may be hierarchically identified by using multiple variables. PredMode is used as a variable for a higher-order identification, and IntraPredMode is used as a variable for a lower-order identification.

For example, by using the PredMode variable for higher-order identification, predictions that use a motion vector (inter prediction, IBC prediction, PredMode=PRED_INTER), and predictions that do not use a motion vector (intra prediction using adjacent pixels and luminance-chrominance prediction, PredMode=PRED_INTRA) can be classified, and furthermore, as for the predictions that do not use a motion vector (PredMode=PRED_INTRA), by further using IntraPredMode, further classification into Planar prediction, DC prediction, etc. is possible (mode definition A).

Inter prediction (predMODE=PRED_INTER)

IBC prediction (predMODE=PRED_INTER)

Planar prediction, vertical prediction, horizontal prediction, DC prediction, Angular prediction, luminance-chrominance prediction (PredMode=PRED_INTRA, each prediction mode is expressed by IntraPredMode).

In addition, for example, as described below, even among the predictions that use a motion vector, the prediction mode predMode of a general inter prediction can be classified as PRED_INTER, and the prediction mode predMode of an IBC prediction can be classified as PRED_IBC for differentiation (mode definition B).

Inter prediction (predMODE=PRED_INTER)

IBC prediction (predMODE=PRED_IBC)

Planar prediction, vertical prediction, horizontal prediction, DC prediction, Angular prediction, luminance-chrominance prediction (PredMode=PRED_INTRA, each prediction mode is expressed by IntraPredMode).

Furthermore, for example, even in the case of the prediction that uses a motion vector, only the general inter prediction can be classified as PRED_INTER, and the IBC prediction can be classified as PRED_INTRA. In this case, by using IntraPredMode that is a sub-prediction mode for further identification in a case that the predMode is PRED_INTRA, it is possible to differentiate between an IBC prediction and an adjacent pixel or Luminance-chrominance prediction (mode definition C). Inter prediction (predMODE=PRED_INTER)

Planar prediction, vertical prediction, horizontal prediction, DC prediction, Angular prediction, luminance-chrominance prediction, IBC prediction (PredMode=PRED_INTRA, each prediction mode is expressed by IntraPredMode).

As illustrated in FIG. 3, the horizontal prediction, vertical prediction, and angular prediction are collectively called directional predictions. Directionality prediction is a prediction method in which a neighboring area that has already been decoded and that is adjacent (close) to the target prediction block is configured as the reference area R and schematically, a predicted image is generated by extrapolating a pixel on the reference area R in a specific direction. For example, an inverted L-time-shaped area including the left and top (or, in addition, the top left, the top right, or the bottom left) of the target prediction block can be used as the reference area R.

That is, the prediction mode group utilized in the video decoding device 1 includes at least any one of an (1) intra prediction mode for calculating a predicted pixel value (corrected) by referencing a reference pixel of a picture including a prediction block, an (2) inter prediction mode (prediction mode B) for calculating a predicted pixel value (corrected) by referencing a reference image that is different from the picture including the prediction block, an (3) IBC prediction mode (prediction mode A), and a (4) luminance-chrominance prediction mode (prediction mode C) for calculating the predicted pixel value (corrected) of a chrominance image by referencing a luminance image.

Both the inter prediction mode and the IBC prediction mode derive a motion vector mvLX that indicates a displacement with respect to the prediction block, and also derive the predicted pixel value (corrected) by referencing a block that exists at a position that is shifted by the motion vector mvLX from the prediction block. Therefore, the inter prediction mode and the IBC prediction mode can be collectively named (corresponding to predMode=PRED_INTER in mode definition A).

Next, an identifier of each prediction mode included in the directional prediction will be described by using FIG. 3. FIG. 3 illustrates a prediction direction that corresponds to an identifier of a prediction mode with regard to 33 types of prediction modes belonging to a directional prediction. The direction of the arrows in FIG. 3 expresses the prediction direction, and more accurately, indicates the direction of the vectors from the prediction target pixels to the pixels on the reference area R that the prediction target pixels refer. This means that the prediction direction can also be called the reference direction. In the identifier of each prediction mode, a symbol expressing whether the main direction is the horizontal direction (HOR) or the vertical direction (VER), and an identifier being a combination of the displacement in the main direction, are associated. For example, a symbol HOR is assigned to the horizontal prediction, VER to the vertical prediction, VER+8 to a prediction mode in which the surrounding pixel in the 45-degree direction at the top right is referenced, VER−8 to a prediction mode in which the surrounding pixel in the 45-degree direction at the top left is referenced, and HOR+8 to a prediction mode in which the surrounding pixel in the 45-degree direction at the bottom left is referenced, respectively. In the directional prediction, 17 prediction modes from VER−8 to VER+8 in which the main direction is the vertical direction, and 16 prediction modes from HOR−7 to HOR+8 in which the main direction is the horizontal prediction are defined. It is noted that the number of directions of the directional prediction is not restricted to 33 directions, and there may be 63 or more directions. As for the symbols of the prediction modes too, different symbols may be used in accordance with the number of directions of the directional prediction (Example: The prediction modes from VER−16 to VER+16 in the vertical direction, etc.).

### Details of the Predicted-Image Generation Unit

Next, the details of the configuration of the predicted-image generation unit 14 will be described by using FIG. 4. FIG. 4 is a functional block diagram illustrating an example of a configuration of the predicted-image generation unit 14.

As illustrated in FIG. 4, the predicted-image generation unit 14 includes a prediction block setting unit 141 (reference area setting unit), an unfiltered reference pixel setting unit 142 (a second prediction unit), a filtered reference pixel setting unit 143 (a first prediction unit), a prediction unit 144, and a predicted-image correction unit 145 (a predicted-image correction unit, a filter switching unit, and a weighting factor change unit).

The filtered reference pixel setting unit 143 is, in accordance with the input prediction mode, configured to apply a reference pixel filter (a first filter) to an unfiltered reference pixel value on an input reference area R, generate a filtered reference image (pixel value), and output the filtered reference image to the prediction unit 144. The prediction unit 144 is, based on the input prediction mode, and the unfiltered reference image and filtered reference image (pixel value), configured to generate a provisional predicted image (a provisional predicted pixel value and a pre-correction predicted image) of the target prediction block, and to output the provisional predicted image to the predicted-image correction unit. The predicted-image correction unit 145 is, in accordance with the input prediction mode, configured to correct the predicted image (the provisional predicted pixel value), and to generate a predicted image (corrected). The predicted image (corrected) generated by the predicted-image correction unit 145 is output to the adder 15.

Below, each unit included in the predicted-image generation unit 14 will be described.

### Prediction Block Setting Unit 141

The prediction block setting unit 141 is configured to configure the prediction blocks included in the target CU into the target prediction block in a specified configuration order, and to output information about the target prediction block (target prediction block information). The target prediction block information includes at least a target prediction block size, a target prediction block position, and an index indicating a luminance or chrominance plane of the target prediction block.

### Unfiltered Reference Pixel Setting Unit 142

The unfiltered reference pixel setting unit 142 configures, to the reference area R, a surrounding area that is adjacent to the target prediction block, based on the target prediction block size and the target prediction block position indicated in the input target prediction block information. Following this, the unfiltered reference pixel setting unit 142 configures the pixel value of the decoded image (decoded pixel value) recorded at a corresponding position within a picture on the frame memory for each pixel in the reference area R as an unfiltered reference pixel value. The unfiltered reference pixel value r(x, y) of a position (x, y) within the prediction block is configured by the equation below by utilizing a decoded pixel value u(px, py) of the target picture expressed with reference to the top left pixel of the picture.

r(x, y)=u(xB+x, yB+y)

x=−1, y=−1··(nS*2−1), and

x=0··(nS*2−1), y=−1

Here, (xB, yB) expresses the position of the top left pixel of the target prediction block within the picture, and nS expresses the size of the target prediction block and indicates the larger value between the width and height of the target prediction block. Furthermore, “y=−1··(nS*2−1)” indicates that y can take (nS*2+1) values from −1 to (nS*2−1).

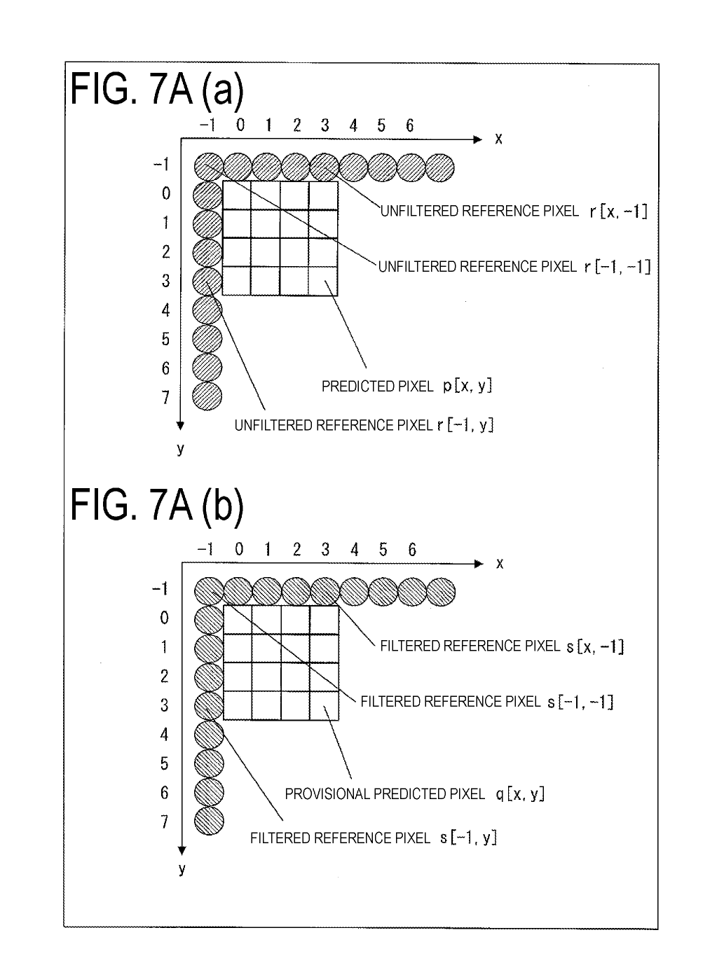

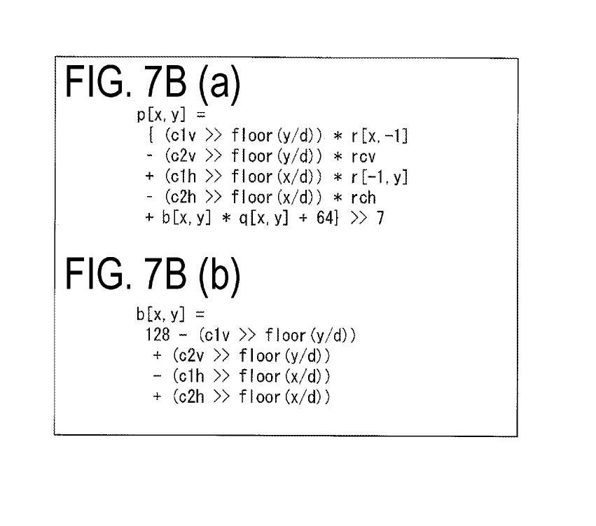

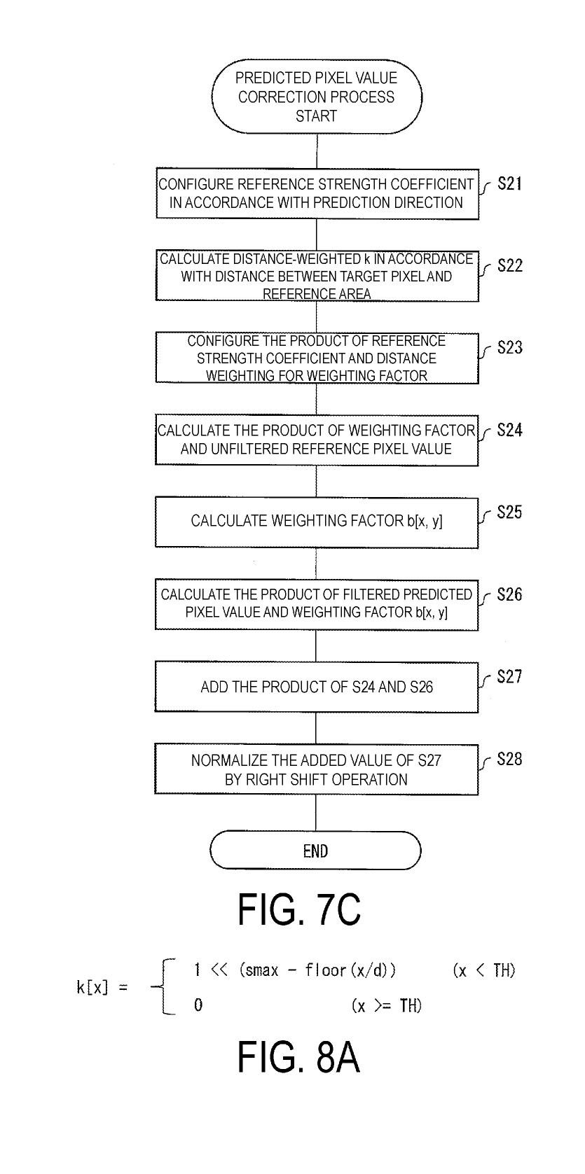

In the above equation, as described later with reference to FIG. 7A(a), the decoded pixel value included in the line of the decoded pixel adjacent to the upper side of the target prediction block and the column of the decoded pixel adjacent to the left side of the target prediction block is copied as the corresponding unfiltered reference pixel value. It is noted that in a case that a decoded pixel value corresponding to a specific reference pixel position does not exist, or cannot be referenced, a predetermined value (for example, 1<<(bitDepth−1) by using the pixel bit depth bitDepth) may be utilized, or a decoded pixel value that exists near the corresponding decoded pixel value and that can be referenced may be utilized.

### Filtered Reference Pixel Setting Unit 143

The filtered reference pixel setting unit 143 is, in accordance with the input prediction mode, configured to apply (implement) a reference pixel filter (the first filter) to an input unfiltered reference pixel value, and to derive and output a filtered reference pixel value s[x, y] at each position (x, y) on the reference area R. Specifically, the filtered reference pixel setting unit 143 applies a low pass filter to a position (x, y) and a peripheral unfiltered reference pixel value, and derives a filtered reference pixel. It is noted that it is not necessary to apply a low pass filter in all cases, but a low pass filter may be applied to, at least, some of the directional prediction modes to derive a filtered reference pixel. It is noted that a filter that is applied to an unfiltered reference pixel value on the reference area R in the filtered reference pixel setting unit 143 before performing an input to the prediction unit 144 illustrated in FIG. 4 is called a “reference pixel filter (the first filter)”, and in contrast, a filter that corrects a provisional predicted image derived by the prediction unit 144 by using an unfiltered reference pixel value in the later-described predicted-image correction unit 145 is called a “boundary filter (the second filter)”.

For example, as in the intra prediction of HEVC, in a case that the prediction mode is DC prediction, or in a case that the prediction block size is 4×4 pixels, the unfiltered reference pixel value may be used as is as the filtered reference pixel value. Furthermore, the existence of low pass filter application may be switched by a flag that is decoded from the coded data. It is noted that in a case that the prediction mode is any one of IBC prediction, luminance-chrominance prediction, and inter prediction, the directional prediction is not performed in the prediction unit 144, and thus, a filtered reference pixel value s[x, y] need not be output from the filtered reference pixel setting unit 143.

### Configuration of Prediction Unit 144

The prediction unit 144 is configured to generate a predicted image of the target prediction block, based on the input prediction mode, the unfiltered reference image, and the filtered reference pixel value, and to output the predicted image to the predicted-image correction unit 145 as a provisional predicted image (provisional predicted pixel value and pre-correction predicted image). The prediction unit 144 internally includes a DC prediction unit 144D, a Planar prediction unit 144P, a horizontal prediction unit 144H, a vertical prediction unit 144V, an angular prediction unit 144A, an inter prediction unit 144N, an IBC prediction unit 144B, and a luminance-chrominance prediction unit 144L. The prediction unit 144 is configured to select a specific prediction unit in accordance with the input prediction mode, and to input an unfiltered reference pixel value and a filtered reference pixel value. The relationship between the prediction mode and the corresponding prediction unit is as described below.

DC prediction . . . DC prediction unit 144D

Planar prediction . . . Planar prediction unit 144P

Horizontal prediction . . . Horizontal prediction unit 144H

Vertical prediction . . . Vertical prediction unit 144V

Angular prediction . . . Angular prediction unit 144A

Inter prediction . . . Inter prediction unit 144N

IBC prediction . . . IBC prediction unit 144B

Luminance-chrominance prediction . . . Luminance-chrominance prediction unit 144L

In at least one prediction mode, the prediction unit 144 generates a predicted image (a provisional predicted image q[x][y]) of the target prediction block based on the filtered reference image. In the other prediction modes, the prediction unit 144 may generate a predicted image q[x][y] by using an unfiltered reference image. Furthermore, a configuration may be such that in the directional prediction, the reference pixel filter is turned ON in a case that a filtered reference image is used, and the reference pixel filter is turned OFF in a case that an unfiltered reference image is used.

Hereinafter, an example in which a predicted image q[x][y] is generated by using an unfiltered reference image in the case of the DC prediction, horizontal prediction, vertical prediction, inter prediction, IBC prediction, and luminance-chrominance prediction, and a predicted image q[x][y] is generated by using a filtered reference image in the case of the angular prediction will be described, but the selection of the unfiltered reference image and the filtered reference image is not restricted to the present example. For example, the selection of the unfiltered reference image and the filtered reference image may be switched in accordance with a flag explicitly decoded from the coded data, or may be switched based on a flag derived from another coded parameter. For example, in the case of the angular prediction, if the difference between the target mode number and the vertical or horizontal is small, the unfiltered reference image (the reference image filter is turned OFF) may be used, and in other cases, the filtered reference image (the reference image filter is turned ON) may be used.

The DC prediction unit 144D is configured to derive a DC prediction value corresponding to a mean value of the input unfiltered reference image, and to output a predicted image (a provisional predicted image q[x, y]) in which the derived DC prediction value is the pixel value.

The Planar prediction unit 144P is configured to generate a provisional predicted image from a value derived by performing linear addition of multiple filtered reference pixel values in accordance with the distance from the prediction target pixel, and to output the provisional predicted image to the predicted-image correction unit 145. For example, the pixel value q[x, y] of the provisional predicted image can be derived according to the equation described below by using the filtered reference pixel value s[x, y] and the size nS of the target prediction block. It is noted that hereinafter, “>>” is a right shift and “<<” is a left shift.

q[x, y]=(

(nS−1−x)*s[−1, y]+(x+1)*s[nS, −1]+(nS−1−y)*s[x, −1]+(y+1)*s[−1, nS]+nS)>>(k+1)

Here, x, y=0··nS−1, and k is defined as log 2(nS).

The horizontal prediction unit 144H is configured to generate an image that is adjacent to the left side of the target prediction block, here, the unfiltered reference image r[x, y], or a predicted image (a provisional predicted image) q[x, y] by extrapolating the filtered reference pixel value s[x, y] on the reference area R in the horizontal direction, and to output the image to the predicted-image correction unit 145.

The vertical prediction unit 144V is configured to generate an image that is adjacent to the upper side of the target prediction block, here, the unfiltered reference image r[x, y], or a predicted image (a provisional predicted image) q[x, y] by extrapolating the filtered reference pixel value s[x, y] on the reference area R in the vertical direction, and to output the image to the predicted-image correction unit 145.

The angular prediction unit 144A is configured to generate an image in a prediction direction (the reference direction) indicated by the prediction mode, here, the unfiltered reference image r[x, y], or a predicted image (a provisional predicted image) q[x, y] by using a filtered reference pixel s[x, y], and to output the image to the predicted-image correction unit 145. In the angular prediction, the reference area R that is adjacent to the top or the left of the prediction block is configured as the main reference area R in accordance with a value of a main direction flag bRefVer, and the filtered reference pixel value on the main reference area R is configured as the main reference pixel value. The generation of the provisional predicted image is performed in the unit of a line or column within the prediction block by referencing the main reference pixel value. In a case that the value of the main direction flag bRefVer is 1 (the main direction being the vertical direction), a unit of generation of the provisional predicted image is configured as a line, and the reference area R on the upper side of the target prediction block is configured as the main reference area R. The main reference pixel value refMain[x] is configured according to the equation below by using the filtered reference pixel value s[x, y].

refMain[x]=s[−1+x, −1], with x=0··2*nS

refMain[x]=s[−1, −1+((x*invAngle+128)>>8)], with x=−nS··−1

It is noted that here, invAngle corresponds to a scaled value of the reciprocal number of a displacement intraPredAngle in the prediction direction. According to the equation described above, when x is within a range of 0 or more, the filtered reference pixel value on the reference area R adjacent to the upper side of the target prediction block is configured as the value of refMain[x]. Furthermore, when x is below 0, the filtered reference pixel value on the reference area R adjacent to the left side of the target prediction block is configured as the value of refMain[x] at a position derived based on the prediction direction. The predicted image (the provisional predicted image) q[x, y] is calculated by the equation below.

q[x, y]=((32−iFact)*refMain[x+iIdx+1]+iFact*refMain[x+iIdx+2]+16)>>5

Here, iIdx and iFact express the position of the main reference pixel used in the generation of the predicted pixel calculated based on the prediction target line, a distance (y+1) in the vertical direction of the main reference area R, and a gradient intraPredAngle decided in accordance with the prediction direction. iIdx corresponds to the position of integer precision in the pixel unit, and iFact corresponds to the position of fractional precision in the pixel unit, and iIdx and iFact are derived by the equation below.

iIdx=((y+1)*intraPredAngle)>>5

iFact=((y+1)*intraPredAngle) & 31

Here, “&” is an operator that expresses the bitwise operation of the logical product, for example, the result of an “A & 31” operation implies the remainder when the integer A is divided by 32.

In a case that the value of the main direction flag bRefVer is 0 (the main direction being the horizontal direction), a unit of generation of the predicted image is configured as a column and the reference area R on the left side of the target PU is configured as the main reference area R. The main reference pixel value refMain[x] is configured according to the equation below by using a filtered reference pixel value s[x, y] on the main reference area R.

refMain[x]=s[−1, −1+x], with x=0··nS

refMain[x]=s[−1+((x*invAngle+128)>>8), −1], with x=−nS··−1

The predicted image q[x, y] is calculated by the equation below.

q[x, y]=((32−iFact)*refMain[y+iIdx+1]+iFact*refMain[y+iIdx+2]+16)>>5

Here, iIdx and iFact express the position of the main reference pixel used in the generation of the predicted pixel calculated based on the prediction target column, the distance (x+1) in the horizontal direction of the main reference area R, and the gradient intraPredAngle. iIdx corresponds to the position of integer precision in the pixel unit, and iFact corresponds to the position of fractional precision in the pixel unit, and iIdx and iFact are derived by the equation below.

iIdx=((x+1)*intraPredAngle)>>5

iFact=((x+1)*intraPredAngle) & 31

The inter prediction unit 144N is configured to generate a predicted image (a provisional predicted image) q[x, y] by performing inter prediction, and to output the predicted image to the predicted-image correction unit 145. That is, in a case that the prediction type information PType input from the variable-length decoding unit 11 designates inter prediction, a predicted image is generated by performing inter prediction using the inter prediction parameter included in the prediction information PInfo, and the reference image read from the frame memory 16 (refer to FIG. 1). The inter prediction that the inter prediction unit 144N performs may be a unidirectional prediction (forward prediction or backward prediction), or may be a bidirectional prediction (an inter prediction in which the reference images included in two reference images lists are used one by one).

The inter prediction unit 144N generates the predicted image by performing motion compensation for the reference images indicated by the reference images list (an L0 list or an L1 list). More specifically, the inter prediction unit 144N reads, from among the reference images indicated by the reference images list (the L0 list or the L1 list), a reference image from a reference image memory (not illustrated in the figure) that exists at the position indicated by the motion vector mvLX with the block to be decoded as a reference. The inter prediction unit 144N generates the predicted image based on the read reference image. It is noted that the inter prediction unit 144N may generate a predicted image by a predicted-image generation mode, such as the “merge prediction mode” and the “Adaptive motion vector (AMVP) prediction mode”. It is noted that the motion vector mvLX may be an integer pixel precision, or may be a fractional pixel precision.

It is noted that the variable-length decoding unit 11 is configured to decode an inter prediction parameter by referencing a prediction parameter stored in a prediction parameter memory 307. The variable-length decoding unit 11 outputs the decoded inter prediction parameter to the predicted-image generation unit 14, and also stores the inter prediction parameter in the prediction parameter memory 307.

The IBC prediction unit 144B is configured to generate a predicted image (a provisional predicted image q[x, y]) by copying an already decoded reference area of a picture that is same as the prediction block. The technology for generating the predicted image by copying the already decoded reference area is called “IBC prediction”. The IBC prediction unit 144B outputs the generated provisional predicted image to the predicted-image correction unit 145. The IBC prediction unit 144B identifies the reference area that is to be referenced in the IBC prediction based on the motion vector mvLX (mv_x, mv_y) indicating the reference area. In this way, same as the inter prediction, the IBC prediction generates the predicted image by reading, from a reference picture (here, the reference picture=the picture to be decoded), a block that exists at a position that is shifted by as much as the motion vector mvLX from the prediction block. Particularly, a case in which the picture to be decoded that is the picture including the prediction block is set as the reference picture is called the IBC prediction, and the other cases (such as a case where a picture that is temporally different from the picture including the prediction block, or a picture from another layer or view is set as the reference picture) are called the inter prediction. That is, same as the inter prediction, the IBC prediction utilizes a vector (the motion vector mvLX) for identifying the reference area. Therefore, the IBC prediction can be handled as a type of inter prediction, and it is also possible to not differentiate the IBC prediction and the inter prediction as prediction modes (corresponding to mode definition A).

In this way, by using the target image that is being decoded as the reference image, the IBC prediction unit 144B can perform the processing according to the same framework as the inter prediction.

The luminance-chrominance unit 144L is configured to predict the chrominance based on a luminance signal.

It is noted that the configuration of the prediction unit 144 is not limited to the one described above. For example, since the predicted image generated by the horizontal prediction unit 144H and the predicted image generated by the vertical prediction unit 144V can be derived by the angular prediction unit 144A as well, a configuration in which the horizontal prediction unit 144H and the vertical prediction unit 144V are not included, and the angular prediction unit 144A is included, is also possible.

### Configuration of Predicted-Image Correction Unit 145

The predicted-image correction unit 145 is, in accordance with the input prediction mode, configured to correct the predicted image (the provisional predicted pixel value) that is the output of the prediction unit 144. Specifically, the predicted-image correction unit 145 corrects the provisional predicted image by performing a weighted addition (weighted mean) of the unfiltered reference pixel value and the provisional predicted pixel value in accordance with the distance between the reference area R and the target pixel, and outputs the provisional predicted image as a predicted image Pred (corrected), for each pixel constituting the provisional predicted image. It is noted that in some prediction modes, correction is not performed by the predicted-image correction unit 145, and the output of the prediction unit 144 may be selected as is as the predicted image. Furthermore, the configuration may be such that the output of the prediction unit 144 (the provisional predicted image, the pre-correction predicted image) and the output of the provisional image correction unit 145 (the predicted image, the corrected predicted image) are switched in accordance with a flag that is explicitly decoded from the coded data, or a flag that is derived from a coded parameter.

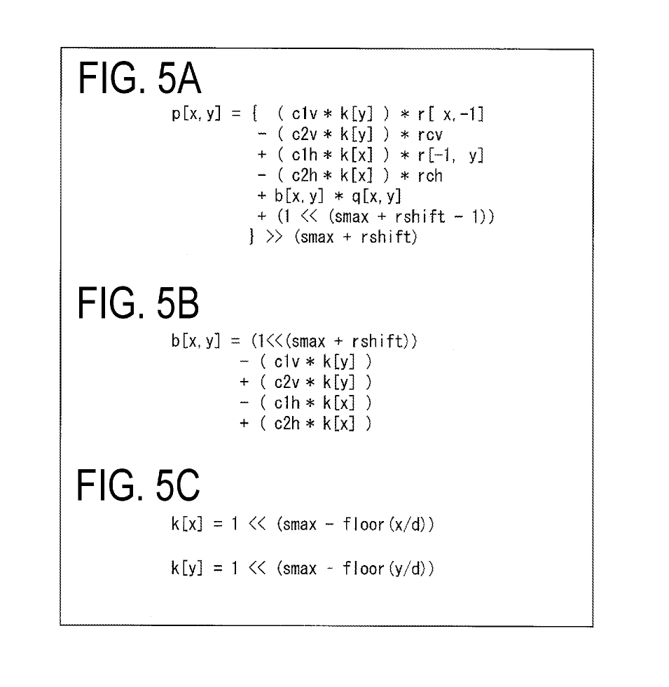

In the predicted-image correction unit 145, the process of deriving a predicted pixel value p[x, y] at a position (x, y) within a prediction block by using a boundary filter will be described with reference to FIGS. 5A to 5C. FIG. 5A illustrates the derivation equation of the predicted pixel value p[x, y]. The predicted pixel value p[x, y] is derived by performing weighted addition (weighted mean) of the provisional predicted pixel value q[x, y] and the unfiltered reference pixel value (for example, r[x, −1], r[−1, y], r[−1, −1]). The weighted addition of the boundary image of the reference area R and the predicted image is called a boundary filter. Here, smax is a predetermined positive integer value corresponding to an adjustment term for representing a distance-weighted k by an integer, and is called the first normalization adjustment term. For example, smax=4 to 10 is used. rshift is a predetermined positive integer value for normalizing a reference strength coefficient, and is called the second normalization adjustment term. For example, rshift=7 is used. A combination of the values of rshift and smax is not limited to the values described above, and another value satisfying the condition that the equation illustrated in FIG. 5A expresses the weighted addition, and the distance-weighted k is represented by an integer may be used as the predetermined value.

The weighting factor for the unfiltered reference pixel value is derived by multiplying the distance-weighted k (k[x] or k[y]) that depends on the distance (x or y) from the reference area R with the reference strength coefficient C (c1v, c2v, c1h, c2h) that is determined beforehand for each prediction direction. More specifically, the product of the reference strength coefficient c1v and the distance-weighted k[y] (vertical direction distance weighting) is used as the weighting factor (the first weighting factor w1v) of the unfiltered reference pixel value r[x, −1] (the upper unfiltered reference pixel value). Furthermore, the product of the reference strength coefficient c1h and the distance-weighted k[x] (horizontal direction distance weighting) is used as the weighting factor (the second weighting factor w1h) of the unfiltered reference pixel value r[−1, y] (the left unfiltered reference pixel value). Also, the product of the reference strength coefficient c2v and the distance-weighted k[y] (vertical direction distance weighting) is used as the weighting factor (the third weighting factor w2v) of the unfiltered reference pixel value rcv(=r[−1, −1]) (the upper-corner unfiltered reference pixel value). Furthermore, the product of the reference strength coefficient c2h and the distance-weighted k[x] (horizontal direction distance weighting) is used as the weighting factor (the fourth weighting factor w2h) of the left-corner unfiltered reference pixel value rch.

FIG. 5B illustrates the derivation equation of the weighting factor b[x, y] for the provisional predicted pixel value q[x, y]. The value of the weighting factor b[x, y] is derived so that the sum total of the product of the weighting factor and the reference strength coefficient matches “1<<(smax+rshift)”. This value has been configured with the intent of normalizing the product of the weighting factor and the reference strength coefficient based on a right shift operation of (smax+rshift) in FIG. 5A.

In FIG. 5C, a value obtained by performing left shift on 1 that is also the differential value obtained by subtracting, from smax, a value “floor(x/d)” that increases monotonically in accordance with the horizontal distance x between the target pixel and the reference area R, is configured as the distance-weighted k[x] that expresses the derivation equation of the distance-weighted k[x]. Here, floor( ) expresses a floor function, d expresses a predetermined parameter corresponding to the prediction block size, and “x/d” expresses the division of x by d (rounded down to the nearest decimal). A definition in which the horizontal distance x is replaced by the vertical distance y in the definition of the distance-weighted k[x] described earlier can be utilized for the distance-weighted k[y] as well. The value of the distance-weighted k[x] and k[y] decreases as the value of x or y increases.

According to the derivation method of the predicted pixel value described above with reference to FIGS. 5A to 5C, the larger the reference distance (x or y) that is the distance between the target pixel and the reference area R, the smaller the value of distance weighting (k[x], k[y]). Therefore, the value of the weighting factor of the unfiltered reference pixel that is obtained by the multiplication of the predetermined reference strength coefficient and distance weighting also becomes small. As a result, the nearer the position within the prediction block to the reference area R, the more the weighting of the unfiltered reference pixel value may be increased to derive a predicted pixel value with a corrected provisional predicted pixel value. Generally, the closer the position to the reference area R, the higher the possibility of the unfiltered reference pixel value being suitable as the estimation value of the pixel value of the target pixel as compared to the provisional predicted image value (the filtered predicted pixel value). Therefore, the predicted pixel value derived by the equation in FIGS. 5A to 5C is a predicted pixel value with a high prediction accuracy as compared to a case where the provisional predicted pixel value is set directly as the predicted pixel value. In addition, according to the equation in FIGS. 5A to 5C, the weighting factor for the unfiltered reference pixel value can be derived by multiplication of the reference strength coefficient and the distance weighting. Therefore, by calculating the value of distance weighting beforehand for each distance and maintaining the values in a table, the weighting factor can be derived without using the right shift operation and division.

It is noted that the reference distance was defined as the distance between the target pixel and the reference area R, and as an example of the reference distance, the position x of the target pixel within the prediction block and the position y of the target pixel within the prediction block were cited, however, other variables that express the distance between the target image and the reference area R may be utilized as the reference distance. For example, the reference distance may be defined as the distance between the predicted pixel and a pixel on the closest reference area R. Furthermore, the reference distance may be defined as the distance between the predicted pixel and a pixel on the reference area R that is adjacent to the top left of the prediction block. Furthermore, in a case that the reference distance is specified by the distance between two pixels, the distance may be a broadly-defined distance. A broadly-defined distance d(a, b) satisfies each of the properties of non-negativity (positivity): d(a, b)≥0, a=b⇒d(a, b)=0, symmetry: d(a, b)=d(b, a), and triangle inequality: d(a, b)+d(b, c)≥d(a, c) for any three points a, b, c∈X. It is noted that in the description provided hereinafter, the reference distance is expressed as a reference distance x, but x is not limited to the distance in the horizontal direction, and can be applied to any reference distance. For example, in a case that the calculation formula of the distance-weighted k[x] is cited as an example, the formula can also be applied to the distance-weighted k[y] that is calculated by using the reference distance y in the vertical direction as a parameter.

### Flow of Predication Image Correction Unit 145

Below, an operation of the predicted-image correction unit 145 will be described with reference to FIG. 7C. FIG. 7C is a flowchart illustrating an example of an operation of the predicted-image correction unit 145.

(S21) The predicted-image correction unit 145 configures the reference strength coefficient C (c1v, c2v, c1h, c2h) that has been defined beforehand for each prediction direction.

(S22) The predicted-image correction unit 145 derives, in accordance with the distance (x or y) between the target pixel (x, y) and the reference area R, each of the distance-weighted k[x] in the x direction and the distance-weighted k[y] in the y direction.

(S23) The predicted-image correction unit 145 derives the weighting factors described below by multiplying each distance weighting derived in step S22 with each reference strength coefficient derived in step S21.

First weighting factor w1v=c1v*k[y]

Second weighting factor w1h=c1h*k[x]

Third weighting factor w2v=c2v*k[y]

Fourth weighting factor w2h=c2h*k[x]

(S24) The predicted-image correction unit 145 calculates the product of each weighting factor (w1v, w1h, w2v, w2h) derived in step S23 and the corresponding unfiltered reference pixel values (r[x, −1], r[−1, y], rcv, rch). The unfiltered reference pixel values to be utilized are the upper boundary unfiltered reference pixel value r[x, −1], the left boundary unfiltered reference pixel value r[−1, y], the upper-corner unfiltered reference pixel value rcv, and the left-corner unfiltered reference pixel value rch.

The product ml of the unfiltered reference pixel value r[x, −1] and the first weighting factor w1v is m1=w1v*r[x, −1]

The product m2 of the unfiltered reference pixel value r[−1, y] and the second weighting factor w1h is m2=w1h*r[−1, y]

The product m3 of the unfiltered reference pixel value rcv and the third weighting factor w2v is m3=w2v*rcv

The product m4 of the unfiltered reference pixel value rch and the fourth weighting factor w2h is m4=w2h*rch

Here, the top left pixel r[−1, −1] is used as the upper-corner unfiltered reference pixel value rcv and the left-corner unfiltered reference pixel value rch. That is, rcv=rch=r[−1, −1]. It is noted that, as illustrated in another configuration described later, a pixel other than the top left pixel may be used as rch and rcv.

(S25) The predicted-image correction unit 145 derives the weighting factor b[x, y] for the target pixel (x, y) by the equation described below so that the sum total of the first weighting factor w1v, the second weighting factor w1h, the third weighting factor w2v, the fourth weighting factor w2h, and the weighting factor b[x, y] becomes “1<<(smax+rshift)”.

b [x, y]=(1<<(smax+rshift))−w1v−w1h+w2v+w2h

(S26) The predicted-image correction unit 145 calculates the product m5 of the provisional predicted pixel value q[x, y] corresponding to the target pixel (x, y), and the weighting factor b(x, y).

m5=b [x, y]*q[x, y]

(S27) The predicted-image correction unit 145 derives the sum total ‘sum’ of the products m1, m2, m3, and m4 derived in step S24, the product m5 derived in step S26, and the rounding adjustment term (1<<(smax+rshift−1)) by the equation below.

sum=m1+m2−m3−m4+m5+(1<<(smax+rshift−1))

(S28) The predicted-image correction unit 145 derives the predicted pixel value (corrected) p [x, y] of the target pixel (x, y) by performing a right shift operation of the added value ‘sum’ derived in step S27 with the sum (smax+rshift) of the first normalization adjustment term and the second normalization adjustment term, as illustrated below.

p [x, y]=sum>>(smax+rshift)

It is noted that the rounding adjustment term is ideally expressed as (1<<(smax+rshift−1) by the first normalization adjustment term smax and the second normalization adjustment term rshift, but is not limited thereto. For example, the rounding adjustment term may be 0, or may be any other prescribed integer.

Thus, by repeating the processes described in steps S21 to S28 for all pixels within the prediction block, the predicted-image correction unit 145 generates the predicted image (a corrected predicted image) p [x, y] within the prediction block. It is noted that the operation of the predicted-image correction unit 145 is not limited to the steps described above, but can be changed within an executable range.

### Examples of Filter Mode and Reference Strength Coefficient C

The reference strength coefficient C (c1v, c2v, c1h, c2h) of the predicted-image correction unit 145 (boundary filter) depends on the intra prediction mode (IntraPredMode), and is derived by referencing the table corresponding to the filter mode (fmode) determined based on the intra prediction mode. It is noted that as described below, the reference strength coefficient C may depend on a prediction mode other than the intra prediction (IntraPredMode), for example, the inter prediction (InterPred) mode or the IBC prediction (IbcPred) mode, and the luminance-chrominance prediction (Luma-ChromaPred) mode.

For example, in a case that a table in which the vectors of the reference strength coefficient C {c1v, c2v, c1h, c2h} are arranged is set as a reference strength coefficient table ktable, the following table can be used as the ktable (here, an example with 36 filter modes fmode (37 filter modes, if inter is included) is described).

ktable [ ][4] = { {c1v, c2v, c1h, c2h} } =
{
{ 27, 10, 27, 10 }, // IntraPredMode = PLANER (=0)
{ 22, 9, 22, 9 }, // IntraPredMode = DC (=1)
{ −10, 7, 22, 1 }, // 2
{ −10, 7, 22, 1 }, // 3
{ −5, 4, 10, 1 }, // 4
{ −5, 4, 10, 1 }, // 5
{ −8, 3, 7, 2 }, // 6
{ −8, 3, 7, 2 }, // 7
{ −48, 1, 8, 6 }, // 8
{ −48, 1, 8, 6 }, // 9
{ 20, 1, 25, 25 }, // IntraPredMode = HOR (= 10)
{ 20, 1, 25, 25 }, // 11
{ 14, −1, 5, 9 }, // 12
{ 14, −1, 5, 9 }, // 13
{ 10, 1, 1, 3 }, // 14
{ 10, 1, 1, 3 }, // 15
{ 6, 2, 2, 1 }, // 16
{ 6, 2, 2, 1 }, // 17
{ −1, 2, −1, 2 }, // 18
{ 2, 1, 6, 2 }, // 19
{ 2, 1, 6, 2 }, // 20
{ 1, 3, 10, 1 }, // 21
{ 1, 3, 10, 1 }, // 22
{ 5, 9, 14, −1 }, // 23
{ 5, 9, 14, −1 }, // 24
{ 25, 25, 20, 1 }, // 25
{ 25, 25, 20, 1}, //IntraPredMode = VER (=26)
{ 8, 6, −48, 1 }, // 27
{ 8, 6, −48, 1 }, // 28
{ 7, 2, −8, 3 }, // 29
{ 7, 2, −8, 3 }, // 30
{ 10, 1, −5, 4 }, // 31
{ 10, 1, −5, 4 }, // 32
{ 22, 1, −10, 7 }, // 33
{ 22, 1, −10, 7 }, // 34
{ 17, 8, 17, 8 }, // IntraPredMode = IBC or PredMode = IBC (=35)
({ 19, 9, 19, 9 }, // PredMode = INTER (=36))

}

Here, the filter mode fmode is derived as illustrated below.

fmode=IntraPredMode

Furthermore, if fode=36 is set for inter prediction, fmode may be derived as described below based on a higher-order prediction mode (PredMode) and a lower-order prediction mode (IntraPredMode).

fmode=PredMode==MODE_INTER ? 36: IntraPredMode

In the example described above, the reference strength coefficient C is C{c1v, c2v, c1h, c2h}=ktable[fmode]=ktable[IntraPredMode] for an IntraPredMode. That is, the reference strength coefficient C{c1v, c2v, c1h, c2h} is derived as described below.

c1v=ktable[fmode][0] (=ktable[IntraPredMode][0])

c2v=ktable[fmode][1] (=ktable[IntraPredMode][1])

c1h=ktable[fmode][2] (=ktable[IntraPredMode][2])

c2h=ktable[fmode][3] (=ktable[IntraPredMode][3])

### Directionality and Reference Strength Coefficient

With reference to the reference strength table ktable described above, the reference strength coefficient C{c1v, c2v, c1h, c2h} in a case that IntraPredMode is the planar prediction (IntraPredMode=0), the DC prediction (IntraPredMode=1), the IBC prediction (IntraPredMode=35), or the inter prediction (fmode=36) is derived from each of ktable[0], ktable[1], ktable[35], and ktable[36], and each of these cases is described as below.

{27, 10, 27, 10 }, // IntraPredMode=PRED_PLANER

{22, 9, 22, 9 }, // IntraPredMode=PRED_DC

{17, 8, 17, 8 }, // IntraPredMode=IBC or PredMode=IBC

{19, 9, 19, 9 }, // PredMode=Inter

If the focus is put on the value of vectors {c1v, c2v, c1h, c2h} described above, it is understood that c1v=c1h, c2v=c2h is established in these prediction modes. Thus, according to an embodiment of the disclosure, in the case of a prediction mode without directionality (non-directional prediction mode), that is, the Planar prediction and DC prediction, as well as the IBC prediction, and inter prediction in the present example, the reference strength coefficient c1v for determining the weighting (=w1v) applied on the upper-side unfiltered coefficient (r[x, −1] and the reference strength coefficient c1h for deciding the weighting (=w1h) applied on the left-side unfiltered coefficient (r[x, −1] are set equal to each other. In addition, in the mode without directionality, particularly, the upper-corner unfiltered reference pixel rv and the left-corner unfiltered reference pixel rh may be set as the same pixel (for example, r[−1][−1]), and the reference strength coefficients c2v and c2h for determining each of the weighting factors w2v and w2h may be set equal to each other. It is noted that according to an embodiment of the disclosure, a “prediction mode without directionality” is a prediction mode other than a mode having a correlation in a specific direction (for example, the VER mode, etc. that has a relatively strong correlation in the vertical direction). Examples of the prediction mode without directionality include Planar prediction, DC prediction, IBC prediction, inter prediction, luminance-chrominance prediction, etc.

Moreover, in the example described above, the values {c1v, c2v, c1h, c2h} of the reference filter coefficient C are configured so that an equation where the value of the Planar prediction≥the value of the DC prediction≥the value of the inter prediction≥the value of the IBC prediction

```
  (particularly,
  c1v_planar(=27) ≥ c1v_dc(=22) ≥ c1v_inter(=19) ≥ c1v_ibc(=17),
  c1h_planar(=27) ≥ c1h_dc(=22) ≥ c1h_inter(=19) ≥ c1h_ibc(=17),
  c2v_planar(=10) ≥ c2v_dc(=9) ≥ c2v_inter(=8) ≥ c2v_ibc(=8),
  c2h_planar(=10) ≥ c2h_dc(=9) ≥ c2h_inter(=8) ≥ c2h_ibc(=8),
)
```

is established. An appropriate relationship between the values of the reference filter coefficient in accordance with the prediction mode, such as the one illustrated above, will be described later.

### Flow of Predicted-Image Generation Process

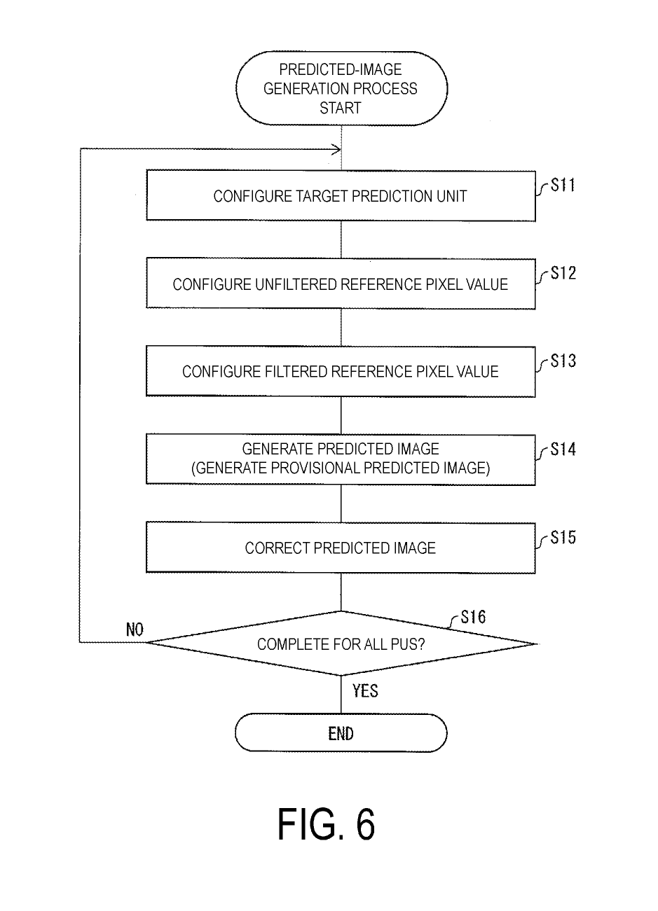

Next, an outline of a predicted-image generation process in a CU unit in the predicted-image generation unit 14 will be described by using the flowchart illustrated in FIG. 6. In a case that the predicted-image generation process starts in the CU unit, first, the prediction bock setting unit 141 configures one of the prediction blocks included in the CU as a target prediction block according to a predetermined order, and outputs target prediction bock information to the unfiltered reference pixel setting unit 142 (S11). Next, the unfiltered reference pixel setting unit 142 configures the reference pixel of the target prediction block by using the decoded pixel value read from an external frame memory, and outputs the unfiltered reference pixel value to the filtered reference pixel setting unit 143 and the predicted-image correction unit 145 (S12). Subsequently, the filtered reference pixel setting unit 143 performs a reference pixel filter on the unfiltered reference pixel value input in S12, derives a filtered reference pixel value and outputs the value to the prediction unit 144 (S13). Next, the prediction unit 144 generates a predicted image of a target prediction block from the input prediction mode and the filtered reference pixel input in S13 and outputs the generated predicted image as a provisional predicted image (S14). Next, based on the prediction mode and the unfiltered reference pixel value input in S12, the predicted-image correction unit 145 corrects the provisional predicted image input in S14 and then generates and outputs a predicted image Pred (corrected). Next, the predicted-image correction unit 145 judges whether the processing of all prediction blocks (PU) within the CU has ended, and in a case that the processing has not ended, the predicted-image correction unit 14 returns to S11 and configures the next prediction block, and in a case that the processing has ended, the predicted-image correction unit 145 ends the process (S16).

According to the configuration described above, the reference strength coefficient C (c1v, c2v, c1h, c2h) of the predicted-image correction unit 145 (boundary filter) depends on the intra prediction mode (IntraPredMode), and is derived by referencing the table in accordance with the filter mode (fmode) determined based on the intra prediction mode. In addition, the reference strength coefficient C is used for deriving the weighting factor of the closest upper pixel (that is, the pixel that is closest to the prediction target pixel [x, y] and that is included within the reference area R) r[x, −1] of the prediction target pixel [x, y], the closest left pixel r[−1, y], and the closest corner pixel (for example, the top left pixel r[−1, −1]) of the prediction target pixel [x, y]. Furthermore, the reference strength coefficient C of the boundary filter may not only be used for the weighting factor of the closest upper pixel r[x, −1], the closest left pixel r[−1, y], and the closest top left pixel r[−1, −1] of the prediction target pixel [x, y], but may also be used for the weighting factor of the closest right pixel and the closest bottom left pixel, etc., for example.

### Reference Pixel Referenced by the Predicted-Image Correction Unit 145

The predicted-image correction unit 145 may derive the predicted pixel value constituting the predicted image by applying a weighted addition using a weighting factor to a provisional predicted pixel value (a filtered predicted pixel value) in a target pixel within the prediction block, and also to at least one or more unfiltered reference pixel values, and may include either a pixel positioned at the top right of the prediction block, or a pixel positioned at the bottom left of the prediction block, without including the pixel positioned at the top left of the prediction block, in at least one or more unfiltered reference pixels.

For example, in a case that the reference pixel in the top right direction is referenced, the predicted-image correction unit 145 uses a pixel value of the reference pixel in the top right direction and the bottom left direction (r[W, −1], r[−1, H]) instead of the reference pixel in the top left direction r [−1, −1], as the corner filter reference pixels rcv and rch. In this case, the predicted-image correction unit 145 derives the predicted pixel value p[x, y] as

$$p [ x , y ] = \{ ( c 1 v * k [ y ] ) * r [ x , - 1 ] - ( c 2 v * k [ y ] ) * rcv + ( c 1 h * k [ x ] ) * r [ - 1 , y ] - ( c 2 h * k [ x ] ) * rch + b [ x , y ] * q [ x , y ] + ( 1 ≪ ( smax + rshift - 1 ) ) \} ≫ ( smax + rshift ) .$$

Here, W and H respectively indicate the width and height of the prediction block, and may, for example, take a value such as 4, 8, 16, 32, or 64 in accordance with the size of the prediction block.

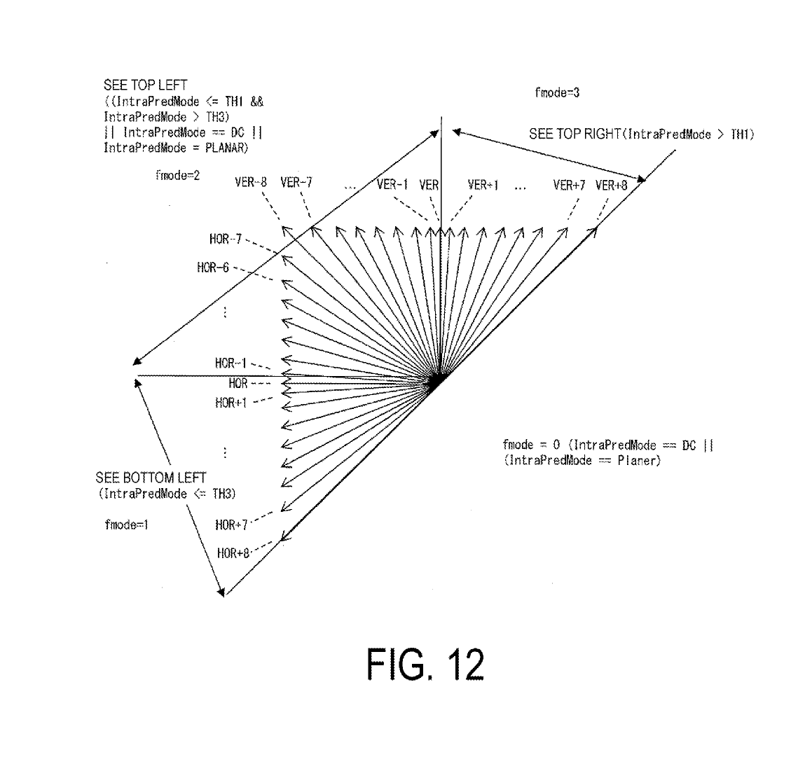

Next, a configuration where the direction of the unfiltered reference image that the predicted-image correction unit 145 references in the directional prediction is changed in accordance with the intra prediction mode (IntraPredMode) will be described by using FIG. 12. FIG. 12 is a diagram illustrating an example of classification of a prediction direction corresponding to an identifier of an intra prediction mode into filter modes fmode, such as the top left, the top right, the bottom left, and no direction, with regard to the 33 types of the intra prediction modes belonging to the directional prediction. It is noted that hereinafter, “TH” and “TH1” to “TH5” indicate predetermined threshold values. FIG. 12 illustrates an example where, if the prediction mode is the directional prediction of intra prediction, and further, the direction of the directional prediction is prediction from the top right, that is, in a case that IntraPredMode>TH1, a filter mode in which the top right direction is the reference direction (for example, filter mode fmode=3) is derived, and if the prediction mode is the directional prediction of intra prediction, and further, the direction of the directional prediction is prediction from the bottom left, that is, in a case that IntraPredMode<=TH3, a filter mode in which the bottom left direction is the reference direction (for example, filter mode fmode=1) is derived, and if the prediction mode is the directional prediction of intra prediction, and further, the direction of the directional prediction is prediction from the top left, that is, one of the filter modes where IntraPredMode<=TH1 && IntraPredMode>TH3 is the reference direction (for example, filter mode fmode=2) is derived, and if the prediction mode is other than the directional prediction, like IntraPredMode==DC or IntraPredMode==PLANER, a filter mode that does not have a reference direction (for example, filter mode fmode=0) is derived.

The pixel value of the upper corner unfiltered reference pixel rcv is the pixel value of the top right pixel rcv=r[W, −1] in the case of a filter mode in which the top right is the reference direction (in the case that IntraPredMode>TH1), and is the pixel value of the top left pixel rcv=r[−1, −1] in the case of a filter mode in which the top left or the bottom left is the reference direction, or in which there is no reference direction (in the case that IntraPredMode is TH1<=TH1, or IntraPredMode==DC, or IntraPredMode==PLANER).

As for the left corner unfiltered reference pixel value rch, in the case of a filter mode in which the top left or the top right is the reference direction, or in which there is no reference direction (in the case that IntraPredMode>TH3, or IntraPredMode==DC, or IntraPredMode==PLANER), the top left pixel rch=r[−1, −1], and in the case of a filter mode in which the bottom left is the reference direction (in the case that IntraPredMode<=TH3), the bottom left pixel rch=r[−1, H]. By thus determining the reference direction, the predicted-image correction unit 145 may use the top right direction or the bottom left direction as the corner unfiltered reference pixel. Furthermore, the predicted-image correction unit 145 may not use the bottom left or the top right direction as the reference direction in the DC prediction and the Planar prediction.

It is noted that FIG. 12 illustrates an example where VER+1 to VER+8 that use the right side (top right side) rather than the vertical direction (VER) as the prediction direction are included in IntraPredMode>TH1, HOR+1 to HOR+8 that use the bottom side (bottom left side) rather than the horizontal direction (HOR) as the prediction direction are included in IntraPredMode<=TH3, and VER−8 to VER−1 that use the right direction from the top left as the prediction direction, and HOR−1 to HOR−8 that use the bottom direction from the top left as the prediction direction are included in IntraPredMode<=TH1 && IntraPredMode>TH3, however, the method of classifying the prediction direction corresponding to the identifier of the intra prediction mode is not limited hereto.

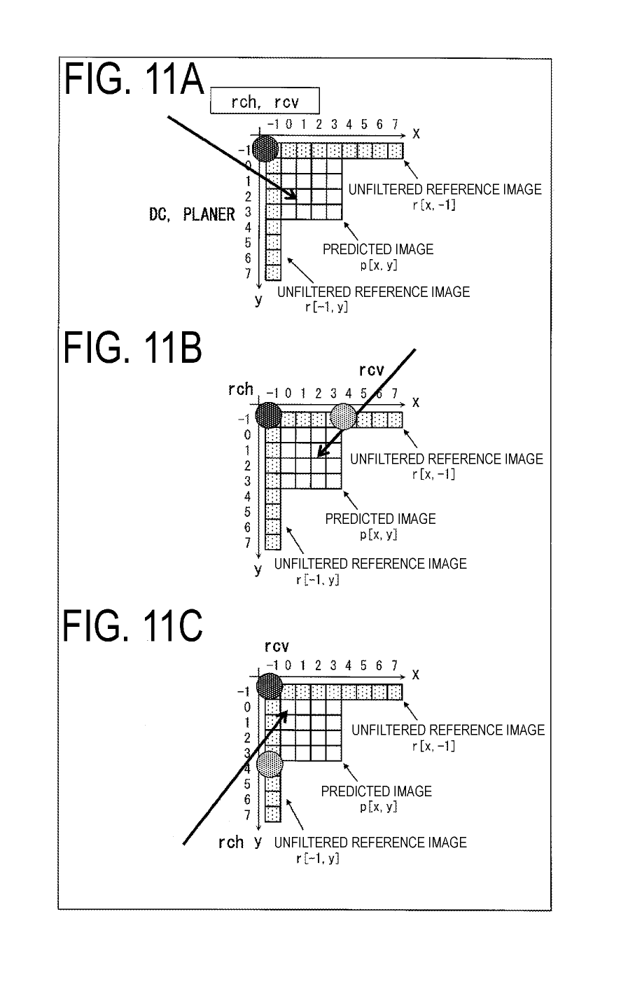

Next, the left-corner unfiltered reference pixel value rcv and the left-corner unfiltered reference pixel value rch will be described by using FIGS. 11A to 11C.

FIGS. 11A to 11C are diagrams illustrating a positional relationship between a predicted pixel on a prediction block in an intra prediction, and an unfiltered reference pixel on a reference area R configured for a prediction block, FIG. 11A, FIG. 11B, and FIG. 11C are diagrams illustrating an example of deriving a predicted pixel on a prediction block from a reference pixel value on a reference region R configured at top left, top right, and bottom left, respectively.

In a case that a predicted pixel on a prediction block is to be derived from a reference pixel value on a reference area R configured at the top left, for an intra prediction without directionality (such as in the case of the DC prediction and the Planar prediction), the predicted-image correction unit 145 uses the top left pixel r[−1, −1] as the upper-corner unfiltered reference pixel value rcv and the left-corner unfiltered reference pixel value rch, and derives the predicted pixel on the prediction block.

In the case that the predicted pixel on the prediction block is to be derived from the reference pixel value on the reference area R configured at the top right, the predicted-image correction unit 145 uses the top right pixel r[W, −1] as the upper-corner unfiltered reference pixel value rcv, and on the other hand, uses the top left pixel r[−1, −1] as the left-corner unfiltered reference pixel value rch, and derives the predicted pixel on the prediction block. It is noted that in a case that the top right pixel r[W, −1] does not exist, a value obtained by copying another existent pixel (for example, r[W−1, −1], etc.) may be used as a substitute. Here, W is the width of the prediction block.

In a case that a predicted pixel on a prediction block is to be derived from a reference pixel value on a reference area R configured at the bottom left, the predicted-image correction unit 145 uses the top left pixel r[−1, −1] as the upper-corner unfiltered reference pixel value rcv, and on the other hand, uses the bottom left pixel r[−1, H] as the left-corner unfiltered reference pixel value rch, and derives the predicted pixel on the prediction block. It is noted that in a case the bottom left pixel r[−1, H] does not exist, a value obtained by copying another existent pixel (for example, r[−1, H−1], etc.) may be used as a substitute. Here, H is the height of the prediction block.

That is, in a case that the predicted-image correction unit 145 corrects the provisional predicted image in accordance with the product of the weighting factor that is determined in accordance with the reference strength coefficient and distance, and the unfiltered reference pixel, the predicted-image correction unit 145 may include a pixel positioned at the top right of the prediction block, or a pixel positioned at the bottom left of the prediction block in at least one or more unfiltered reference pixels, in accordance with the directionality (IntraPredMode) indicated by the prediction mode.

### Reduction in Size of Filter Strength Coefficient Table 191 Referenced by Predicted-Image Correction Unit 145

In a case that the filter strength of the boundary filter (reference strength coefficient C) is determined depending on the intra prediction mode, a size of a filter strength coefficient table 191 that is the reference strength coefficient referenced by the predicted-image correction unit 145 increases as the number of filter modes fmode increases. In order to reduce the size of the filter strength coefficient table 191, the predicted-image correction unit 145 may, for at least one filter mode fmode, determine the filter strength coefficient (weighting factor) by referencing the filter strength coefficient table 191, and may, for at least one other filter mode fmode, determine a weighting factor by referencing one or more filter strength coefficient tables 191 corresponding to a table index based on one or more table indexes derived from a filter mode fmode other than the other filter modes. The number of the filter strength coefficient table 191 may be smaller (less) than the number of the filter modes.

The predicted-image correction unit 145 may, as described above, determine a weighting factor corresponding to the filter mode fmode for the provisional predicted pixel value of the target pixel in the prediction block, and also for at least one or more unfiltered reference pixel values, and may apply a weighted addition to derive a predicted pixel value constituting the predicted image.

In this configuration, in a case that the predicted-image correction unit 145 determines the weighting factor for a certain filter mode fmode, the predicted-image correction unit 145 can utilize (re-utilize) the filter strength coefficient table 191 that is referenced for determining the weighting factor for the other filter modes fmode, and thus derive the predicted pixel value. As a result, it is not necessary to include the filter strength coefficient table 191 for all filter modes fmode, and the size of the filter strength coefficient table 191 can thus be reduced.

Below, a few examples of a configuration having an effect of reducing the size of the filter strength coefficient table 191 will be described.

### Example 1 of Reduction of Size of Filter Strength Coefficient Table in Directional Prediction

In a case that 0 to N (N is 2 or a higher integer) filter modes fmode exist for a boundary filter, the predicted-image correction unit 145 may determine the weighting factor (reference strength coefficient C) for the filter mode fmode=m (m is 1 or a higher integer) by referencing a table for the filter mode fmode=m−1, and a table for the filter mode fmode=m+1.

That is, the filter strength coefficient table 191 that the predicted-image correction unit 145 references in the case of determining the weighting factor for a boundary filter with filter modes fmode=0 to N need not include a weighting factor for all filter modes. For example, the filter strength coefficient table 191 of the filter mode fmode=m may be derived from the mean value of the filter strength coefficient table 191 of the filter mode fmode=m−1, and that of the filter mode fmode=m+1.

The predicted-image correction unit 145 may determine the reference strength coefficient (c1v, c2v, c1h, c2h) that is predetermined for each prediction direction as

c1v=c1vtable[fmode/2] (if fmode %2==0)

c2v=c2vtable[fmode/2] (if fmode %2==0)

c1h=c1htable[fmode/2] (if fmode %2==0)

c2h=c2htable[fmode/2] (if fmode %2==0)

for the filter mode fmode=m−1 and the filter mode fmode=m+1, and may determine the reference strength coefficient (c1v, c2v, c1h, c2h) as

c1v=(c1vtable[fmode/2]+c1vtable[fmode/2+1])/2 (if fmode %2==1)

c2v=(c2vtable[fmode/2]+c2vtable[fmode/2+1])/2 (if fmode %2==1)

c1h=(c1htable[fmode/2]+c1htable[fmode/2+1])/2 (if fmode %2==1)

c2h=(c2htable[fmode/2]+c2htable[fmode/2+1])/2 (if fmode %2==1)

for the filter mode fmode=m.

With such a configuration, the size of the filter strength coefficient table 191 that the predicted-image correction unit 145 references in the case of determining the weighting factor for a boundary filter with filter modes fmode=0 to N can be reduced to half.

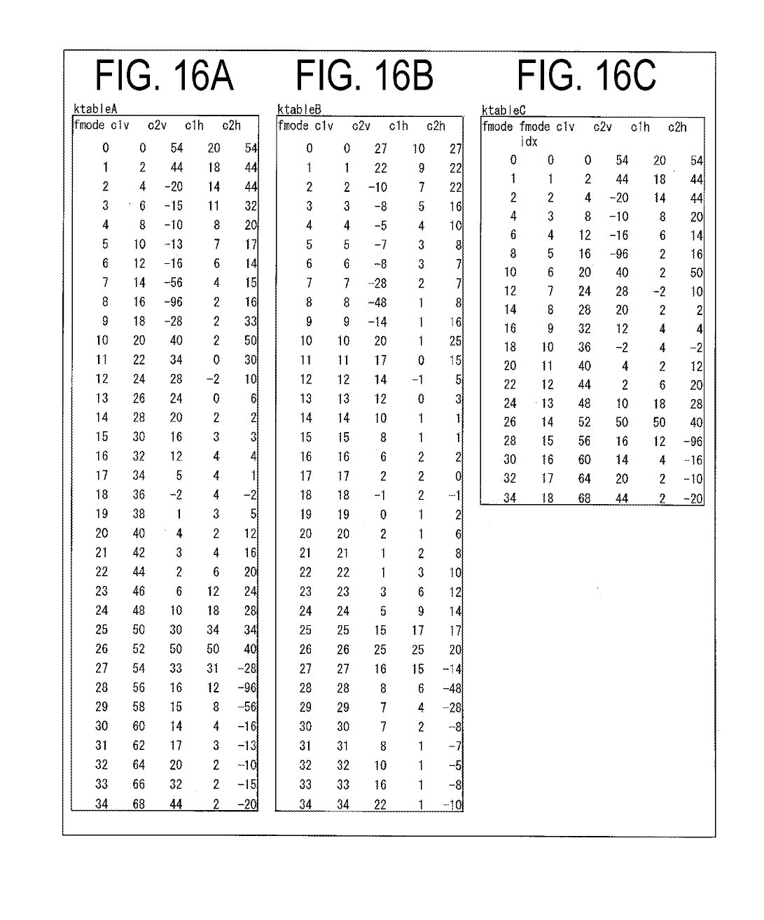

For example, FIGS. 16A to 16C illustrate an example where some of the fmodes have a fixed table value, here, fmode=0, 1, 2n, . . . 34 (n=1 . . . 17) from among the fmodes within a predetermined range (here, fmode=0 . . . 34), and on the other hand, a reference strength table ktable having a relationship derived from the fixed table value is used for the other fmodes (=3, 5, . . . 2n+1, . . . 33, n=1 . . . 16). The example illustrated in FIGS. 16A to 16C indicates that the derivable table in a case of a value i of the fmode (i=fmode) is derived from the mean of the reference strength coefficient of the fixed tables with an index of fmode=i−1 and i+1. FIGS. 16A to 16C are diagrams illustrating an example of a table in which the vectors of the reference strength coefficient C{c1v, c2v, c1h, c2h} are arranged.

For example, same as the ktableA illustrated in FIG. 16A, if a table

ktableA[fmode]=ktableA[fmode] (if fmode=0, 1, 2n, n=1 . . . 17)

ktableA[fmode]=(ktableA[fmode*2−1]+ktableA[fmode*2+1])/2 (if fmode=2n+1, n=1 . . . 16)

c1v=ktableA[fmode][0]

c2v=ktableA[fmode][1]

c1h=ktableA[fmode][2]

c2h=ktableA[fmode][3]

is assumed, the size of the filter strength coefficient table 191 can be reduced (compressed) to half.

It is noted that here, the mean is used, but a weighted mean may also be used.

Furthermore, in a case that fractional points occur when a derivable table is derived by the mean or the weighted mean of the fixed table values, a process for conversion to integers may be added after the mean or weighted mean. Specifically, same as the ktableB illustrated in FIG. 16B, if a table

ktableB[fmode]=ktableB[fmode] (if fmode=0, 1, 2n, n=1 . . . 17)

ktableB[fmode]=INT((ktableB[fmode*2−1]+ktableB[fmode*2+1])/2) (if fmode=2n+1, n=1 . . . 16)

c1v=ktableB[fmode][0]

c2v=ktableB[fmode][1]

c1h=ktableB[fmode][2]

c2h=ktableB[fmode][3]

is assumed, the size of the filter strength coefficient table 191 can be reduced (compressed) to half while limiting the value of the derivable table to integers. Here, INT expresses an operation of conversion to integers, where fractional points are rounded up or rounded down. Furthermore, the division and conversion to integers for the mean may be performed simultaneously, for example, the division by 2, and the process INT(x/2) for conversion to integers can be replaced by 1, a right shift by 1 (x>>1), or a right shift performed after adding the constant 1 for rounding, and (x+1)>>1.

It is noted that rather than having a table including the coefficient value of the derivation destination (deriving the fmode table from fmode−1 and fmode+1), the ktableC illustrated in FIG. 16C may be used only as a derivation-source fixed table, and the reference strength coefficient C in an fmode may be derived from the table. That is, the table of the fmode may be derived from fmodeidx and fmodeidx+1. Here, an example in which a reference strength coefficient equivalent to the ktableA can be derived will be described.

ktable[fmode]=ktableC[fmodeidx] (fmode=0, 1, 2n, n=1 . . . 17)

ktable[fmode]=ktableC[fmodeidx]+ktableC[fmodeidx+1]

(fmode=2n+1, n=1 . . . 16)

fmodeidx=(fmode<2) ? fmode : (fmode>>1)+1

c1v=ktable[fmode][0]

c2v=ktable[fmode][1]

c1h=ktable[fmode][2]

c2h=ktable[fmode][3]

It is noted that the configuration described above can be interpreted as a configuration in which the derived reference strength coefficient C is saved once in ktable, but although the configuration may be assumed to be such that the derived reference strength coefficient C is saved in ktable, a configuration in which rather than saving in ktable, a directly-derived reference strength coefficient is used may also be assumed.

### Example 2 of Reduction of Size of Filter Strength Coefficient Table in Directional Prediction

In addition to the filter mode fmode corresponding to the directionality, the weighting factor (reference strength coefficient C) of the boundary filter also depends on the block size blksize of the prediction block. Thus, in a case that the predicted-image correction unit 145 determines the weighting factor for a boundary filter with filter mode fmode=0 to N, the weighting factor may be determined in accordance with the block size of the prediction block. That is, the predicted-image correction unit 145 may determine the weighting factor for a certain block size by referencing the weighting factor of other block sizes.

If the index indicating the block size is assumed as blkSizeIdx, the blkSizeIdx is

blkSizeIdx=log 2(blksize)−2,

and the predicted-image correction unit 145 may determine the reference strength coefficient (c1v, c2v, c1h, c2h) determined beforehand for each prediction direction as

c1v=c1vtable[blkSizeIdx/2][fmode] (if blkSizeIdx %2==0)

c2v=c2vtable[blkSizeIdx/2][fmode] (if blkSizeIdx %2==0)

c1h=c1htable[blkSizeIdx/2][fmode] (if blkSizeIdx %2==0)

c2h=c2htable[blkSizeIdx/2][fmode] (if blkSizeIdx %2==0)

for the filter mode fmode=m−1 and the filter mode fmode=m+1, and as

c1v=(c1vtable[blkSizeIdx/2][fmode]+c1vtable[blkSizeIdx/2+1][fmode])/2 (blkSizeIdx %2==1)

c2v=(c2vtable[blkSizeIdx/2]+c2vtable[blkSizeIdx/2+1])/2 (if blkSizeIdx %2 ==1)

c1h=(c1htable[blkSizeIdx/2]+c1htable[blkSizeIdx/2+1])/2 (if blkSizeIdx %2 ==1)

c2h=(c2htable[blkSizeIdx/2]+c2htable[blkSizeIdx/2+1])/2 (if blkSizeIdx %2 ==1)

for the filter mode fmode=m.

### Example 3 of Reduction of Size of Filter Strength Coefficient Table in Directional Prediction

In addition, in a case that the predicted-image correction unit 145 determines the weighting factor (reference strength coefficient C) for the boundary filter with filter mode fmode=0 to N in accordance with the block size (PU size) of the prediction block, the predicted-image correction unit 145 may derive the weighting factor for a prediction block with a certain block size as being same as the weighting factor for a prediction block with another block size. For example, in a case that the block size of a prediction block exceeds a predetermined size, the predicted-image correction unit 145 determines the weighted coefficient by referencing the same filter strength coefficient table 191 regardless of the block size.

For example, in the case of a small block size (for example, 4×4 and 8×8), the predicted-image correction unit 145 determines the weighting factor by referencing a different filter strength coefficient table 191 for each block size, and in the case of a large block size (16×16, 32×32, and 64×64), the predicted-image correction unit 145 determines the weighting factor by referencing the same filter strength coefficient table 191 for all block sizes.

In this case, if the index indicating the block size is assumed to be blkSizeIdx, then

blkSizeIdx=0 (if PUsize=4)

blkSizeIdx=1 (if PUsize=8)

blkSizeIdx=2 (if PUsize>=16),

and the predicted-image correction unit 145 may determine the reference strength coefficient (c1v, c2v, c1h, c2h) determined beforehand for each prediction direction as

c1v=c1vtable[fmode][blkSizeIdx]

c2v=c2vtable[fmode][blkSizeIdx]

c1h=c1htable[fmode][blkSizeIdx]

c2h=c2htable[fmode][blkSizeIdx].

It is noted that “PUsize>=16” implies that the PU size is 16×16 or more.

### Switching Filter Strength of Boundary Filter

In a case that the strength of the reference pixel filter applied to the reference pixel in the filtered reference pixel setting unit 143 is low, it may be better to reduce the strength of the boundary filter applied in the predicted-image correction unit 145 used for correcting the pixel value on the reference area R near the boundary of the prediction block. However, in the related art, there are technologies to simply change the existence of a reference pixel filter applied to a reference pixel, and the filter strength applied to the reference pixel, but no technologies for switching the strength of a boundary filter used for correcting the pixel value on the reference area near the boundary of the prediction block. Therefore, it was not possible to switch the strength of the boundary filter used for correcting the pixel value on the reference area near the boundary of the prediction block in accordance with the existence and strength of the reference pixel filter applied to the reference pixel.

Thus, the filtered reference pixel setting unit 143 derives a filtered reference pixel value by switching the strength or the ON/OFF status of the reference pixel filter (the first filter), and activating the reference pixel filter for the pixel on the reference area R that is configured for the prediction block. The prediction unit 144 is configured to derive a provisional predicted pixel value of the prediction block by referencing the filtered reference pixel value on the reference area R by a prediction method corresponding to the prediction mode.

The predicted-image correction unit 145 switches the strength or the ON/OFF status of the boundary filter in accordance with the strength or the ON/OFF status of the reference pixel filter. The predicted-image correction unit 145 generates a predicted image by performing a correction process on a provisional predicted image based on the unfiltered reference pixel value on the reference area R and the prediction mode. The predicted-image correction unit 145 derives a predicted pixel value constituting a predicted image by applying, to a provisional predicted pixel value of a target pixel in a prediction block, and also to at least one or more unfiltered reference pixel values, a boundary filter (the second filter) using a weighted addition based on a weighting factor.

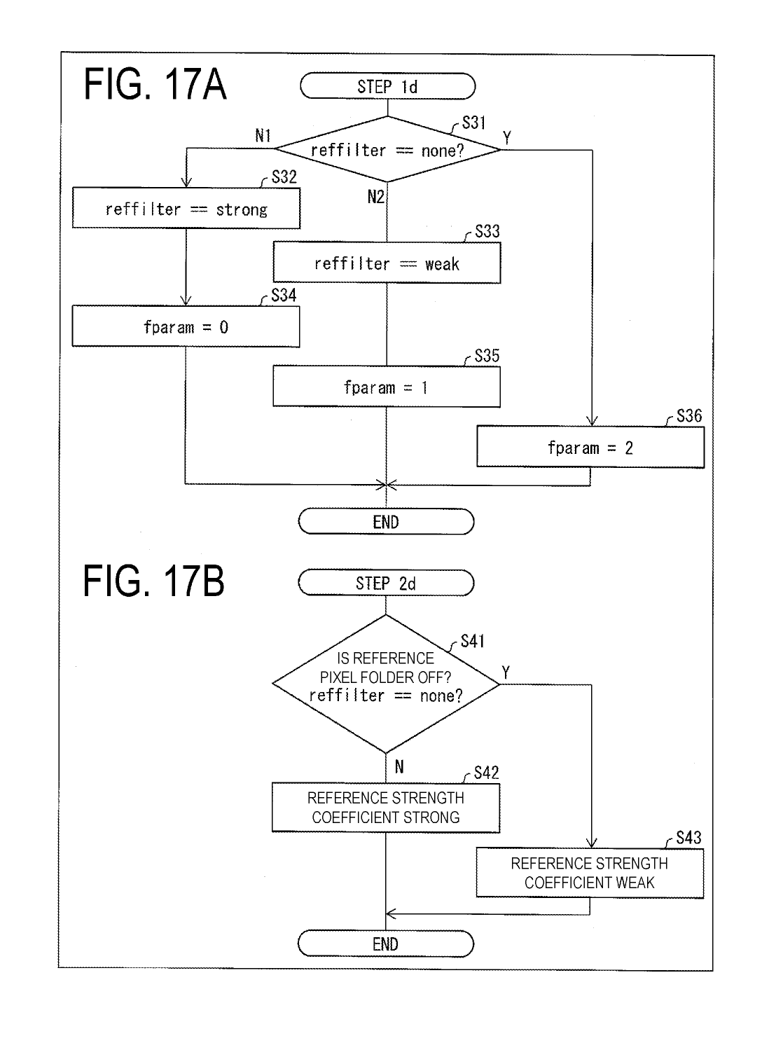

Hereinafter, a process in which the filtered reference pixel setting unit 143 derives the filter strength coefficient fmode of the reference pixel filter (STEP 1d), and a process in which the predicted-image correction unit 145 switches the filter strength C of the boundary filter in accordance with the existence or filter strength reffilter of the reference pixel filter (STEP 2d) will be described by citing specific examples in FIGS. 17A and 17B.

### STEP 1d: Deriving the Filter Strength Coefficient of the Reference Pixel Filter

FIG. 17A is a flowchart illustrating an example of a flow of a process for deriving, by the filtered reference pixel setting unit 143, the filter strength coefficient C of a reference pixel filter in accordance with a reference pixel filter. In the example illustrated in the figure, in a case that the reference pixel filter is OFF (Y in S31), the filtered reference pixel setting unit 143 configures the filter mode fmode for determining the filter strength coefficient C as 2 (S36). On the other hand, in a case that the reference pixel filter is not OFF (N1 or N2 in S31), the filtered reference pixel setting unit 143 configures the filter mode fmode in accordance with the strength of the reference pixel filter. In a case that the reference pixel filter is strong (N1 in S31), the filtered reference pixel setting unit 143 configures the filter mode fmode as 0 (S34), and in a case that the reference pixel filter is weak (N2 in S31), the filtered reference pixel setting unit 143 configures the filter mode fmode as 1 (S35).

That is, in a case that the three stages of strong, weak, and none are configured for the filter strength reffilter of the processing reference pixel filter, the filtered reference pixel setting unit 143 may configure the filter mode fmode for switching the filter strength coefficient C as

fmode=0 (reffilter==strong)

fmode=1 (reffilter==weak)

fmode=2 (reffilter==none)

### STEP 2d: Switching the Filter Strength of the Boundary Filter

FIG. 17B is a flowchart illustrating an example of a flow of a process for switching, by the predicted-image correction unit 145, the strength of the reference strength coefficient C in accordance with a reference pixel filter. In the example illustrated in the figure, in a case that the reference pixel filter is OFF (Y in S41), the predicted-image correction unit 145 configures the reference strength coefficient C as weak (S43), and in a case that the reference pixel filter is not OFF (N in S41), the predicted-image correction unit 145 configures the strength of the reference strength coefficient C as strong (S42).

It is noted that in a case that the reference pixel filter is OFF (that is, reffilter==none), the predicted-image correction unit 145 may configure the reference strength coefficient C of the boundary filter as 0. In such a case, the predicted-image correction unit 145 may switch whether to configure the reference strength coefficient (c1v, c2v, c1h, c2h) that is determined beforehand for each prediction direction to 0 in accordance with the state of the reference pixel filter or to reference the table of the reference strength coefficient, for example, configure

c1v=(reffilter==none) ?0:c1vtable[fmode]

c2v=(reffilter==none) ?0:c2vtable[fmode]

c1h=(reffilter==none) ?0:c1htable[fmode]

c2h=(reffilter==none) ?0:c2htable[fmode].

As in the example illustrated in FIG. 17B, in a case that the reference pixel filter is OFF (that is, reffilter==none), the predicted-image correction unit 145 may configure the reference strength coefficient C of the boundary filter as weak, and in a case that the reference pixel filter is ON (that is, reffilter==strong or weak), the predicted-image correction unit 145 may configure the reference strength coefficient C of the boundary filter as strong. In such a case, the predicted-image correction unit 145 may switch between: to use the values of the table of the reference strength coefficient as they are; and to add a change to the values of the table of the reference strength coefficient, wherein the reference strength coefficient (c1v, c2v, c1h, c2h) is determined beforehand for each prediction direction, in accordance with the state of the reference pixel filter. For example, the predicted-image correction unit 145 may configure

c1v=(reffilter==none) ?0:c1vtable[fmode]>>1:c1vtable[fmode]

c2v=(reffilter==none) ?0:c2vtable[fmode]>>1:c2vtable[fmode]

c1h=(reffilter==none) ?0:c1htable[fmode]>>1:c1htable[fmode]

c2h=(reffilter==none) ?0:c2htable[fmode]>>1:c2htable[fmode].

Here, a method according to which the value of the reference strength coefficient (c1vtable[fmode], c2vtable[fmode]. c1htable[fmode], c2htable[fmode]) to be referenced is reduced by performing a right shift in the case that the reference pixel filter is OFF (that is, reffilter==none) is used, but another method may also be used. For example, a table in a case that the reference pixel filter is OFF (that is, reffilter==none), and a table in a case that the reference pixel filter is ON may be prepared (switched), and the value of the table in the case that the reference pixel filter is OFF (that is, reffilter==none) may be set equal to or below the value of the table in the case that the reference pixel filter is ON.

Alternatively, the predicted-image correction unit 145 may switch the reference strength coefficient C of the boundary filter in accordance with the parameter fparam for switching the filter strength coefficient C of the reference pixel filter. fparam is derived, for example, as described below, in accordance with the reference filter.

fparam=0 (reffilter==strong)

fparam=1 (reffilter==weak)

fparam=2 (reffilter==none)

Next, the predicted-image correction unit 145 adds a change to the value obtained by referencing the table in accordance with the derived parameter fparam, and determines the reference strength coefficient C (c1v, c2v, c1h, c2h). For example, in a case that the filter strength reffilter of the reference pixel filter is strong (fparam=0 in the example described above), the predicted-image correction unit 145 may configure the reference strength coefficient C of the boundary filter as strong, and in a case that the filter strength reffilter of the reference pixel filter is weak or none (fparam=1 or 2 in the example described above), the predicted-image correction unit 145 may configure the reference strength coefficient C of the boundary filter as weak. In such a case, the predicted-image correction unit 145 may configure the reference strength coefficient C (c1v, c2v, c1h, c2h) that is determined beforehand for each prediction direction as

c1v=c1vtable[fmode]>>fparam

c2v=c2vtable[fmode]>>fparam

c1h=c1htable[fmode]>>fparam

c2h=c2htable[fmode]>>fparam.

According to such a configuration, it is possible to switch the strength of a filter used for correcting the provisional predicted pixel value near the boundary of a prediction block in accordance with the existence and strength of the filter applied to the reference pixel. As a result, the predicted pixel value near the boundary of the prediction block can be appropriately corrected.

Switching the Filter Strength of the Boundary Filter in a Case that an Edge Exists Near the Boundary of the Prediction Block

It is known that if a boundary filter is applied in a case that an edge exists near the boundary of a prediction block, an artifact, such as a line, may occur in the predicted image. Therefore, in the case that an edge exists near the boundary of a prediction block, it is desirable to weaken the filter strength.

Thus, the filtered reference pixel setting unit 143 derives a filtered reference pixel value by activating the reference pixel filter for the pixel on the reference area R that is configured for the prediction block. The prediction unit 144 derives a provisional predicted pixel value of the prediction block by referencing the filtered reference pixel value by a prediction method corresponding to the prediction mode.

The predicted-image correction unit 145 derives a predicted pixel value constituting a predicted image by applying, to a provisional predicted pixel value of a target pixel in a prediction block, and also to at least one or more unfiltered reference pixel values, a boundary filter using a weighted addition based on a weighting factor, and generates a predicted image from the provisional predicted pixel value by performing a correction process based on the unfiltered reference pixel value on the reference area R and the prediction mode.

For example, in a case that an edge exists in the boundary adjacent to the upper side, the predicted-image correction unit 145 weakens the reference strength coefficient C of the upper boundary filter, and in a case that an edge exists in the boundary adjacent to the left side, the predicted-image correction unit 145 weakens the reference strength coefficient C of the left boundary filter.

Hereinafter, a process in which the filtered reference pixel setting unit 143 derives an edge flag (STEP 1e-1), and a process in which the predicted-image correction unit 145 switches the filter strength C of the boundary filter for each edge flag (STEP 2e-1) will be described by citing specific examples.

### STEP 1e-1: Deriving an Edge Flag

The predicted-image correction unit 145, by referencing an adjacent pixel, derives an edge flag that is a flag indicating whether or not an edge exists in an adjacent boundary. For example, in accordance with whether or not the number of times that the absolute value of differential value of an adjacent pixel exceeds the threshold value TH exceeds the THCount, the filtered reference pixel setting unit 143 may derive an upper edge flag edge_v and a left edge flag edge_h as

edge_v=(Σ(|r[x+1, −1]−r[x, −1]|>TH? 1:0))>THCount ? 1:0

edge_h=(Σ(|r[−1, y]−r[−1, y+1]|>TH? 1:0))>THCount ? 1:0,

respectively. In a case that an edge exists, the edge flag is set to 1.

### STEP 2e-1: Switching the Filter Strength of the Boundary Filter

In a case that the edge flag indicates the existence of an edge, the predicted-image correction unit 145 may configure the reference strength coefficient C of the boundary filter as 0. In such a case, the predicted-image correction unit 145 may configure the reference strength coefficient C (c1v, c2v, c1h, c2h) that has been defined beforehand for each prediction direction as

c1v=edge_v ? 0:c1vtable[fmode]

c2v=edge_v ? 0:c2vtable[fmode]

c1h=edge_h ? 0:c1htable[fmode]

c2h=edge_h ? 0:c2htable[fmode].

Alternatively, in a case that the edge flag indicates the existence of an edge, the predicted-image correction unit 145 may weaken (lower) the reference strength coefficient C of the boundary filter. In such a case, the predicted-image correction unit 145 may change the reference strength coefficient in accordance with the edge flag, for example, the predicted-image correction unit 145 may configure the reference strength coefficient C (c1v, c2v, c1h, c2h) that is determined beforehand for each prediction direction as

c1v=c1vtable[fmode]>>edge_v

c2v=c2vtable[fmode]>>edge_v

c1h=c1htable[fmode]>>edge_h

c2h=c2htable[fmode]>>edge_h.

It is noted that in STEP 1e-1 and STEP 2e-1 described above, a case in which each of the value of the upper edge flag edge_v and the left edge flag edge_h configured by filtered reference pixel setting unit 143 is a binary value indicating whether or not an edge exists was described, but the values are not restricted thereto. Hereinafter, an example of a case in which multiple values (for example, 0, 1, and 2) can be configured for both the upper edge flag edge_v and the left edge flag edge_h will be described.

### STEP 1e-2: Deriving an Edge Flag

For example, in accordance with whether or not the number of times that the absolute value of differential value (ACT_v, ACT_h) of a pixel adjacent to the upper side exceeds the threshold value TH exceeds the THCount1, THCount2, the filtered reference pixel setting unit 143 may derive an upper edge flag edge_v as

ACT_v=(Σ(|r[x+1, −1]−r[x, −1]|>TH? 1:0))

ACT_h=(Σ(|r[−1, y]−r[−1, y+1]|>TH? 1:0))

edge_v=2 (if ACT_v>THCount2)

edge_v=1 (else if ACT_v>THCount1)

edge_v=0 (otherwise)

and on the other hand, the filtered reference pixel setting unit 143 may derive a left edge flag edge_h as

edge_h=2 (if ACT_h>THCount2)

edge_h=1 (else if ACT_h>THCount1)

edge_h=0 (otherwise).

THCount1 and THCount2 are predetermined constants that satisfy the relationship THCount2>THCount1.

### STEP 2e-2: Switching the Filter Strength of the Boundary Filter

The predicted-image correction unit 145 may switch the reference strength coefficient C of the boundary filter in accordance with the edge flag. In such a case, the predicted-image correction unit 145 may change in accordance with the edge flag, the reference strength coefficient C (c1v, c2v, c1h, c2h) that is determined beforehand for each prediction direction, for example, may configure as

c1v=c1vtable[fmode]>>edge_v

c2v=c2vtable[fmode]>>edge_v

c1h=c1htable[fmode]>>edge_h

c2h=c2htable[fmode]>>edge_h.

In the description above, the reference strength coefficient C was derived in accordance with the size of the edge flag by a shift operation based on a value corresponding to the edge flag, however, the derivation process is not limited thereto.

For example, the predicted-image correction unit 145 may derive the weighting corresponding to the value of the edge flag by referencing the table, and may accordingly, derive the reference strength coefficient. That is, the predicted-image correction unit 145 multiples the weighting w (wtable[edge_v] and wtable[edge_h]) corresponding to the edge flag, and performs a shift.

c1v=c1vtable[fmode]*wtable[edge_v]>>shift

c2v=c2vtable[fmode]*wtable[edge_v]>>shift

c1h=c1htable[fmode]*wtable[edge_h]>>shift

c2h=c2htable[fmode]*wtable[edge_h]>>shift

Here, the table may, for example, have the following value:

wtable[]={8, 5, 3}

shift=3

Switching the Filter Strength of the Boundary Filter in Accordance with the Quantization Step

Generally, if the divisor during quantization (quantization step) becomes small, it is possible to reduce the strength of the filter used for correcting the pixel value on the reference area R near the boundary of the prediction block because the prediction error reduces.

Thus, in a case that the quantization step is equal to or below a predetermined value (for example, QP=22), the predicted-image correction unit 145 may switch to filter strength C of the boundary filter to a weaker one.

That is, the filtered reference pixel setting unit 143 derives a filtered reference pixel value on the reference area R that is configured for the prediction block. The prediction unit 144 (intra prediction unit) derives a provisional predicted pixel value of the prediction block by referencing the filtered reference pixel value by a prediction method corresponding to the prediction mode.

The predicted-image correction unit 145 derives a predicted pixel value constituting the predicted image by applying a weighted addition using a weighting factor corresponding to the filter mode to the provisional predicted pixel value of the target pixel in the prediction block, and also to at least one or more unfiltered reference pixel values. The predicted-image correction unit 145 may, for at least one filter mode, determine the weighting factor by referencing the filter strength coefficient table 191, and may, for at least one other filter mode, determine the weighting factor by referencing the filter strength coefficient table 191 of a filter mode other than the other filter modes.

Hereinafter, a process in which the filtered reference pixel setting unit 143 derives the filter strength coefficient fmode of the reference pixel filter (STEP 1g), and a process in which the predicted-image correction unit 145 switches the filter strength of the boundary filter in accordance with the existence or filter strength of the reference pixel filter (STEP 2d) will be described by citing specific examples.

### STEP 1g: Deriving the Filter Strength Coefficient of the Reference Pixel Filter

The filtered reference pixel setting unit 143 can configure the filter strength coefficient fmode to different values as

fmode=0 (in a case that QP is 32 or more)

fmode=1 (in a case that QP is 27 or more, and less than 32)

fmode=2 (in a case that QP is 22 or more, and less than 27),

in accordance with the value of QP.

### STEP 2g: Switching the Filter Strength of the Boundary Filter

The predicted-image correction unit 145 may configure the reference strength coefficient C of the boundary filter in accordance with the value of QP. In such a case, the predicted-image correction unit 145 may change the reference strength coefficient C (c1v, c2v, c1h, c2h) that is determined beforehand for each prediction direction

c1v=c1vtable[fmode]>>fmode

c2v=c2vtable[fmode]>>fmode

c1h=c1htable[fmode]>>fmode

c2h=c2htable[fmode]>>fmode

as described above based on the filter strength coefficient fmode. Thus, in a case that the reference strength coefficient C is changed based on fmode, it will finally result in a change in the reference strength coefficient C based on the quantization parameter QP.

In the description above, the reference strength coefficient C was derived in accordance with the size of fmode by a shift operation based on a value corresponding to fmode, however, the derivation process is not limited thereto.

For example, the predicted-image correction unit 145 may derive the weighting corresponding to the value of fmode by referencing the table, and may accordingly, derive the reference strength coefficient. That is, the predicted-image correction unit 145 multiples the weighting w (wtable[fmode] and wtable[fmode]) corresponding to fmode, and performs a shift.

c1v=c1vtable[fmode]*wtable[fmode]>>shift

c2v=c2vtable[fmode]*wtable[fmode]>>shift

c1h=c1htable[fmode]*wtable[fmode]>>shift

c2h=c2htable[fmode]*wtable[fmode]>>shift

Here, the table may, for example, have the following value:

wtable[]={8, 5, 3}

shift=3

Note that the categories of the quantization parameter QP used in the switching of the reference strength coefficient are not restricted to 3. The number of times of switching may be 2, or may be more than 3. Moreover, the reference strength coefficient C may be continuously changed in accordance with the QP.

### Intra Prediction Using a Boundary Filter

Hereinafter, an intra prediction using a boundary filter will be described. Here, a method of correcting a provisional predicted pixel value obtained by intra prediction using a filtered reference pixel based on the unfiltered reference pixel value on the reference area R will be described by referencing FIGS. 7A(a) and 7A(b). FIGS. 7A(a) and 7A(b) are diagrams illustrating a positional relationship between a predicted pixel on a prediction block in an intra prediction and an unfiltered reference pixel on a reference area R configured for a prediction block. FIG. 7A(a) illustrates a position of a predicted pixel value p[x, y] at a position (x, y) in the prediction block, an unfiltered reference pixel value r[x, −1] of a pixel above the position (x, y) and at a position (x, −1) on the reference area R adjacent to the upper side of the prediction block, a pixel value r[−1, y] (unfiltered reference pixel valuer [−1, y]) of a pixel left to the position (x, y) and of an unfiltered reference pixel at a position (−1, y) on the reference area R adjacent to the left side of the prediction block, and an unfiltered reference pixel r[−1, −1] at a position (−1, −1) on the reference area R adjacent to the top left of the prediction block. Similarly, FIG. 7A(b) illustrates a predicted pixel value q[x, y] based on a provisional reference pixel value at a position (x, y) (a provisional predicted pixel value q[x, y]), a filtered reference pixel value s[x, −1] at a position (x, −1), a filtered reference pixel value s[−1, y] at a position (−1, y), and a filtered reference pixel value s[−1, −1) at a position (−1, −1). Note that the respective positions of the unfiltered reference pixel illustrated in FIG. 7A(a) and the filtered reference pixel illustrated in FIG. 7A(b) are only example, and not restricted to the positions in the figure.

FIG. 7B(a) illustrates the derivation equation of the predicted pixel value p[x, y]. The predicted pixel value p[x, y] is derived by performing weighted addition of the provisional predicted pixel value q[x, y] and the unfiltered reference pixel values r[x, −1], r[−1, y], r[−1, −1]. The weighting factor is a value obtained by performing right shift of the predetermined reference strength coefficient (c1v, c2v, c1h, c2h) based on the position (x, y). For example, the weighting factor for the unfiltered reference pixel value r[x, −1] is c1v>>floor (y/d). Here, floor( ) expresses a floor function, d expresses a predetermined parameter corresponding to the prediction block size, and “y/d” expresses the division of y by d (rounded down to the nearest decimal). Here, the value of d that is a predetermined parameter corresponding to the prediction block size is small in a case that the prediction block size is small (for example, d=1), and is large in a case that the prediction block size is large (for example, d=2). The weighting factor for the unfiltered reference pixel value can be expressed as a value obtained by adjusting the corresponding reference strength coefficient by a weighting corresponding to the reference distance (distance weighting). Furthermore, b[x, y] is a weighting factor for a provisional predicted pixel value q[x, y], and is derived by an equation illustrated in FIG. 7A(b). b[x, y] is configured such that the sum total of the weighting factor matches the denominator during weighted addition (“>>7” in the equation shown in FIGS. 7A(a) and 7A(b), that is, equivalent to division by 128). According to the equation in FIG. 7B(a), the larger the value of x or y, the smaller the value of the weighting factor of the unfiltered reference pixel. In other words, the weighting factor of the unfiltered reference pixel has a property of increasing as the position within the prediction block comes closer to the reference area R.

According to the weighting described above, the predicted pixel is corrected by using a distance weighting obtained by performing right shift on a predetermined reference pixel strength coefficient based on the position of the pixel to be corrected in the prediction target area (the prediction block). Since the accuracy of the predicted image near the boundary of the prediction block can be improved by this correction, the amount of the coded data can be reduced.

### Details of the Reference Filter

According to the HEVC standard, a reference pixel filter performed on a reference pixel is applied in accordance with the intra prediction mode (IntraPredMode). For example, in a case that the IntraPredMode is close to horizontal (HOR=10) or vertical (VER=26), the filter applied near the boundary of the reference pixel is turned OFF. In the other cases, the following [1 2 1]>>2 filter is applied.

That is, in a case that the reference pixel filter is applied, the filtered reference pixels pF[] [] for y of 0 to nTbS*2−2 are

pF[−1][−1]=(p[−1][0]+2*p[−1][−1]+p[0][−1]+2)>>2

pF[−1][y]=(p[−1][y+1]+2*p[−1][y]+p[−1][y−1]+2)>>2,

and for x of 0 to nTbS*2−2 are

pF[−1][nTbS*2−1]=p[−1][nTbS*2−1]

pF[x][−1]=(p[x−1][−1]+2*p[x][−1]+p[x+1][−1]+2)>>2

pF[nTbS*2−1][−1]=p[nTbS*2−1][−1].

Here, nTbS is the size of the target block.

The filtered reference pixel setting unit 143 may determine the reference pixel filter applied to the unfiltered reference pixel in accordance with the parameter decoded from the coded data. For example, the filtered reference pixel setting unit 143 determines whether to apply a low pass filter having a 3-tap filter strength coefficient [1 2 1]/4, or a low pass filter having a 5-tap filter strength coefficient [2 3 6 3 2]/16, in accordance with the prediction mode and the block size. It is noted that the filtered reference pixel setting unit 143 may derive the filtering flag in accordance with the prediction mode and the block size.

### Boundary Filter in an IBC Prediction and Inter Prediction

Primarily, a boundary filter is used to correct the results of intra prediction based on the directional prediction, DC prediction, and Planar prediction, but is also believed to be effective in improving the quality of a predicted image in inter prediction and IBC prediction as well. This is because even in inter prediction and IBC prediction, there is a mutual correlation at the boundary between a block within the reference area R and the prediction block. In order to use this correlation, the predicted-image correction unit 145 according to an embodiment of the disclosure uses a common filter (the predicted-image correction unit 145) in intra prediction, inter prediction, or IBC prediction. As a result, the implementation can be simplified more as compared with a configuration having a dedicated predicted image correction means in inter prediction and the IBC prediction.

### First Application Example of a Boundary Filter in an IBC Prediction and Inter Prediction

The predicted-image correction unit 145 similarly applies a boundary filter in the IBC prediction and inter prediction as well. Also, as for the reference strength coefficient C of the boundary filter, the same reference strength coefficient C as in the case of the DC prediction and Planar prediction may be used.

That is, the predicted-image correction unit 145 uses, for the IBC prediction in which the pixels of an already decoded reference area R are copied, and also for the inter prediction in which a predicted image is generated by motion compensation, the same filter mode fmode as the intra prediction (for example, the DC prediction and the Planar prediction, etc.) in which the adjacent pixel is referenced. These reference strength coefficients C are strength coefficients without a directionality (non-directional), and the same strength coefficient as the vertical direction coefficient and the horizontal direction coefficient is used. That is,

c1v=c1h

c2v=c2h

is established (equation K) between the reference strength coefficients (c1v, c2v, c1h, c2h) determined for each reference direction.

Specifically, an independent filter mode fmode is derived for each of the IBC prediction and inter prediction, and a value that satisfies the above equation K is used for the reference filter strength C referenced in the fmode.

In addition, the configuration may be such that the same reference strength coefficient C is mutually shared in the case of the IBC prediction IBC and the inter prediction INTER, as well as in the case of the DC prediction and the Planar prediction.

Specifically, in a case that the prediction mode is IBC prediction IBC and inter prediction INTER, the predicted-image correction unit 145 may derive the same reference strength coefficients c1v[k], c2v[k], c1h[k], and c2h[k] of the boundary filter as in the case that the intra prediction mode IntraPredMode is DC prediction and Planar prediction.

For example, in a case that a filter mode fmode specified by

fmode=0 (if IntraPredMode==DC, or IntraPredMode==Planar, or PredMode==INTER)

fmode=1 (else if IntraPredMode<TH1)

fmode=2 (else if IntraPredMode<TH2)

fmode=3 (else if IntraPredMode<TH3)

fmode=4 (else if IntraPredMode<TH4)

fmode=5 (otherwise),

is switched, the predicted-image correction unit 145 derives the reference strength coefficients c1v[k], c2v[k], c1h[k], and c2h[k] of the boundary filter by

c1v[k]=c1vtable[fmode]

c2v[k]=c2vtable[fmode]

c1h[k]=c1htable[fmode]

c2h[k]=c2htable[fmode].

It is noted that the number of fmodes is optional, and is not limited to the example described above.

In addition, for example, in a case that the above-described reference strength table ktable is used in place of the reference strength tables c1vtable[], c2vtable[], c1htable[], and c2htable[] described above, 0 and 1 are used as the fmodes in each of the DC prediction and Planar prediction in ktable, and therefore, it is appropriate to use 0 and 1 as the fmodes in the IBC prediction and the inter prediction as well.

### Intra Prediction Using a Boundary Filter

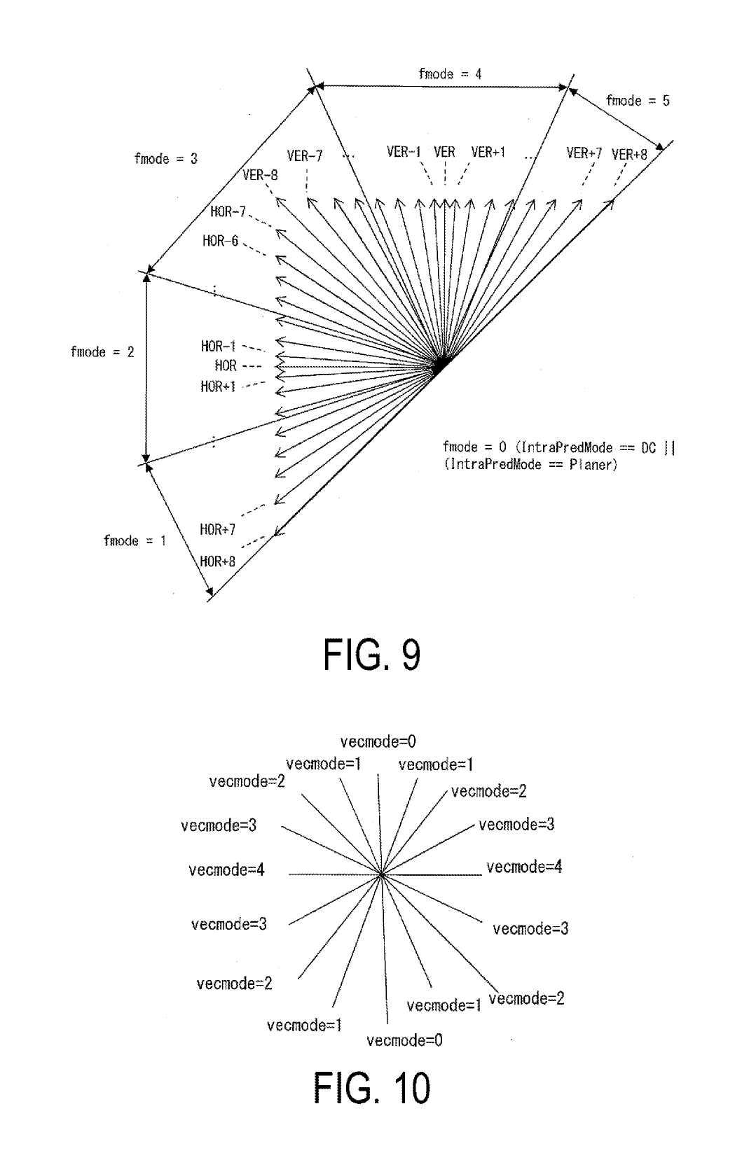

FIG. 9 is a diagram illustrating an example of classification of a prediction direction that corresponds to the identifier of the intra prediction mode into five filter modes fmode with regard to the 33 types of intra prediction modes belonging to the directional prediction. It is noted that the DC prediction and the Planar prediction that are non-directional predictions correspond to the filter mode fmode=0.

In the example illustrated in FIG. 9, the predicted-image correction unit 145 may switch a filter mode fmode specified by

fmode=0 (if IntraPredMode==DC or IntraPredMode==Planar)

fmode=1 (else if IntraPredMode<TH1)

fmode=2 (else if IntraPredMode<TH2)

fmode=3 (else if IntraPredMode<TH3)

fmode=4 (else if IntraPredMode<TH4)

fmode=5 (otherwise).

It is noted that the number of fmodes is optional, and is not limited to the example described above.

The correspondence between the reference directions and the filter modes fmode, shown in FIG. 9, is merely one example, and may be appropriately changed. For example, the width (expanse) in each reference direction may be equal or may not be equal.

### First Modification

### Reference Strength Coefficient C of Planar Prediction and DC Prediction

If the Planar prediction and the DC prediction are compared, the Planar prediction has a stronger correlation (linking) with the pixel values on the reference area R close to the boundary of the prediction block. Therefore, in the case of the Planar prediction, it is desirable to keep the filter strength of the boundary filter lower to that in the case of the DC prediction. That is, a reference filter strength coefficient in which the reference filter strength coefficients c1v_planar, c1h_planar in the case of the fmode of the Planar prediction, and the reference filter strength coefficients c1v_dc, c1h_dc in the case of the fmode of the DC prediction have the relationship described below is used as the reference strength coefficient c1v that determines the weighting (=w1v) applied to the upper unfiltered coefficient (r[x, −1], and the reference strength coefficient c1h that determines the weighting (=w1h) applied to the left unfiltered coefficient (r[x, −1].

c1v_planar>c1v_dc

c1h_planar>c1h_dc

In addition, the same may be applied to the reference filter strength of the corner unfiltered pixel as well. That is, a reference filter strength coefficient in which the unfiltered reference filter coefficient c2h_planar in the case of the fmode of the planar prediction, and the unfiltered reference filter coefficient c2h_planar in the case of the fmode of the DC prediction, and the reference filter strength coefficients c2v_dc, c2h_dc in the case of the fmode of the DC prediction have the relationship described below may be used.

c2v_planar>c2v_dc

c2h_planar>c2h_dc

### Reference Strength Coefficient C of Inter Prediction

The correlation with the pixel values on the reference area R near the boundary of the prediction block in the case of the inter prediction and the IBC prediction is thought to be smaller as compared to that in the case of the Planar prediction. Therefore, in the case of the inter prediction and the IBC prediction too, it is desirable to keep the filter strength of the boundary filter lower to that in the case of the Planar prediction.

That is, a reference filter strength coefficient C in which the reference filter strength coefficients c1v_inter, c1h_inter in the case of the fmode of the inter prediction, and the reference filter strength coefficients c1v_planar, c1h_planar in the case of the fmode of the Planar prediction have the relationship described below is used as the reference strength coefficient c1v that determines the weighting (=w1v) applied to the upper unfiltered coefficient (r[x, −1], and the reference strength coefficient c1h that determines the weighting (=w1h) applied to the left unfiltered coefficient (r[x, −1].

c1v_inter>c1v_planar

c1h_inter>c1h_planar

Similarly, for the reference filter strength coefficients c1v_ibc and c1h_ibc in the case of the fmode of the IBC prediction, a reference filter strength coefficient C which has the relationship described below is used.

c1v_ibc<c1v_planar

c1h_ibc<c1h_planar

It is noted that for the reference filter strength coefficient C of the corner unfiltered pixel value too, coefficients having a similar relationship may be used.

c2v_inter<c2v_planar

c2h_inter<c2h_planar

c2h_ibc<c2v_planar

c2h_ibc<c2h_planar

### Another Example of Reference Strength Coefficient C of Inter Prediction

In the case of the DC prediction too, the similar relationship to the case of the Planar prediction is thought to exist. That is, the correlation with the pixel values on the reference area R near the boundary of the prediction block in the case of the inter prediction and the IBC prediction is thought to be smaller as compared to that in the case of the DC prediction. Therefore, a reference filter strength coefficient C in which the reference filter strength coefficients c1v_inter and c1h_inter that determine the weighting of the upper unfiltered coefficient and the left unfiltered coefficient in the case of the fmode of the inter prediction have the relationship described below with respect to the reference filter strength coefficients c1v_dc and c1h_dc in the case of the DC prediction is used.

c1v_inter<c1v_dc

c1h_inter<c1h_dc

Similarly, for the reference filter strength coefficients c1v_ibc and c1h_ibc in the case of the fmode of the IBC prediction, a reference filter strength coefficient C which has the relationship described below is used.

c1v_ibc<c1v_dc

c1h_ibc<c1h_dc

It is noted that for the reference filter strength coefficient C of the corner unfiltered pixel value too, coefficients having a similar relationship may be used.

c2v_inter<c2v_dc

c2h_inter<c2h_dc

c2v_ibc<c2v_dc

c2h_ibc<c2h_dc

### Reference Strength Coefficient C of Inter Prediction and IBC Prediction

The correlation with the pixel values on the reference area R near the boundary of the prediction block of the inter prediction is thought to be stronger as compared to that in the case of the IBC prediction. Therefore, in the case of the inter prediction too, it is desirable to keep the filter strength of the boundary filter stronger than in the case of the IBC prediction.

That is, a reference filter strength coefficient in which the reference filter strength coefficients c1v_inter, c1h_inter in the case of the fmode of the inter prediction, and the reference filter strength coefficients c1v_ibc, c1h_ibc in the case of the fmode of the IBC prediction have the relationship described below is used as the reference strength coefficient c1v that determines the weighting (=w1v) applied to the upper unfiltered coefficient (r[x, −1], and the reference strength coefficient c1h that determines the weighting (=w1h) applied to the left unfiltered coefficient (r[x, −1].

c1v_inter>c1v_ibc

c1h_inter>c1h_ibc

In addition, a reference filter strength coefficient in which the corner unfiltered reference filter coefficients c2v_inter, c2h_inter in the case of the fmode of the Planar prediction, and the unfiltered reference filter coefficients c2v_ibc, c2h_ibc in the case of the fmode of the IBC prediction have the relationship described below may be used.

c2v_inter>c2v_ibc

c2h_inter>c2h_ibc

### Another Example of Reference Strength Coefficient C of Inter Prediction and IBC Prediction

The correlation with the pixel values on the reference area R near the boundary of the prediction block in the case of the inter prediction and the IBC prediction too is thought to be stronger as compared to that in the case of the DC prediction. Therefore, in the case of the inter prediction and the IBC prediction too, it is desirable to keep the filter strength of the boundary filter lower to that in the DC prediction.

In a case that the filter strength C of the boundary filter is different in the DC prediction mode and the Planar prediction mode, the predicted-image correction unit 145 may be configured to use the same filter strength coefficient as the Planar prediction mode in a case that the prediction mode PredMode is an inter prediction mode. Here, the IBC prediction mode is included in the inter prediction mode.

In such a case, the predicted-image correction unit 145 may switch a filter mode fmode specified by

fmode=0 (if IntraPredMode==Planar or PredMode==INTER)

fmode=1 (else if IntraPredMode==DC)

fmode=2 (else if IntraPredMode<TH1)

fmode=3 (else if IntraPredMode<TH2)

fmode=4 (else if IntraPredMode<TH3)

fmode=5 (else if IntraPredMode<TH4)

fmode=6 (otherwise).

Further, in such a case, the predicted-image correction unit 145 may configure the reference strength coefficients (c1v, c2v, c1h, c2h) that are determined beforehand for each prediction direction as

c1v=c1vtable[fmode]

c2v=c2vtable[fmode]

c1h=c1htable[fmode]

c2h=c2htable[fmode].

It is noted that the number of fmodes is optional, and is not limited to the example described above.

Moreover, referencing may be performed as described below by using a table ktable[] [] arranged for each filter mode in which the vectors of the reference strength coefficient C {c1v, c2v, c1h, c2h} have been arranged.

c1v=ktable[fmode][0]

c2v=ktable[fmode][1]

c1h=ktable[fmode][2]

c2h=ktable[fmode][3]

### Second Modification

Alternatively, in a case that an IBC prediction mode is the prediction mode PredMode in addition to the intra prediction and the inter prediction, the IBC prediction mode may be corresponded with the filter mode fmode=0. Furthermore, the Planar prediction and the DC prediction may have the same filter mode fmode=0. That is, the predicted-image correction unit 145 may switch a filter mode fmode specified by

fmode=0 (if IntraPredMode==DC, or IntraPredMode==Planar, or IntraPredMode==IBC, or PredMode==INTER)

fmode=1 (else if IntraPredMode<TH1)

fmode=2 (else if IntraPredMode<TH2)

fmode=3 (else if IntraPredMode<TH3)

fmode=4 (else if IntraPredMode<TH4)

fmode=5 (otherwise).

In such a case, the predicted-image correction unit 145 may configure the reference strength coefficients (c1v, c2v, c1h, c2h) that are determined beforehand for each prediction direction as

c1v=c1vtable[fmode]

c2v=c2vtable[fmode]

c1h=c1htable[fmode]

c2h=c2htable[fmode].

It is noted that the number of fmodes is optional, and is not limited to the example described above.

It is noted that the inter prediction may not necessarily be correlated with the filter mode fmode=0. That is, the predicted-image correction unit 145 may switch a filter mode fmode specified by

fmode=0 (if IntraPredMode==DC, or IntraPredMode==Planar, or IntraPredMode==IBC)

fmode=1 (else if IntraPredMode<TH1)

fmode=2 (else if IntraPredMode<TH2)

fmode=3 (else if IntraPredMode<TH3)

fmode=4 (else if IntraPredMode<TH4)

fmode=5 (otherwise).

It is noted that the number of fmodes is optional, and is not limited to the example described above.

### Second Application Example of a Boundary Filter in an IBC Prediction

Alternatively, the predicted-image correction unit 145 may, in a case that either one of the inter prediction mode and the IBC prediction mode has been selected, have a configuration in which weighted addition is not applied in the case that a motion vector mvLX indicating the reference area is an integer pixel unit.

That is, the predicted-image correction unit 145 does not apply a boundary filter (turns off the boundary filter) in a case that the motion vector mvLX is an integer pixel, and may apply a boundary filter (turns on the boundary filter) in a case that the motion vector mvLX is not an integer pixel.

In such a case, in the case that the prediction mode PredMode is the inter prediction mode or the IBC prediction mode, and the motion vector mvLX is an integer, the predicted-image correction unit 145 may be configured such that the correction process by the predicted-image correction unit 145 is not instructed. Alternatively, in the case that the prediction mode PredMode is the inter prediction mode or the IBC prediction mode, and the motion vector mvLX is an integer, the predicted-image correction unit 145 may be configured such that all of the reference strength coefficients (c1v, c2v, c1h, c2h) that are determined beforehand for each prediction direction are set to 0.

Alternatively, in the case that either one of the inter prediction mode and the IBC prediction mode has been selected, the predicted-image correction unit 145 changes the filter strength of the boundary filter process by weighted addition depending on whether the motion vector mvLX indicating a reference image is an integer pixel unit or a non-integer pixel unit, and may keep the filter strength of the boundary filter applied in the case that the motion vector mvLX is an integer pixel unit lower than the filter strength of the boundary filter applied when the motion vector mvLX is a non-integer pixel unit.

That is, the predicted-image correction unit 145, in the inter prediction mode or the IBC prediction mode, may have a configuration where the predicted-image correction unit 145 applies a boundary filter with a weak filter strength in the case that the motion vector mvLX is an integer pixel, and applies a boundary filter with a strong filter strength in the case that the motion vector mvLX is not an integer pixel.

In such a case, the predicted-image correction unit 145 may switch a filter mode fmode specified by

fmode=0 (if IntraPredMode==Planar || ((IntraPredMode==IBC || PredMode==Inter) && ((MVx & M)==0 && (MVy & M)==0))

fmode=1 (else if IntraPredMode==DC|| IntraPredMode==IBC || PredMode==Inter)

fmode=2 (else if IntraPredMode<TH1)

fmode=3 (else if IntraPredMode<TH2)

fmode=4 (else if IntraPredMode<TH3)

fmode=5 (else if IntraPredMode<TH4)

fmode=6 (otherwise).

It is noted that if the accuracy of the motion vector mvLX is 1/(2ⁿ), integer M becomes M=2ⁿ−1. Here, n is 0 or a higher integer. That is, when n=2, the accuracy of the motion vector mvLX is 1/4, and M=3.

In such a case, the predicted-image correction unit 145 may configure the reference strength coefficients (c1v, c2v, c1h, c2h) that are determined beforehand for each prediction direction as

c1v=c1vtable[fmode]

c2v=c2vtable[fmode]

c1h=c1htable[fmode]

c2h=c2htable[fmode].

It is noted that in a case that the IBC prediction mode is included in the inter prediction mode, the predicted-image correction unit 145 may switch a filter mode fmode specified by

fmode=0 (If IntraPredMode==Planer || (PredMode==INTER && (MVx & M)==0 && (MVy & M)==0))

fmode=1 (else if IntraPredMode==DC ||PredMode==Inter)

fmode=2 (else if IntraPredMode<TH1)

fmode=3 (else if IntraPredMode<TH2)

fmode=4 (else if IntraPredMode<TH3)

fmode=5 (else if IntraPredMode<TH4)

fmode=6 (otherwise).

Note that MVx is the x component of the motion vector and MVy is the y component of the motion vector. It is noted that the number of fmodes is optional, and is not limited to the example described above.

In the description given above, in a case that the filter mode fmode used in the integer pixel is 0, the filter strength is weak as compared to the case in which the filter mode fmode is 1. That is, the relational expression

c1vtable[fmode==0]<c1vtable[fmode==1]

c1htable[fmode==0]<c1htable[fmode==1]

is established in the reference strength coefficients c1v and c1h for the pixels r[x, −1] and r[−1, y] in the boundary region.

### Application Example of a Boundary Filter in an Inter Prediction

Alternatively, the predicted-image correction unit 145 may derive a prediction pixel value constituting the predicted image by applying, to a provisional prediction pixel value of the target pixel in the prediction block, and also to at least one or more unfiltered reference pixel values, a weighted addition using a weighting factor corresponding to the filter mode fmode having a directionality corresponding to the directionality of the motion vector mvLX.

That is, in a case that the prediction mode PredMode is inter prediction, the predicted-image correction unit 145 may determine the filter mode fmode in accordance with the direction of the motion vector mvLX of the prediction block derived by the inter prediction unit 144N.

FIG. 10 is a diagram illustrating an example of switching the filter mode fmode of a boundary filter in accordance with a direction vecmode of the motion vector mvLX in the inter prediction.

Specifically, in a case that the prediction mode PredMode is inter prediction, the predicted-image correction unit 145 determines a filter mode fmode corresponding to the direction vecmode of the motion vector mvLX of the prediction block, and may derive the reference strength coefficient C of the boundary filter

In such a case, the predicted-image correction unit 145 may, for example, use a variable vecmode indicating the directionality of the direction prediction to switch the reference strength coefficient C by using a filter mode fmode specified by

fmode=vecmode.

It is noted that vecmode, for example, can be derived by comparing the horizontal component mxLX[0] and the vertical component mxLX[1] of the motion vector as described below. In a case that N1=4 and N2=2,

vecmode==0 (|mvLX[1]|>N1*|mvLX[0]|)

vecmode==1 (|mvLX[1]|>N2*|mvLX[0]|)

vecmode==3 (|mvLX[0]|>N2*|mvLX[1]|)

vecmode==4 (|mvLX[0]|>N1*|mvLX[1]|)

vecmode==2 (else)

In the description given above, the filter mode fmode is derived by using a vecmode that does not give consideration to a symmetric directionality, but the filter mode fmode may be derived in accordance with a symmetric directionality. For example, in this case, the predicted-image correction unit 145 may switch a filter mode fmode specified by

fmode=0 (vecmode==0)

fmode=1 (vecmode==1 && mvLX[0]*mvLX[1]<0)

fmode=2 (vecmode==2 && mvLX[0]*mvLX[1]<0)

fmode=3 (vecmode==3 && mvLX[0]*mvLX[1]<0)

fmode=4 (vecmode==4)

fmode=5 (vecmode==3 && mvLX[0]*mvLX[1]>0)

fmode=6 (vecmode==2 && mvLX[0]*mvLX[1]>0)

fmode=7 (vecmode==1 && mvLX[0]*mvLX[1]>0).

It is noted that in the vertical prediction vecmode=0 and the horizontal prediction vecmode=4, among the symmetric directions, only one prediction direction (from top to bottom or from left to right) is used, and the other prediction direction (from bottom to top or from right to left) is not used. Therefore, differentiation is not performed in the equation described above.

Thus, the predicted-image correction unit 145 derives the reference strength coefficients c1v, c2v, c1h, and c2h of the boundary filter by

c1v=c1vtable[fmode]

c2v=c2vtable[fmode]

c1h=c1htable[fmode]

c2v=c2vtable[fmode].

It is noted that the number of fmodes is optional, and is not limited to the example described above.

In the luminance-chrominance prediction LMChroma, the predicted-image correction unit 145 may apply a boundary filter not only to the luminance in the provisional predicted pixel near the boundary of the prediction block, but also to the chrominance. In such a case, it is desirable for the filter strength of the applied boundary filter to be same as the filter strength of the boundary filter applied in the DC prediction mode.

Thus, in a case that the intra prediction mode IntraPredModeC is the luminance-chrominance prediction mode LMChroma (that is, IntraPredModeC=LM), the predicted-image correction unit 145 applies a boundary filter that has the same filter strength as the boundary filter applied in the DC prediction mode.

For example, in a case that the filter mode fmode is classified as

fmode=0(if IntraPredMode==DC, or IntraPredMode==Planar, or IntraPredModeC==LM)

fmode=1 (else if IntraPredModeC<TH1)

fmode=2 (else if IntraPredModeC<TH2)

fmode=3 (else if IntraPredModeC<TH3)

fmode=4 (else if IntraPredModeC<TH4)

fmode=5 (otherwise)

(refer to FIG. 9), the predicted-image correction unit 145 changes the filter strength of the boundary filter in accordance with the filter mode fmode corresponding to the intra prediction mode IntraPredModeC.

In such a case, the predicted-image correction unit 145 can configure the reference strength coefficient C of the boundary filter in accordance with the chrominance intra prediction mode IntraPredModeC. That is, the predicted-image correction unit 145 can configure the reference strength coefficients (c1v, c2v, c1h, c2h) that are determined beforehand for each prediction direction as

c1v=c1vtable[fmode]

c2v=c2vtable[fmode]

c1h=c1htable[fmode]

c2h=c2htable[fmode].

It is noted that the number of fmodes is optional, and is not limited to the example described above.

### Effect of the Video Decoding Device

The video decoding device according to the present embodiment described above has a prediction image generation unit 14 that includes the predicted-image correction unit 145 as a component, and the predicted-image generation unit 14 is configured to generate a predicted image (corrected) from an unfiltered reference pixel value and a provisional predicted pixel value by weighted addition based on a weighting factor for each pixel of a provisional predicted image. The weighting factor described above is a product of a reference strength coefficient determined in accordance with the prediction direction indicated by the prediction mode, and the distance weighting that decreases monotonically as a result of an increase in the distance between the target pixel and the reference area R. Therefore, the larger the reference distance (for example, x, y), the smaller is the value of the distance weighting (for example, k[x], k[y]), and therefore, by generating the predicted image by further increasing the weighting of the unfiltered reference pixel value when the reference distance is small, a predicted pixel value with a high prediction accuracy can be generated. In addition, since the weighting factor is the product of the reference strength coefficient and distance weighting, by calculating the value of distance weighting beforehand for each distance and maintaining the values in a table, the weighting factor can be derived without using the right shift operation and division.

First Modification: Configuration in Which the Distance Weighting is Set to 0 when the Distance Increases

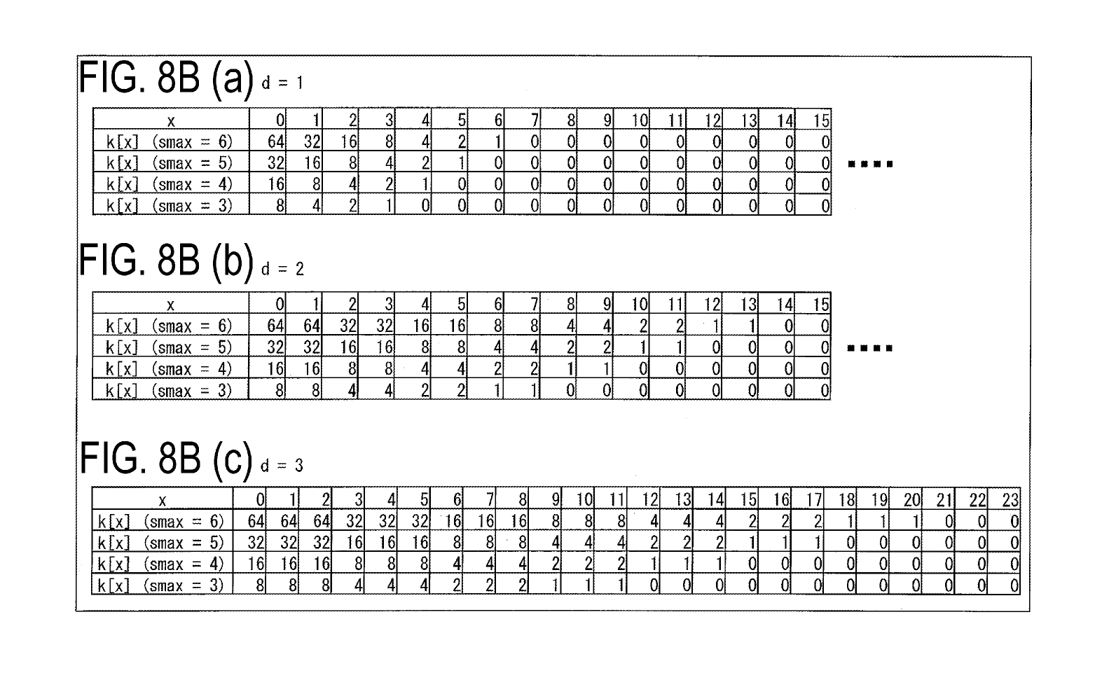

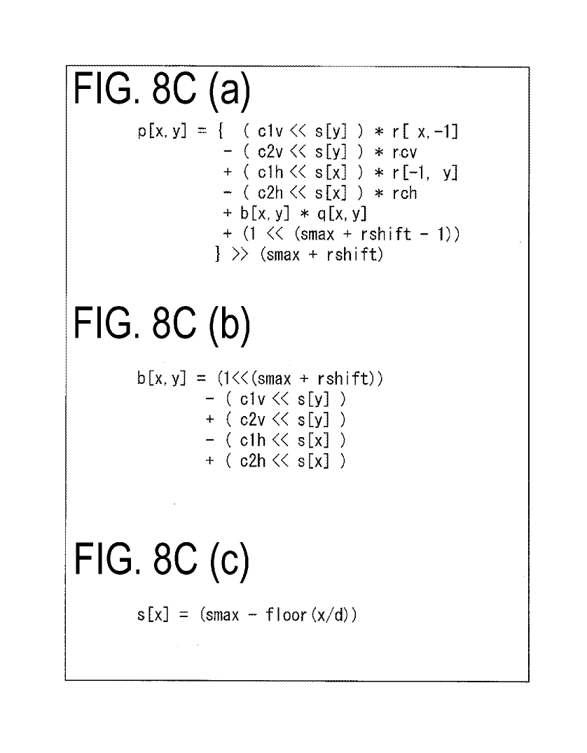

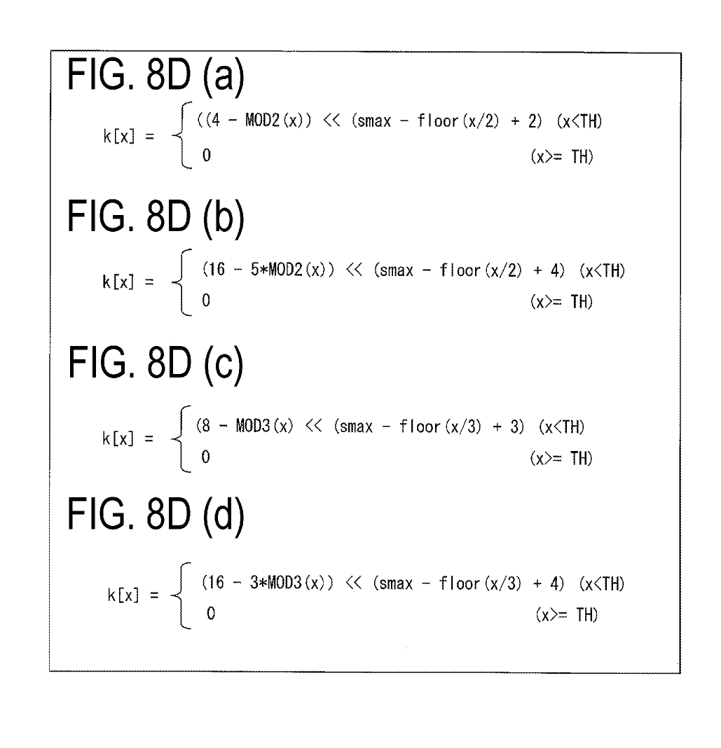

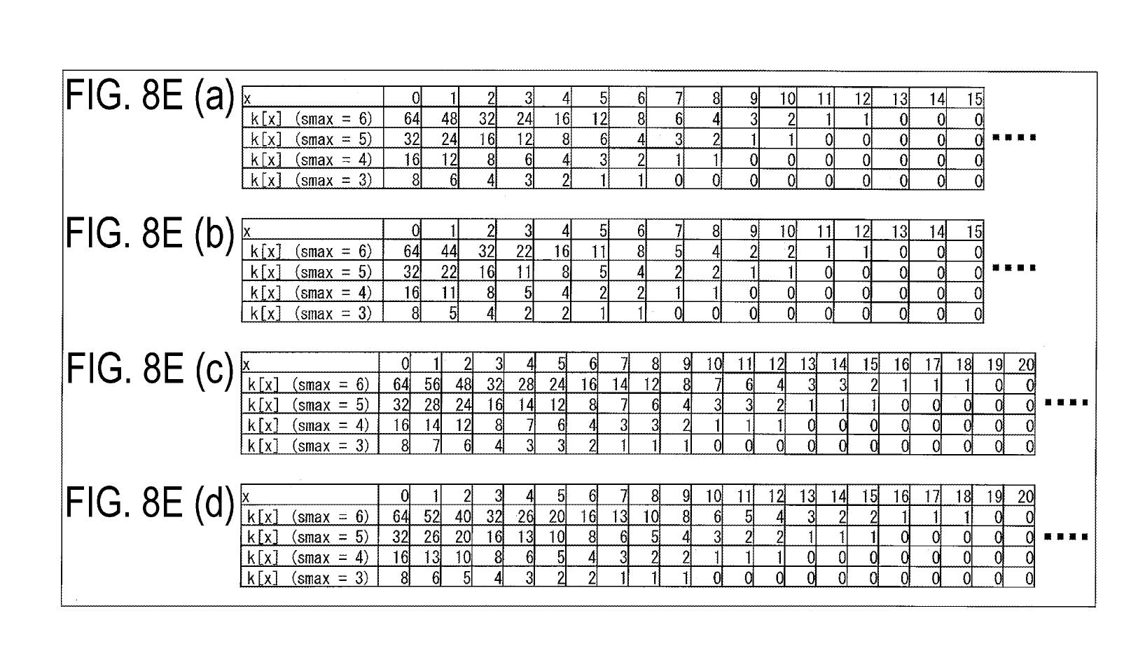

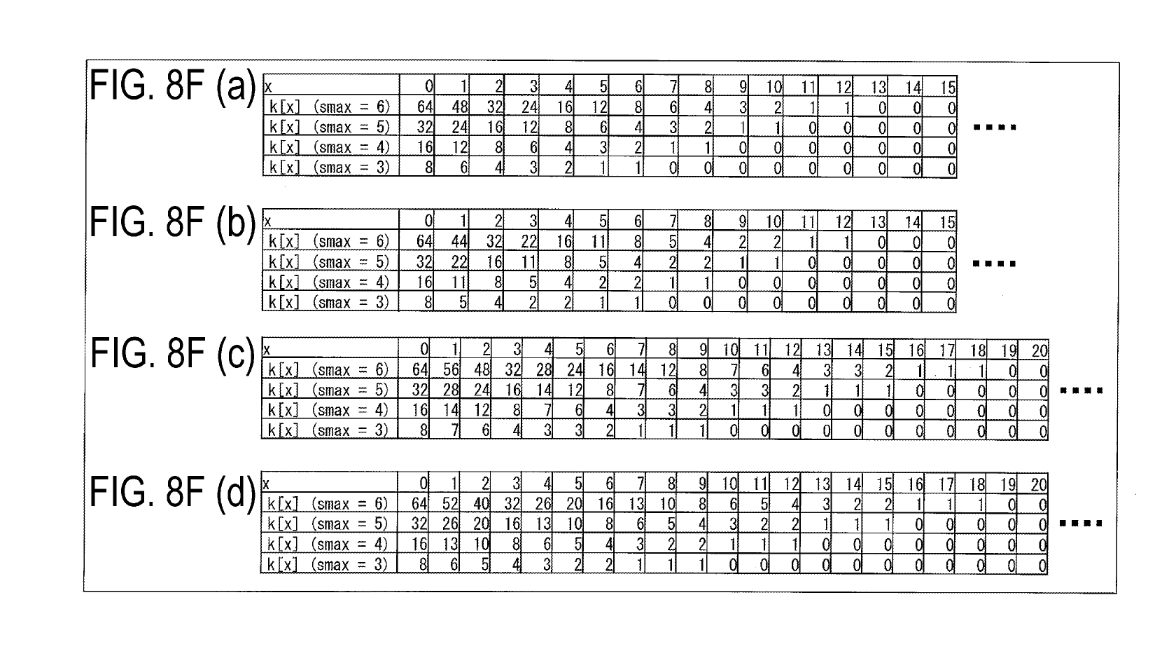

In the predicted-image correction unit 145 according to the embodiment described above, the derivation of the weighting factor as a product of the reference strength coefficient and distance weighting was described with reference to FIG. 5A. As shown in FIG. 5C, a distance-weighted k[x] that decreases in accordance with an increase in the distance x (reference distance x) between the target pixel and the reference area R was used as the value of distance weighting, but the predicted-image correction unit 145 may be configured such that the distance-weighted k[x] is set to 0 in a case that the reference distance x is a predetermined value or higher. An example of the calculation formula of the distance-weighted k[x] in such a configuration is shown in FIG. 8A. According to the calculation formula of the distance-weighted k[x] shown in FIG. 8A, in a case that the reference distance x is less than the predetermined threshold value TH, the distance-weighted k[x] is configured in accordance with the reference distance x by a calculation formula that is same as in FIG. 5C. In addition, in a case that the reference distance x is equal to or more than the predetermined threshold value TH, the value of the distance-weighted k[x] is configured as 0 regardless of the reference distance x. A predetermined value can be used as the value of the threshold TH, for example, in a case that the value of the first normalization adjustment term smax is 6, and the value of the second normalization adjustment term rshift is 7, the prediction image correction process can be performed by configuring the value of the threshold TH as 7.

It is noted that the threshold value TH may be changed depending on the first normalization adjustment term smax. More specifically, the threshold value TH may be configured to increase as a result of an increase in the first normalization adjustment term smax. A configuration example of such a threshold value TH will be described by referencing to FIGS. 8B(a) to 8B(c). FIGS. 8B(a) to 8B(c) are tables indicating a relationship between a reference distance x and a weighting factor k[x] in a case that a first normalization adjustment term smax is different. Here, the value of the second normalization adjustment term rshift is assumed to be 7. FIG. 8B(a), FIG. 8B(b), and FIG. 8B(c) illustrate the relationship between the reference distance x and the weighting factor k[x] in a case that the value of a variable d showing a block size is 1, 2, and 3, respectively. Variable d is a variable that increases as a result of an increase in the prediction block size, for example d=1 is assigned for a prediction block size 4×4, d=2 is assigned for prediction block sizes 8×8 and 16×16, and d=3 is assigned for a prediction block size larger than 32×32. In this sense, the variable d is also called the prediction block size identification information d. In FIG. 8B(a), a threshold value TH that varies depending on whether the first normalization adjustment term smax is large or small is configured. The relationship between the first normalization adjustment term smax and the threshold value TH as shown in FIG. 8B(a) is

TH=7, in a case that smax=6

TH=6, in a case that smax=5

TH=5, in a case that smax=4

TH=4, in a case that smax=3.

The above relationship can be expressed by the relational expression TH=1+smax. Similarly, the relationship between smax and TH in the table shown in FIG. 8B(b) can be expressed by the relational expression TH=2*(1+smax). Similarly, the relationship between smax and TH in the table shown in FIG. 8B(c) can be expressed by the relational expression TH=3*(1+smax). That is, the threshold value TH can be expressed by the relational expression TH=d*(1+smax) based on the prediction block size identification information d and the first normalization adjustment term smax. The first normalization adjustment term smax is a number expressing the expression accuracy of the weighting factor k[x], and the above expression can also indicate that a comparatively larger threshold value TH is configured in a case that the expression accuracy of the weighting factor k[x] is high. Therefore, since the value of the weighting factor k[x] becomes relatively small in a case that the expression accuracy of the weighting factor k[x] is small, far more number of multiplications can be omitted in the prediction image correction process by configuring a smaller threshold value TH.

Furthermore, as described in FIG. 5C, in a case that the distance-weighted k[x] is derived by an operation of subtracting a number corresponding to x from smax (for example, smax−floor (x/d)), if x increases, then smax−floor (x/d) will become negative. While it is possible to perform a negative left shift operation (the result is equivalent to a right shift operation) in some processing systems, it is not possible to perform a negative left shift operation in the other processing systems, and a left shift can be performed only for 0 or a higher number. As described in the present embodiment, by setting the weighting factor k[x] to 0 in a case that the weighting factor is larger than the threshold value TH, and by using a derivation method for k[x] such as one in which k[x] decreases monotonically in accordance with the distance x in the other cases, a negative left shift operation can be avoided.

As described above, the predicted-image correction unit 145 can be configured such that the distance-weighted k[x] is 0 in a case that the reference distance x is equal to or more than the predetermined value. In such a case, the multiplication in the prediction image correction process can be omitted for the partial area in the prediction block (the area in which the reference distance x becomes equal to or more than the threshold value TH).

For example, a part of the calculation in the prediction image correction process includes the calculation of the sum value, which can be expressed as sum=m1+m2−m3−m4+m5+(1<<(smax+rshift−1)). Since k[x] becomes 0 when x exceeds the threshold value TH, w1h and w2h become 0, and therefore, m2 and m4 also become 0. Therefore, the calculation can be simplified as sum=m1−m3+m5+(1<<(smax+rshift−1)). Similarly, the process of calculation of b[x, y]=(1<<(smax+rshift))−w1v−w1h+w2v+w2h can be simplified as b[x, y]=(1<<(smax+rshift))−w1v+w2v.

Similarly, since k[y] becomes 0 when y exceeds the threshold value TH, w1v and w2v become 0, and therefore, m1 and m3 also become 0. Therefore, the calculation of the above-described sum value can be simplified as sum=m2−m4+m5+(1<<(smax+rshift−1)). Similarly, the process of calculation of b[x, y]=(1<<(smax+rshift))−w1v−w1h+w2v+w2h can be simplified as b[x, y]=(1<<(smax+rshift))−w1h+w2h.

In addition to the effect that the number of multiplications can be simply reduced, it is also possible to perform batch processing through parallel processes with reduced multiplications in the entire partial area described above.

It is noted that by configuring a threshold value TH that varies in accordance with the variable d and also depending on whether the first normalization adjustment term smax is large or small, the derivation of the weighting factor k[x] and the prediction image correction process can be reduced to the maximum possible extent, however, as a more simplified configuration, a fixed-value TH can also be used as the threshold value TH. Particularly, since parallel processes are performed in multiples of 4 or 8 in many software, by using a fixed value such as TH=8, 12, or 16, it is possible to derive a weighting factor k[x] that is suitable for a parallel operation, in a simple configuration.

Furthermore, it is also possible to configure a predetermined value that is decided in accordance with the prediction block size. For example, a value that is half of the width of the prediction block size may be configured as the threshold value TH. In such a case, the threshold value TH for a prediction block size of 16×16 will be 8. Furthermore, the threshold value TH may be configured as 4 in a case that the prediction block size is 8×8 or less, and the threshold value TH may be configured as 8 in the case of other prediction block sizes. In other words, the threshold value TH is configured so that the weighting factor becomes 0 in a pixel positioned at the bottom right area of the prediction block. In a case that the prediction image generation processes in a prediction block are performed in parallel, in most of the cases, the processes are performed in an area unit obtained by dividing the prediction block by a multiple of 2, and therefore, by configuring the threshold value TH such that the weighting factor of the entire bottom right area becomes 0, the prediction image correction process can be performed by the same process for all pixels within the same area.

### Second Modification: Configuration in Which Distance Weighting is Derived by Using a Table

In the predicted-image correction unit 145 according to the embodiment described above, the derivation of the value of distance-weighted k[x] according to the calculation formula shown in FIG. 5C was described, however, it is also possible to determine the distance-weighted k[x] based on the relationship between the reference distance x, the first normalization adjustment term smax, and the prediction block size identification information d saved on a recording area such as a memory or hard disk, etc., and then perform the prediction image correction process. For example, if the table shown in FIGS. 8B(a) to 8B(c) (distance weighting derivation table) is maintained in a recording area, the predicted-image correction unit 145 can determine the distance-weighted k[x] by referencing a specific entry ktable[x] of the distance weighting derivation table ktable[] (in FIGS. 8B(a) to 8B(c), the table is also simply indicated as k[]) based on the first normalization adjustment term smax, the prediction block size identification information d, and the reference distance x. In other words, by referencing the distance weighting derivation table on the recording area by using the reference distance x, the first normalization adjustment term smax, and the prediction block size identification information d as indexes, the distance-weighted k[x] can be determined. The derivation process of the distance-weighted k[x] in a case that the distance weighting derivation table shown in FIGS. 8B(a) to 8B(c) is used can be implemented by performing steps S301 to S303 described below in an order.

(S301) Select a corresponding table in accordance with the value of the prediction block size identification information d. Specifically, the table shown in FIG. 8B(a) is selected in a case that d=1, the table shown in FIG. 8B(b) is selected in a case that d=2, and the table shown in FIG. 8B(c) is selected in a case that d=3. It is noted that regardless of the prediction block size, in a case that the relationship between the reference distance x and the distance-weighted k[x] is the same, this step can be omitted.

(S302) Select a corresponding line in the table in accordance with the value of the first normalization adjustment term smax. For example, in a case that smax=6, the line indicated as “k[x] (smax=6)” in the table selected in S301 is selected. It is noted that in a case that smax has a predetermined value, this step may be omitted.

(S303) Select k[x] corresponding to the reference distance x from the line selected in S302, and configure it as the value of distance-weighted k[x].

For example, in a case that the prediction block size is 4×4 (the value f the prediction block size identification information d is 1), the value of the first normalization adjustment term is 6, and the reference distance x is 2, the table shown in FIG. 8B(a) will be selected in step S301, the line “k[x] (smax=6)” will be selected in step S302, and the value “16” described in the column “x=2” in step S303 will be configured as the weighting factor k[x].

It is noted that in a case that steps S301 and S302 are omitted, the distance-weighted k[x] is determined by referencing the distance weighting derivation table on the recording area with the reference distance x as the index.

The table shown in FIGS. 8B(a) to 8B(c) was described as an example of the distance weighting derivation table, but other tables can also be used as the distance weighting derivation tables. In such a case, the distance weighting derivation table must satisfy at least property 1 described below.

(Property 1) k[x] is a broadly defined monotonically-increasing function of the reference distance x. In other words, in a case that the reference distance x1 and the reference distance x2 satisfy the relationship x1<x2, the relationship k[x2]>=k[x1] is established.

In a case that the distance weighting derivation table satisfies property 1, the prediction image correction process can be performed by configuring a smaller distance weighting for a pixel that exists at a location with a comparatively larger reference distance.

Furthermore, in addition to property 1, the distance weighting derivation table preferably satisfies property 2 described below.

(Property 2) k[x] is a value that is expressed by a power of 2.

The value of the distance-weighted k[x] that is derived by referencing the distance weighting derivation table having property 2 has a power of 2. On the other hand, as illustrated in FIG. 5A, a process of deriving the weighting factor by multiplying the distance-weighted k[x] with the reference strength coefficient (for example, c1v) is included in the prediction image correction process. Therefore, in a case that property 2 is possessed, because multiplication by the distance-weighted k[x] is multiplication by a power of 2, multiplication can be performed by a left shift operation, and the weighting factor can be derived by a processing cost that is lower than that for multiplication. Furthermore, in a case that k[x] has a power of 2, then in software in which multiplication is comparatively easy to perform, the prediction image correction process is implemented by a product of k[x], and in hardware in which a shift operation is comparatively easy to perform, the prediction image correction process is performed by a shift operation of a weighted shift value s[x] indicating a relationship of k[x]=1<<s[x].

Thus, as described above in the second modification, it is possible to implement a configuration by which the prediction image correction process is performed by determining the distance-weighted k[x] based on the relationship between the reference distance x, the first normalization adjustment term smax, and the prediction block size identification information d saved on a recording area. In such a case, as compared with a case in which the distance-weighted k[x] is derived by a calculation formula such as the one shown in FIG. 5C, the distance weighting can be derived by a comparatively lesser number of operations.

### Third Modification: Configuration Based on the Distance Left Shift Value

In the predicted-image correction unit 145 according to the embodiment described above, the weighting factor is derived by using a product of the reference strength coefficient and distance weighting (for example, c1v*k[y]), as shown in FIG. 5A. However, another method equivalent to product may be used for deriving the weighting factor, for example, it is possible to configure a predicted-image correction unit 145 that derives the weighting factor by applying left shift to the reference strength coefficient, with the distance shift value s[ ] being used as the shift width. Hereinafter, an example will be described with reference to FIGS. 8C(a) to 8C(c).

FIG. 8C(a) shows the derivation equation of the predicted pixel value p[x, y] at position (x, y) within the prediction block. In the derivation equation, for example, the weighting factor for the unfiltered reference pixel value r[x, −1] is configured as c1v<<s[y]. That is, the weighting factor is derived by performing left shift on the reference strength coefficient c1v by a distance shift value s[y] that is determined in accordance with the reference distance y.

FIG. 8C(b) illustrates another derivation equation of the weighting factor b[x, y] for the provisional predicted pixel value q[x, y].

FIG. 8C(c) expresses a derivation equation of the distance shift value s[ ]. In the distance shift value s[x] s[x] (k[x]=1<<s[x]), a differential value obtained by subtracting, from smax, a value “floor(x/d)” that increases monotonically in accordance with the reference distance x (the horizontal distance x between the target pixel and the reference area R), is configured. Here, floor( )expresses a floor function, d expresses a predetermined parameter corresponding to the prediction block size, and “x/d” expresses the division of x by d (rounded down to the nearest decimal). A definition in which the horizontal distance x is replaced by the vertical distance y in the definition of the distance-weighted s[x] described earlier can be used for the distance shift value s[y] as well. The value of the distance shift values s[x] and s[y] reduces as the reference distance (x or y) increases.

According to the derivation method of the predicted pixel value described above with reference to FIGS. 8C(a) to 8C(c), the larger the distance (x or y) between the target pixel and the reference area R, the smaller the value of the distance shift (s[x], s[y]). Since the derived weighting factor also increases as the distance shift value increases, as already described, by further increasing the weighting of the unfiltered reference pixel value as the position within the prediction block comes closer to the reference area R, and correcting the provisional predicted pixel value, it is possible to derive the predicted pixel value.

Hereinafter, an operation of the third modification of the predicted-image correction unit 145 will be described by again referencing FIG. 7C. In the third modification of the predicted-image correction unit 145, the weighting factor is derived by a process in which steps (S22) and (S23) have been replaced by steps (S22′) and (S23′). The other processes are same as described earlier, and hence, the description has been omitted.

(S22′) Calculate the distance-weighted k corresponding to the distance between the target pixel and the reference area R, and then compute the distance shift value s[].

(S23′) The predicted-image correction unit 145 (third modification) derives the weighting factors described below by performing a left shift, on each reference strength coefficient derived in step S21, based on each distance shift value derived in step S22′.

First weighting factor w1v=c1v<<s[y]

Second weighting factor w1h=c1h<<s[x]

Third weighting factor w2v=c2v<<s[y]

Fourth weighting factor w2h=c2h<<s[x]

Thus, in the third modification of the predicted-image correction unit 145, the weighting factor is derived by performing a left shift based on the distance shift value s[x]. The left shift operation is superior not only because the left shift value itself is high speed, but because the left shift operation can be replaced by a calculation that is equivalent to multiplication.

### Fourth Modification: Configuration in Which the Accuracy of Distance Weighting is Improved

In the predicted-image correction unit 145 according to the embodiment described above, a calculation method based on the left shift operation of the distance-weighted k[x] was described with reference to FIG. 5C. Here, as shown by the equation in FIG. 5C, in a case that the distance-weighted k[x] is derived by a left shift operation expressed in the format “k=P<<Q”, it can be expressed that the distance-weighted k[x] is derived by applying a left shift based on the left shift width Q to the shifted term P.

According to the configuration described up to here, in FIG. 5C, the shifted term P is “1”, the left shift width Q is “smax−floor (x/d)”. In this case, the value that the distance-weighted k[x] can take is limited to the power of 2.

However, the distance-weighted k[x] can be determined by a method in which the distance-weighted k[x] is not limited to a power of 2. The derivation equation of such a distance-weighted k[x] will be described with reference to FIG. 8D.

FIGS. 8D(a) to 8D(d) respectively illustrate an example of a calculation formula for deriving a distance-weighted k [x] by a left shift operation. FIG. 8D(a) and FIG. 8D(b) are derivation equations of a distance-weighted k [x] used in a case that d=2, and FIG. 8D(c) and FIG. 8D(d) are derivation equations of a distance-weighted k [x] used in a case that d=3. In a case that d=2, a remainder term MOD2(x) of 2 is used as the derivation equation of the distance-weighted k[x] (refer to FIGS. 8D(a) and (b)), and in a case that d=3, a remainder term MOD3(x) of 3 is used as the derivation equation of the distance-weighted k[x] (refer to FIGS. 8D(c) and (d)). In FIG. 8D(a), the shifted term P is configured as “4−MOD2(x)” and the left shift width Q is configured as “smax−floor(x/2)+2”. Here, “MOD2(x)” is the remainder obtained by dividing x by the divisor 2, and “floor(x/2)” is the quotient obtained by dividing x by the divisor 2. FIG. 8D(a) can be expressed as described below by using a predetermined divisor a (in FIG. 8D(a), a=2) and a predetermined constant b (in FIG. 8D(a), b=2). That is, in FIG. 8D(a), the shifted term P is configured as a “Value obtained by subtracting the remainder (MODa(x)) based on the divisor a of the reference distance x from 2 raised to the power of b” and the left shift width Q is configured as a “Value obtained by subtracting the quotient (floor(x/a)) obtained by the division of the reference distance x by divisor a from the first normalization adjustment term (smax), and then adding the constant b”.

In FIG. 8D(b), the shifted term P is configured as “16−5*MOD2(x)” and the left shift width Q is configured as “smax−floor(x/2)+4”. FIG. 8D(b) can be expressed as described below by using a predetermined divisor a (in FIG. 8D(b), a=2), a predetermined constant b (in FIG. 8D(b), b=4), and a predetermined constant c (in FIG. 8D(b), c=5). That is, in FIG. 8D(b), the shifted term P is configured as a “value obtained by subtracting the product of the remainder (MODa(x)) based on the divisor a of the reference distance x and the constant c from 2 raised to the power of b” and the left shift width Q is configured as a “value obtained by subtracting the quotient (floor(x/a)) obtained by the division of the reference distance x by divisor a from the first normalization adjustment term (smax), and then adding the constant b”.

In FIG. 8D(c), the shifted term P is configured as “8−MOD3(x)” and the left shift width Q is configured as “smax−MOD3(x)+3”. Here, “MOD3(x)” is the remainder obtained by dividing x by the divisor 3, and “floor(x/3)” is the quotient obtained by dividing x by the divisor 3. FIG. 8D(c) can be expressed as described below by using a predetermined divisor a (in FIG. 8D(c), a=3) and a predetermined constant b (in FIG. 8D(b), b=3). That is, in FIG. 8D(c), the shifted term P is configured as a “value obtained by subtracting the remainder (MODa(x)) based on the divisor a of the reference distance x from 2 raised to the power of b” and the left shift width Q is configured as a “value obtained by subtracting the quotient (floor(x/a)) obtained by the division of the reference distance x by divisor a from the first normalization adjustment term (smax), and then adding the constant b”.

In FIG. 8D (d), the shifted term P is configured as “16−3*MOD3(x)” and the left shift width Q is configured as “smax−MOD3(x)+4”. FIG. 8D(d) can be expressed as described below by using a predetermined divisor a (in FIG. 8D(d), a=3), a predetermined constant b (in FIG. 8D(b), b=4), and a predetermined constant c (In FIG. 8D(b), c=3). That is, in FIG. 8D(d), the shifted term P is configured as a “value obtained by subtracting the product of the remainder (MODa(x)) based on the divisor a of the reference distance x and the constant c from 2 raised to the power of b” and the left shift width Q is configured as a “value obtained by subtracting the quotient (floor(x/a)) obtained by the division of the reference distance x by divisor a from the first normalization adjustment term (smax), and then adding the constant b”.

The equations in FIG. 8D(a) and FIG. 8D(c) that have been described above can be compiled together and expressed as below. The distance weighting is derived by configuring a predetermined divisor a and a predetermined constant b, and by configuring the shifted term P as a “value obtained by subtracting the remainder based on the divisor a of the reference distance x from 2 raised to the power of b” and the left shift width Q as a “value obtained by subtracting the quotient based on the divisor a of the reference distance x from the first normalization adjustment term, and then adding the constant b”, and then applying a left shift operation of the left shift width Q to the shifted term P.

The equations in FIG. 8D(b) and FIG. 8D(d) described above can be compiled together and expressed as below. The distance weighting is derived by configuring a predetermined divisor a, a predetermined constant b, and a predetermined constant c, and by configuring the shifted term P as a “value obtained by subtracting the product of the remainder based on the divisor a of the reference distance x and the constant c from 2 raised to the power of b” and the left shift width Q as a “value obtained by subtracting the quotient based on the divisor a of the reference distance x from the first normalization adjustment term, and then adding the constant b”, and then applying a left shift operation of the left shift width Q to the shifted term P.

As described above, according to the calculation method of the distance-weighted k[x] illustrated in FIGS. 8D(a) to 8D(d), the value of the shifted term P can be configured based on the remainder obtained by dividing the reference distance x by a predetermined divisor. Therefore, the shifted term P can be configured as a value other than 1. Therefore, since a value other than a power of 2 can be derived as the value of the distance-weighted k[x], the degree of freedom of configuring the distance weighting improves, and thus, it is possible to configure the distance weighting so that a predicted image having a smaller prediction residual can be derived by the predicted-image correction process.

For example, in a case that the distance weighting is limited to a value other than the power of 2, as illustrated in FIGS. 8B(a) to 8B(c), the distance weighting does not change even if the distance x changes in a case that d is other than 1. For example, in a case that d=2 and smax=8, the distance-weighted k[x] changes only once in two times as x increases in the form of 8, 8, 4, 4, 2, 2, 1, 1, and for example, in a case that d=3 and smax=8, the distance-weighted k[x] changes only once in three times as x increases in the form of 8, 8, 8, 4, 4, 4, 2, 2, 2, 1, 1, 1. This is because floor(x/d) does not change continuously during the derivation of the distance-weighted k[x] if d>0 (the distance weighting changes only once if x increases by only as much as the length d). In this case, not only because the process of reducing the weighting of the unfiltered pixels at the boundary cannot be applied if the distance increases, but also because the change becomes discontinuous, artificial patterns (for example, lines) associated with the prediction method remain that may cause the subjective image quality to decline. According to the calculation method of the distance-weighted k[x] illustrated in FIGS. 8D(a) to 9D(d), it becomes possible to make the change continuous as a result of the remainder term (refer to FIGS. 8F(a) to 8F(d)). Thus, MODE2(x) is a term that changes in the form of 0, 1, 0, 1, 0, 1, 0, 1 as x increases, and as a result, 4−MOD2(x) changes in the form of 4, 3, 4, 3, 4, 3, 4, 3. From 4 to 3, there is a reduction of only 3/4=0.7. In a case that d=2, if the fact that the shift value smax−floor(x/d) changes once in two times (one and a half times in two times) is also considered together, the weighting changes relatively as 1, 3/4, 1/2, 3/4*1/2, 1/4, . . .

The calculation formula of the distance-weighted k[x] that is described above with reference to FIGS. 8E(a) to 8E(d), and the calculation formula of the distance-weighted k[x] that is described with reference to FIGS. 8F(a) to 8F(d) as the first modification may also be combined thereto. The calculation formula of the distance-weighted k[x] based on such a combination is illustrated in FIGS. 8D(a) to 8D(d). Each calculation formula of the distance-weighted k[x] illustrated in FIGS. 8D(a) to 8D(d) is a modification of a corresponding calculation formula of the distance-weighted k[x] described with reference to FIGS. 8B(a) to 8B(c) so that the reference distance x becomes 0 in a case that the reference distance x is equal to or more than a predetermined value. FIG. 8D(a) corresponds to FIG. 8E(a), FIG. 8D(b) to FIG. 8E(b), FIG. 8D(c) to FIG. 8E(c), and FIG. 8D(d) to FIG. 8E(d), respectively.

Furthermore, during the derivation of the distance-weighted k[x], rather than performing the calculation each time based on the calculation formula in FIGS. 8D(a) to 8D(d), the distance-weighted k[x] may be derived by referencing a distance weighting reference table in a storage area. An example of the distance weighting reference table is illustrated in FIGS. 8F(a) to 8F(d). The tables illustrated in FIGS. 8F(a) to 8F(d) are tables that maintain the results of the calculation formulas of distance weighting in FIGS. 8D(a) to 8D(d).

It is noted that FIG. 8D(a) and FIG. 8D(c) are particularly suitable for hardware processing. For example, 4−MOD2(x) can be processed in the hardware without using a product that makes the implementation scale larger, and the same is true for 8−MOD3(x).

Fifth Modification: Configuration Omitting the Correction Process in Accordance with the Block Size

The predicted-image correction unit 145 may be configured to perform the predicted-image correction process described above in a case that the prediction block size satisfies a specific condition, and to output the input provisional predicted image as is in the form of a predicted image in the other cases. Specifically, the configuration is such that the predicted-image correction process is omitted in a case that the prediction block size is equal to or less than a predetermined size, and the predicted-image correction process is performed in the other cases. For example, in a case that the prediction block size is 4×4, 8×8, 16×16, and 32×32, the predicted-image correction process is omitted in prediction blocks with a size of 4×4 and 8×8, and the predicted-image correction process is performed in prediction blocks with a size of 16×16 and 32×32. Generally, the processing amount per unit area is large in a case that a small prediction block is used, which becomes the bottleneck of the processing. Therefore, by omitting the predicted-image correction process in a comparatively small prediction block, the amount of coded data can be reduced by an effect of improvement in the predicted image accuracy by the predicted-image correction process, without increasing processes that become the bottleneck.

### Video Coding Device

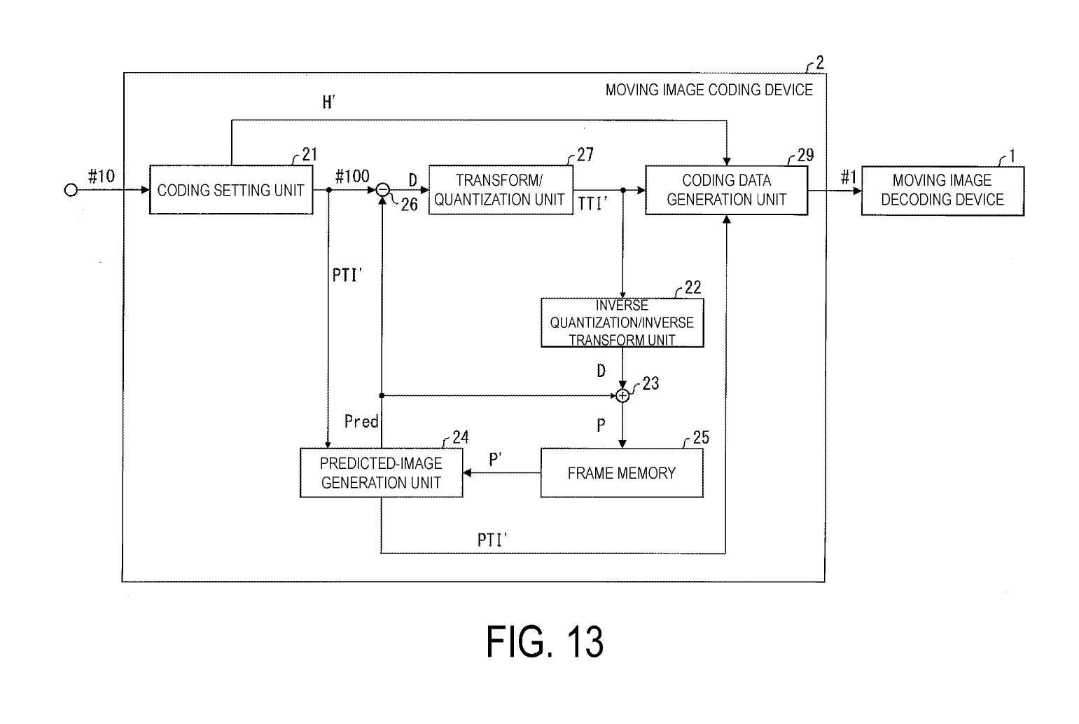

The video decoding device 2 according to the present embodiment will be described with reference to FIG. 13. The video coding device 2 is a video coding device that includes a predicted-image generation unit 24 having the same functions as the predicted-image generation unit 14 described earlier, and by coding an input image #10, generates and outputs coded data #1 that can be decoded by the video decoding device 1. FIG. 13 is a functional block diagram indicating a configuration of the video coding device 2. As illustrated in FIG. 13, the video coding device 2 includes a coding setting unit 21, an inverse quantization/inverse transform unit 22, an adder 23, a predicted-image generation unit 24, a frame memory 25, a subtracter 26, a transform/quantization unit 27, and a coded data generation unit 29.

The coding setting unit 21 is configured to generate image data concerning coding and various types of configuration information based on the input image #10. Specifically, the coding setting unit 21 generates the image data and configuration information described below. First of all, by sequentially splitting the input image #10 into a slice unit, tree block unit, and CU unit, the coding setting unit 21 generates a CU image #100 for a target CU.

Furthermore, based on the result of the splitting process, the coding setting unit 21 generates header information H′. The header information H′ includes (1) information about the size and shape of the tree blocks belonging to the target slice, as well as the position within the target slice, and also (2) CU information CU′ about the size and shape of the CU(s) belonging to each tree block, as well as the position within the target tree block.

In addition, the coding setting unit 21 generates PT configuration information PTI′ by referencing the CU image #100 and the CU information CU′. The PT configuration information PTI′ includes information about the (1) splitting patterns that are possible for each PU (prediction block) of the target CU, and (2) all combinations of the prediction modes that can be assigned to each prediction block.

The coding setting unit 21 is configured to supply the CU image #100 to the subtracter 26. Furthermore, the coding setting unit 21 supplies the header information H′ to the coding data generation unit 29. Furthermore, the coding setting unit 21 supplies the PT configuration information PTI′ to the predicted-image generation unit 24.

The inverse quantization/inverse transform unit 22 restores the prediction residual of each block, by performing inverse quantization and inverse orthogonal transform for the quantization prediction residual of each block that is supplied from the transform/quantization unit 27. The inverse orthogonal transform is as described earlier in the description about the inverse quantization/inverse transform unit 13 illustrated in FIGS. 2(a) to 2(d), and therefore, the description is omitted here.

Furthermore, the inverse quantization/inverse transform unit 22 integrates the prediction residual of each block according to the splitting patterns designated by the TT splitting information (described later), and generates a prediction residual D for the target CU. The inverse quantization/inverse transform unit 22 supplies the generated prediction residual D of the target CU to the adder 23.

The predicted-image generation unit 24 generates a predicted image Pred for the target CU, by referencing the local decoded image P′ recorded in the frame memory 25, and the PT configuration information PTI′. The predicted-image generation unit 24 configures the prediction parameter obtained by the predicted-image generation process in the PT configuration information PTI′, and transfers the PT configuration information PTI′ after configuration to the coding data generation unit 29. It is noted that the predicted-image generation process by the predicted-image generation unit 24 is similar to that by the predicted-image generation unit 14 included in the video decoding device 1, and therefore, the description is omitted. The predicted-image generation unit 24 internally includes each constituting element of the predicted-image generation unit 14 illustrated in FIG. 4, and can generate a predicted image with the PT information PTI′ and the local decoded image P′ as an input, and then output the generated predicted image.

The adder 23 is configured to generate a decoded image P for the target CU by adding the predicted image Pred supplied by the predicted-image generation unit 24, and the prediction residual D supplied by the inverse quantization/inverse transform unit 22.

In the frame memory 25, the decoded images P are sequentially recorded. In the frame memory 25, when a target tree block is decoded, the decoded images that correspond to all tree blocks decoded earlier than the target tree block (for example, all preceding tree blocks in the raster scan order) are recorded.

The subtracter 26 is configured to generate a prediction residual D for the target CU by subtracting the predicted image Pred from the CU image #100. The subtracter 26 supplies the generated prediction residual D to the transform/quantization unit 27.

The transform/quantization unit 27 is configured to generate a quantization prediction residual by performing orthogonal transform and quantization for the prediction residual D. It is noted that here, an orthogonal transform implies the transform from a pixel area to a frequency area. Furthermore, examples of inverse orthogonal transform include a DCT transform (Discrete Cosine Transform) and a DST transform (Discrete Sine Transform), and the like.

Specifically, the transform/quantization unit 27 is configured to reference the CU image #100 and the CU information CU′, and to determine the splitting patterns for one or multiple blocks of the target CU. Furthermore, the prediction residual D is split into the prediction residual for each block according to the determined splitting pattern.

Moreover, the transform/quantization unit 27, after generating the prediction residual in the frequency area by performing an orthogonal transform for the prediction residual of each block, generates a quantization prediction residual for each block by performing quantization of the prediction residual in the frequency area.

In addition, the transform/quantization unit 27 generates the TT configuration information TT′ that includes the quantization prediction residual of each generated block, the TT splitting information that designates the splitting patterns of the target CU, and the information about all splitting patterns that are possible for each block of the target CU. The transform/quantization unit 27 supplies the generated TT configuration information TT′ to the inverse quantization/inverse transform unit 22 and the coding data generation unit 29.

The coding data generation unit 29 is configured to code the header information H′, the TT configuration information TTI′, and the PT configuration information PTI′, and to generate coded data #1 by overlaying the coded header information H, the TT configuration information TTI, and the PT configuration information PTI, and then output the coded data #1.

### Effect of the Video Coding Device

The video coding device according to the present embodiment described above has a predicted-image generation unit 24 that includes the predicted-image correction unit 145 as a constituting element, and the predicted-image generation unit 24 is configured to generate a predicted image (corrected) from an unfiltered reference pixel value and a provisional predicted pixel value by weighted addition based on a weighting factor for each pixel of a provisional predicted image. The weighting factor described above is a product of a reference strength coefficient determined in accordance with the prediction direction indicated by the prediction mode, and the distance weighting that decreases monotonically as a result of an increase in the distance between the target pixel and the reference area R. Therefore, the larger the reference distance (for example, x, y), the smaller is the value of the distance weighting (for example, k[x], k[y]), and therefore, by generating the predicted image by further increasing the weighting of the unfiltered reference pixel value when the reference distance is small, a predicted pixel value with a high prediction accuracy can be generated. In addition, since the weighting factor is the product of the reference strength coefficient and distance weighting, by calculating the value of distance weighting beforehand for each distance and maintaining the values in a table, the weighting factor can be derived without using the right shift operation and division.

### Predicted-Image Generation Device

The video decoding device 1 and the video coding device 2 described above internally include the predicted-image generation unit 14 illustrated in FIG. 4, and thus, a predicted image having a high prediction accuracy can be derived by comparatively less calculation amount, and coding and decoding processes of a video can be realized. On the other hand, the predicted-image generation unit 14 can also be used for other purposes. For example, the predicted-image generation unit 14 can also be utilized by incorporation in an image loss repair device for repairing a loss of videos and still images. In such a case, a prediction block corresponds to a target area of loss repair, and the input to the predicted-image generation unit 14 is a prediction mode corresponding to a repair pattern for image loss, and the input images or repaired images close to the prediction block. The output is the already repaired image in the prediction block.

The predicted-image generation device can be achieved by the same configuration as the predicted-image generation unit 14, and the predicted-image generation device can be utilized as a constituting element of the video decoding device, the video coding device, and the image loss repair device.

### Application Examples

The video coding device 2 and the video decoding device 1 described above can be utilized by loading in various types of devices that perform transmission, reception, recording, and playback of videos. It is noted that a video may be a naturally video shot by a camera or the like, or may be an artificially video (including CG and GUI) generated by a computer, etc.

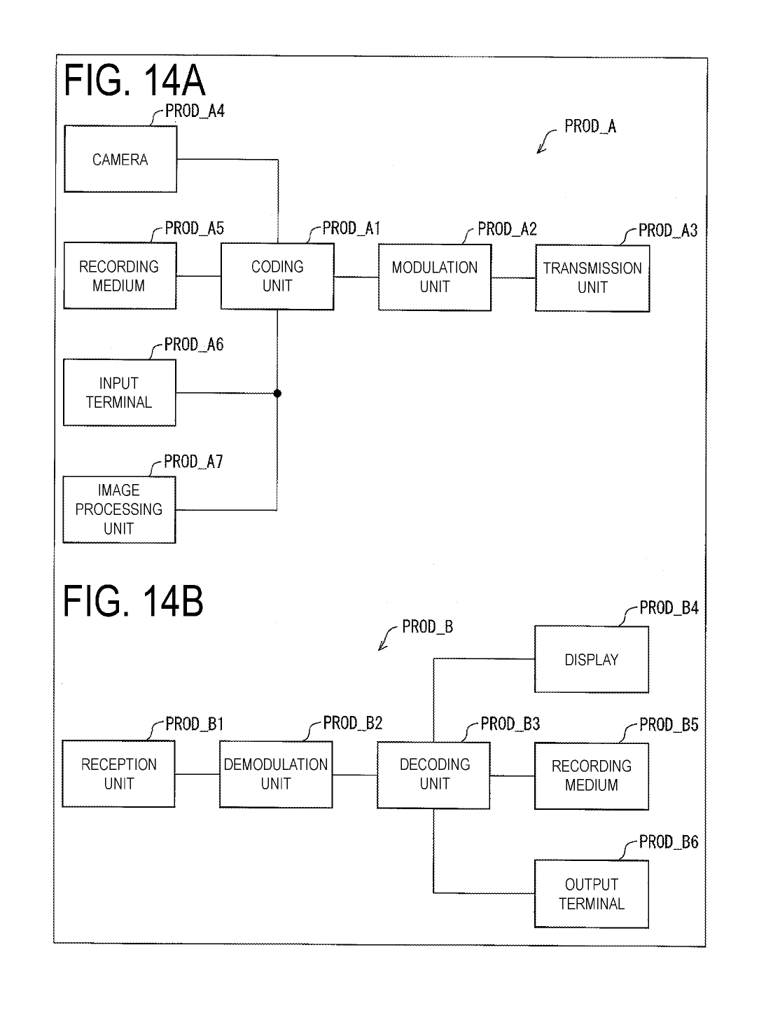

First of all, the availability of the video coding device 2 and the video decoding device 1 described above for the transmission and reception of videos will be described with reference to FIGS. 14A and 14B.

FIG. 14A is a block diagram illustrating a configuration of a transmission device PROD_A in which the video coding device 2 is mounted. As illustrated in FIG. 14A, the transmission device PROD_A includes a coding unit PROD_A1 configured to obtain coded data by coding a video, a modulation unit PROD_A2 configured to obtain a modulation signal by modulating a carrier wave by the coded data obtained by the coding unit PROD_A1, and a transmission unit PROD_A3 configured to transmit a modulation signal obtained by the modulation unit PROD_A2. The video coding device 2 described above is utilized as the coding unit PROD_A1.

The transmission device PROD_A may, as a supply source of the video input to the coding unit PROD_A1, further include a camera PROD_A4 for shooting a video, a recording medium PROD_A5 for recording the video, and an input terminal PROD_A6 for the input of the video from outside, as well as an image processing unit A7 configured to generate or process the image. In FIG. 14A, a configuration in which the transmission device PROD_A includes all of the above-described units is illustrated, but some of the units may be omitted.

It is noted that the recording medium PROD_A5 may record videos that have not been coded, or may record videos that have been coded by a coding method for recording that is different from the coding method for transmission. In the latter case, a decoding unit (not illustrated in the figure) configured to decode the coded data read from the recording medium PROD_A5 according to the coding method for recording may be interposed between the recording medium PROD_A5 and the coding unit PROD_A1.

FIG. 14B is a block diagram illustrating a configuration of a reception device PROD_B in which the video coding device 1 is mounted. As illustrated in FIG. 14B, the reception device PROD_B includes a reception unit PROD_B1 configured to receive a modulation signal, a demodulation unit PROD_B2 configured to obtain coded data by demodulating the modulation signal received by the reception unit PROD_B1, and a decoding unit PROD_B3 configured to obtain a video by decoding the coded data obtained by the demodulation unit PROD_B2. The video decoding device 1 described above is utilized as the decoding unit PROD_B3.

The reception device PROD_B may, as a supply destination of the video output by the decoding unit PROD_B3, further include a display PROD_B4 for the display of the video, a recoding medium PROD_B5 for recording the video, and an output terminal PROD_B6 for the output of the video to the outside. In FIG. 14B, a configuration in which the reception device PROD_B includes all of the above-described units is illustrated, but some of the units may be omitted.

It is noted that the recording medium PROD_B5 may be a medium for recording videos that have not been coded, or may be a medium for coding by a coding method for recording that is different from the coding method for transmission. In the latter case, a coding unit (not illustrated in the figure) configured to code the video acquired from the decoding unit PROD_B3 according to the coding method for recording may be interposed between the decoding unit PROD_B3 and the recording medium PROD_B5.

It is noted that the transmission medium for transmitting the modulation signal may be wireless or may be wired. Furthermore, the transmission form for transmitting the modulation signal may be broadcast (here, broadcast indicates a transmission form in which the transmission destination is not specified beforehand), or may be communication (here, communication indicates a transmission form in which the transmission destination is not specified beforehand). That is, the transmission of the modulation signal may be achieved by any one of radio broadcast, wired broadcast, radio communication, and wired communication.

For example, a broadcast station (such as a broadcast facility, etc.)/reception station (such as a television receiver, etc.) of terrestrial digital broadcasting is an example of a transmission device PROD_A/reception device PROD_B that transmits and receives a modulation signal by radio broadcast. Furthermore, a broadcast station (such as a broadcast facility, etc.)/reception station (such as a television receiver, etc.) of cable television broadcasting is an example of a transmission device PROD_A/reception device PROD_B that transmits and receives a modulation signal by wired broadcast.

Furthermore, a server (such as a workstation, etc.)/client (such as a television receiver, personal computer, smartphone, etc.), such as a VOD (Video On Deman) service using the Internet, or a video hosting service is an example of a transmission device PROD_A/reception device PROD_B that transmits and receives a modulation signal by communication (normally, either a wireless or wired transmission medium is used in LAN, and a wired transmission medium is used in WAN). Here, a personal computer includes a desktop PC, a laptop PC, and a tablet PC. Furthermore, a multi-functional mobile phone terminal is also included in a smartphone.

It is noted that in addition to a function of decoding the coded data downloaded from the server and displaying the decoded data on a display, the client of a video hosting service has a function of coding a video shot by a camera, and uploading the coded video to the server. That is, the client of a video hosting service functions as both the transmission device PROD_A and the reception device PROD_B.

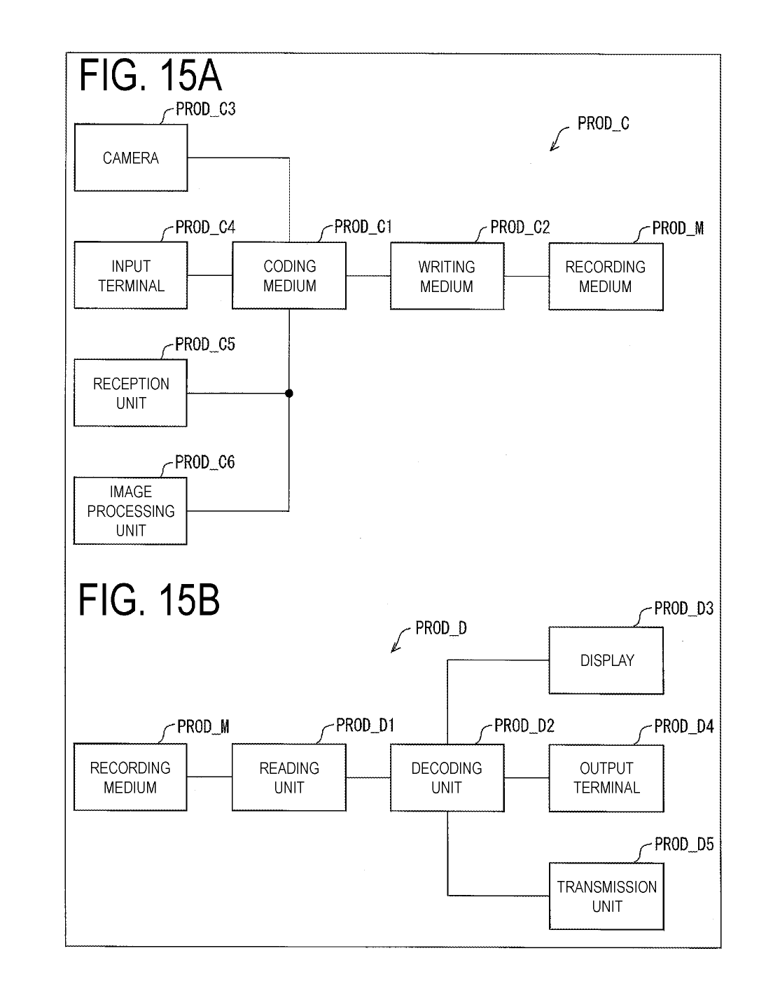

Next, the availability of the video coding device 2 and the video decoding device 1 described above for recording and playing back videos will be described with reference to FIGS. 15A and 15B.

FIG. 15A is a block diagram illustrating a configuration of a recording device PROD_C in which the video coding device 2 described earlier is mounted. As illustrated in FIG. 15A, the recording medium PROD_C includes a coding unit PROD_C1 configured to obtain coded data by coding a video, and a writing unit PROD_C2 configured to write the coded data obtained by the coding unit PROD_C1 to the recording medium PROD_M. The video coding device 2 described above is utilized as the coding unit PROD_C1.

It is noted that the recording medium PROD_M may be (1) a medium that is built into the recording device PROD_C, such as an HDD (Hard Disk Drive) or SSD (Solid State Drive), etc., (2) a medium that is connected to the recording device PROD_C, such as an SD memory card, or a USB (Universal Serial Bus) flash memory, etc., or (3) a medium mounted in a drive device (not illustrated in the figure) that is built into the recording device PROD_C, such as a DVD (Digital Versatile Disc) or BD (Blu-ray Disc:®) and the like.

Furthermore, the recording device PROD_C may, as a supply source of the video input to the coding unit PROD_C1, further include a camera PROD_C3 for shooting a video, an input terminal PROD_C4 for the input of the video from outside, and a reception unit PROD_C5 for receiving the video, as well as an image processing unit C6 configured to generate or process the image. In FIG. 15A, a configuration in which the recording device PROD_C includes all of the above-described units is illustrated, but some of the units may be omitted.

It is noted that the reception unit PROD_C5 may be a unit configured to receive videos that have not been coded, or may be a unit configured to receive coded data that has been coded by a coding method for transmission that is different from the coding method for recording. In the latter case, a decoding unit for transmission (not illustrated in the figure) configured to decode the coded data that has been coded by the coding method for transmission may be interposed between the reception unit PROD_C5 and the coding unit PROD_C1.

Examples of such a recording device PROD_C include, for example, a DVD recorder, a BD recorder, an HD (Hard Disk) recorder, etc. (in this case, the input terminal PROD_C4 or the reception unit PROD_C5 is the main supply source of the video). Furthermore, a camcorder (in this case, the camera PROD_C3 is the main supply source of the video), a personal computer (in this case, the reception unit PROD_C5 is the main supply source of the video), a smartphone (in this case, the camera PROD_C3, or the reception unit PROD_C5, or the image processing unit C6 is the main supply source of the video) etc., are also examples of such a recording device PROD_C.

FIG. 15B is a block diagram illustrating a configuration of a playback device PROD_D in which the video coding device 1 described above is mounted. As illustrated in FIG. 15B, the playback device PROD_D includes a reading unit PROD_D1 configured to read coded data written to the recording medium PROD_M, and a decoding unit PROD_D2 configured to obtain a video by decoding the coded data read by the reading unit PROD_D1. The video decoding device 1 described above is utilized as the decoding unit PROD_D2.

It is noted that the recording medium PROD_M may be (1) a medium that is built into the playback device PROD_D, such as an HDD or SSD, etc., (2) a medium that is connected to the playback device PROD_D, such as an SD memory card or a USB flash memory, etc., or (3) a medium mounted in a drive device (not illustrated in the figure) that is built into the playback device PROD_D, such as a DVD or BD.

Furthermore, the playback device PROD_D may, as a supply destination of the video output by the decoding unit PROD_D2, further include a display PROD_D3 for the display of the video, an output terminal PROD_D4 for the output of the video to the outside, and a transmission unit PROD_D5 configured to transmit the video. In FIG. 15B, a configuration in which the playback device PROD_D includes all of the above-described units is illustrated, but some of the units may be omitted.

It is noted that the transmission unit PROD_D5 may be a unit configured to transmit videos that have not been coded, or may be a unit configured to transmit coded data that has been coded by a coding method for transmission that is different from the coding method for recording. In the latter case, a coding unit (not illustrated in the figure) configured to code the video by the coding method for transmission may be interposed between the decoding unit PROD_D2 and the transmission unit PROD_D5.

Examples of such a playback device PROD_D include, for example, a DVD player, a BD player, an HDD player, etc. (in this case, the output terminal PROD_D4 to which the television receiver or the like is connected is the main supply destination of the video). Furthermore, a television receiver (in this case, the display PROD_D3 is the main supply destination of the video), digital signage (also called a digital sign or digital board system, and the like; the display PROD_D3 or the transmission unit PROD_D5 is the main supply destination of the video), a desktop PC (in this case, the output terminal PROD_D4 or the transmission unit PROD_D5 is the main supply destination of the video), a laptop or tablet PC (in this case, the display PROD_D3 or the transmission unit PROD_D5 is the main supply destination of the video), a smartphone (in this case, the display PROD_D3 or the transmission unit PROD_D5 is the main supply destination of the video) etc., are examples of such a playback device PROD_D.

### Hardware Implementation and Software Implementation

The functional blocks in the image processing device 20 and image processing device 20a may be implemented by a logic circuit (hardware) formed on an integrated circuit (IC chip) or the like, or by software using a Central Processing Unit (CPU).

In the latter case, the voice-guided navigation device 1, 10 includes a CPU configured to perform commands of a program being software for achieving the functions, a Read Only Memory (ROM) or a storage device (these are referred to as “recording medium”) in which the program and various pieces of data are recorded in a computer- (or CPU-) readable manner, and a Random Access Memory (RAM) in which the program is loaded. In addition, an object of an embodiment of the disclosure can also be achieved by supplying, to each device described above, a recording medium that is software for achieving the functions described above, and that records the program codes of the control program of each device described above (executable format program, intermediate code program, and source program) in a format that can be read by a computer, and then reading and executing the program codes recorded in the recording medium on the computer (or the CPU or MPU).

As the recording medium described above, for example, tapes such as a magnetic tape and cassette tape, etc., discs including magnetic discs such as a floppy® disk/hard disc, etc., and optical discs such as a CD-ROM (Compact Disc Read-Only Memory)/MO disc (Magneto-Optical disc)/MD (Mini Disc)/DVD (Digital Versatile Disc)/CD-R (CD Recordable)/Blu-ray disc®, etc., cards such as an IC card (including a memory card)/optical card, etc., semiconductor memories, such as a mask ROM/EPROM (Erasable Programmable Read-Only Memory)/EEPROM (Electrically Erasable and Programmable Read-Only Memory:®)/flash ROM, etc., or logic circuits, such as a PLD (Programmable logic device) and FPGA (Field Programmable Gate Array), etc. can be used.

Furthermore, each device described above may be configured to be connectable to a communication network, and the program codes described above may be supplied via the communication network. The communication network is not particularly restricted, as long as the program codes can be transmitted. For example, the Internet, intranet, extranet, LAN (Local Area Network), ISDN (Integrated Services Digital Network), VAN (Value-Added Network), CATV (Community Antenna Television/Cable Television) communication network, virtual private network, telephone line network, mobile communication network, satellite communication network, etc. can be used. Furthermore, the transmission medium constituting the communication network is also not restricted to a particular configuration or type, as long as the program codes can be transmitted over the medium. For example, a wired transmission medium such as IEEE (Institute of Electrical and Electronic Engineers) 1394, USB, power line communication, cable TV line, telephone line, ADSL (Asymmetric Digital Subscriber Line) line, etc., and a wireless medium such as infrared rays like IrDA (Infrared Data Association) and a remote controller, Bluetooth®, IEEE 802.11 radio, HDR (High Data Rate), NFC (Near Field Communication), DLNA (Digital Living Network Alliance:®), mobile telephone network, satellite channel, terrestrial wave digital network, etc. can be used. Note that one aspect of the disclosure may also be implemented in a form of a data signal embedded in a carrier wave in which the program is embodied by electronic transmission.

### CROSS-REFERENCE OF RELATED APPLICATION

This application claims priority based on JP 2016-019353 filed in Japan on Feb. 3, 2016, the contents of which are incorporated herein by reference.

### INDUSTRIAL APPLICABILITY

An embodiment according to the disclosure can be suitably applied to an image decoding device configured to decode coded data, the coded data being coded image data, and to an image coding device configured to generate coded data, the coded data being coded image data. Furthermore, the embodiment can be suitable applied to a data structure of coded data generated by the image coding device and referenced by the image decoding device.

### REFERENCE SIGNS LIST

1 Video decoding device
14, 24 Predicted-image generation unit
141 Prediction block setting unit (reference area setting unit)
142 Unfiltered reference pixel setting unit (second prediction unit)
143 Filtered reference pixel setting unit (first prediction unit)
144 Prediction unit
144D DC prediction unit
144P Planar prediction unit
144H Horizontal prediction unit
144V Vertical prediction unit
144A Angular prediction unit
144N Inter prediction unit
144B IBC prediction unit
144L Luminance-chrominance prediction unit
145 Predicted-image correction unit (predicted-image correction unit, filter switching unit, weighting factor change unit)
16, 25 Frame memory
2 Video coding device

1. A predicted-image generation device, comprising:
a filtered reference pixel setting unit configured to derive a filtered reference pixel value on a reference area configured for a prediction block;
a prediction unit configured to derive a provisional predicted pixel value of the prediction block by a prediction method corresponding to a prediction mode included in a first prediction mode group, or by a prediction method corresponding to a prediction modes included in a second prediction mode group; and
a predicted-image correction unit configured to generate a predicted image from the provisional predicted pixel value by performing a predicted-image correction process based on an unfiltered reference pixel value on the reference area, and a filter mode corresponding to a prediction mode referenced by the prediction unit, wherein
the predicted-image correction unit is configured to, in accordance with the prediction mode referenced by the prediction unit,
derive a predicted pixel value constituting the predicted image by applying, to the provisional predicted pixel value and to at least one unfiltered reference pixel value, a weighted addition using a weighting factor corresponding to the filter mode, or
derive a predicted pixel value constituting the predicted image by applying, to the provisional predicted pixel value and to at least one unfiltered reference pixel value, a weighted addition that is used for a filter mode corresponding to a non-directional prediction mode.

2. The predicted-image generation device according to claim 1, wherein the second prediction mode group includes at least one of
a prediction mode A in which the provisional predicted pixel value is calculated by referring to a reference image that is a picture including the prediction block,
a prediction mode B in which the provisional predicted pixel value is calculated by referring to a reference image other than the picture including the prediction block, and
a prediction mode C in which the provisional predicted pixel value is calculated as a chrominance image by referring to a luminance image indicating a luminance.

3. The predicted-image generation device according to claim 2, wherein the predicted-image correction unit is configured, in a case that either of the prediction mode A and the prediction mode B is selected,
not to apply the weighted addition in a case that a motion vector indicating the reference image is of a unit of an integer pixel.

4. The predicted-image generation device according to claim 2, wherein the predicted-image correction unit is configured to,
in a case that either of the prediction mode A and the prediction mode B is selected, change a strength of a filter process by the weighted addition depending on whether a motion vector indicating the reference image is of a unit of an integer pixel or of a unit of a non-integer pixel, and
cause the strength of the filter process, in a case that the motion vector is of a unit of an integer pixel, to be lower than the strength of the filter process in a case that the motion vector is of a unit of a non-integer pixel.

5. A predicted-image generation device, comprising:
a reference area setting unit configured to configure a reference area for a prediction block;
a prediction unit configured to calculate a provisional predicted pixel value of the prediction block by a prediction method corresponding to a prediction mode; and
a predicted-image correction unit configured to generate a predicted image from the provisional predicted pixel value by performing a predicted-image correction process based on an unfiltered reference pixel value on the reference area, and any one of multiple filter modes, wherein
the predicted-image correction unit is configured to derive a predicted pixel value constituting the predicted image by applying, to the provisional predicted pixel value and to at least one unfiltered reference pixel value, a weighted addition using a weighting factor corresponding to a filter mode having a directionality that corresponds to a directionality of a motion vector indicating a reference image.

6. A predicted-image generation device, comprising:
a filtered reference pixel setting unit configured to derive a filtered reference pixel value by applying a first filter to a pixel on a reference area configured for a prediction block;
a first filter switching unit configured to switch a strength or an ON/OFF state of the first filter;
an intra prediction unit configured to derive a provisional predicted pixel value of the prediction block by referring to the filtered reference pixel value or a pixel on the reference area by a prediction method corresponding to a prediction mode;
a predicted-image correction unit configured to generate a predicted image from the provisional predicted pixel value by performing a predicted-image correction process based on an unfiltered reference pixel value on the reference area and the prediction mode, and configured to derive a predicted pixel value constituting the predicted image by applying, to the provisional predicted pixel value in a target pixel within the prediction block and to at least one unfiltered reference pixel value, a second filter using a weighted addition based on a weighting factor; and
a second filter switching unit configured to switch a strength or an ON/OFF state of the second filter in accordance with the strength or the ON/OFF state of the first filter.

7.-16. (canceled)

17. A video decoding device, comprising:
the predicted-image generation device according to claim 1, wherein
the video decoding device is configured to decode a coded image by adding or subtracting a residual image to or from the predicted image.

18. A video coding device, comprising: the predicted-image generation device according to claim 1, wherein
the video coding device is configured to code a residual between the predicted image and an image to be coded.
